(19) United States
(12) Patent Application Publication
(10) Pub. No.: US 2025/0102895 A1
(43) Pub. Date: Mar. 27, 2025

(54) IMAGE DISPLAY APPARATUS, IMAGE DISPLAY SYSTEM, AND PROJECTION OPTICAL SYSTEM

(71) Applicant: SONY GROUP CORPORATION, TOKYO (JP)

(72) Inventors: JUN NISHIKAWA, TOKYO (JP); TOMOHARU NAKAMURA, TOKYO (JP)

(21) Appl. No.: 18/730,424

(22) PCT Filed: Aug. 18, 2022
(86) PCT No.: PCT/JP2022/031173

§ 371 Date: Jul. 19, 2024

(30) Foreign Application Priority Data
Jan. 27, 2022 (JP) 2022-010620

(51) Int. Cl. G03B 21/20; G03B 21/00

(52) U.S. Cl. CPC G03B 21/2066; G03B 21/006; G03B 21/208

(57) ABSTRACT

An image display apparatus according to an embodiment of the present technology includes a light source, an image generator, and a projection optical system. The image generator modulates light emitted by the light source to generate image light that includes a plurality of pieces of pixel light. The projection optical system includes a lens system and a reflection optical system. The lens system is formed along a reference axis at a position at which the generated image light enters the lens system. The lens system refracts the plurality of pieces of pixel light included in the generated image light, and emits the plurality of pieces of refracted pixel light. The reflection optical system is formed along the reference axis. The plurality of pieces of pixel light emitted from the lens system is reflected off the reflection optical system to be headed for an onto-projection object in a state in which traveling directions of the plurality of pieces of pixel light are aligned, the onto-projection object being an object onto which projection is performed.

### TECHNICAL FIELD

The present technology relates to an image display apparatus such as a projector, an image display system, and projection optical system.

### BACKGROUND ART

Conventionally, a projector is widely known as a projection-type image display apparatus that displays a projected image on a screen. Recently, there has been an increasing demand for a super-wide-angle front-projection-type projector that can perform large-screen display even on a small projection space. The use of such a projector makes it possible to perform large-screen projection onto a limited space by performing oblique projection onto a screen at a wide angle.

In the super-wide-angle projection-type projector disclosed in Patent Literature 1, display shifting such as moving a projected image projected onto a screen can be performed by moving some of optical components included in a projection optical system. The use of such display shifting makes it easy to make a minor adjustment of, for example, a position of an image.

In the projection-type display apparatus disclosed in Patent Literature 2, a light beam coming from a display panel is reflected off a plurality of rotationally asymmetric reflecting surfaces to be projected onto a screen. Further, the image of a stop is formed at a negative magnification by an optical system (the plurality of rotationally asymmetric reflecting surfaces) situated closer to the screen than the position of the stop. Consequently, the effective diameter of a light ray on each surface is reduced, and each optical element such as the reflecting surface and the entirety of the optical system are made smaller in size.

Further, a technology is known that projects image light onto a transparent screen to display an image on the screen in an image display system that uses, for example, a projector. For example, image light is projected onto a transparent screen through which, for example, the background can be seen, and this enables an image to be displayed in a state of being superimposed on the background.

The image display apparatus disclosed in Patent Literature 3 uses a transparent screen formed by two holographic optical elements (HOE) in combination. For example, a transparent screen formed by first and second HOEs being integrated, the first HOE including a diffusion function, the second HOE including a concave-mirror function. This makes it possible to view a virtual image formed at a position that is different from a position on the surface of the transparent screen, and thus to enjoy image display that brings a great feeling of floating.

### CITATION LIST

### Patent Literature

Patent Literature 1: Japanese Patent No. 5365155
Patent Literature 2: Japanese Patent Application Laid-open No. 2001-255462
Patent Literature 3: Japanese Patent Application Laid-open No. 2018-163307

### DISCLOSURE OF INVENTION

### Technical Problem

There is a need for a technology that enables high-quality image display to be performed by an image display apparatus such as a projector.

In view of the circumstances described above, it is an object of the present technology to provide an image display apparatus and a projection optical system that enable high-quality image display.

### Solution to Problem

In order to achieve the object described above, an image display apparatus according to an embodiment of the present technology includes a light source, an image generator, and a projection optical system.

The image generator modulates light emitted by the light source to generate image light that includes a plurality of pieces of pixel light.

The projection optical system includes a lens system and a reflection optical system.

The lens system is formed along a reference axis at a position at which the generated image light enters the lens system. The lens system refracts the plurality of pieces of pixel light included in the generated image light, and emits the plurality of pieces of refracted pixel light.

The reflection optical system is formed along the reference axis. The plurality of pieces of pixel light emitted from the lens system is reflected off the reflection optical system to be headed for an onto-projection object in a state in which traveling directions of the plurality of pieces of pixel light are aligned, the onto-projection object being an object onto which projection is performed.

In this image display apparatus, a plurality of pieces of pixel light making up an image is refracted to be emitted to the reflection optical system by the lens system. The plurality of pieces of pixel light is reflected off the reflection optical system to be headed for the onto-projection object in a state in which traveling directions of the plurality of pieces of pixel light are aligned. This makes it possible to perform high-quality image display.

A standard deviation of a distribution of the traveling directions of the plurality of pieces of pixel light reflected off the reflection optical system may be smaller than 0.16.

The reflection optical system may include at least one curved reflecting surface having a rotationally asymmetric shape.

The at least one curved reflecting surface may include a first reflecting surface off which the plurality of pieces of pixel light emitted from the lens system is reflected, a second reflecting surface off which the plurality of pieces of pixel light reflected off the first reflecting surface is reflected, and a third reflecting surface off which the plurality of pieces of pixel light reflected off the second reflecting surface is reflected to be headed for the onto-projection object.

A standard deviation of a distribution of the traveling directions of the plurality of pieces of pixel light reflected off the third reflecting surface may be smaller than 0.16.

The image generator may emit, to the lens system and along the reference axis, the image light making up a rectangular image that has paired long sides that face each other, and paired short sides that face each other. In this case, when a direction that corresponds to a short-side direction in which the short side of the image extends is defined as a first direction, the image being made up by the image light emitted to the lens system; and when a direction that corresponds to a long-side direction in which the long side of the image extends is defined as a second direction, the image being made up by the image light emitted to the lens system, the first reflecting surface may have a negative power, the second reflecting surface may have a negative power, and the third reflecting surface may have a positive power in the case in which the projection optical system is viewed in the first direction. Further, the first reflecting surface may have a positive power, the second reflecting surface may have a negative power, and the third reflecting surface may have a positive power in the case in which the projection optical system is viewed in the second direction.

The projection optical system may be configured such that 0.25<θLx/360<0.47, where θLx represents an angle formed when the projection optical system is viewed in the first direction, the angle being formed by a piece of short-side pixel light incident on the third reflecting surface and the piece of short-side pixel light reflected off the third reflecting surface, the piece of short-side pixel light being a piece of pixel light that is from among the plurality of pieces of pixel light and corresponds to a pixel situated in a middle portion of the short side of the image.

The at least one curved reflecting surface may be a single curved reflecting surface.

A standard deviation of a distribution of the traveling directions of the plurality of pieces of pixel light reflected off the single reflecting surface may be smaller than 0.13.

The image generator may emit, to the lens system and along the reference axis, the image light making up a rectangular image that has paired long sides that face each other, and paired short sides that face each other. In this case, when a direction that corresponds to a short-side direction in which the short side of the image extends is defined as a first direction, the image being made up by the image light emitted to the lens system; and when a direction that corresponds to a long-side direction in which the long side of the image extends is defined as a second direction, the image being made up by the image light emitted to the lens system, the single reflecting surface may have a positive power in the case in which the projection optical system is viewed in the first direction. Further, the single reflecting surface may have a positive power in the case in which the projection optical system is viewed in the second direction.

The projection optical system may be configured such that 0.02<θLx/360<0.47, where θLx represents an angle formed when the projection optical system is viewed in the first direction, the angle being formed by a piece of short-side pixel light incident on the single reflecting surface and the piece of short-side pixel light reflected off the single reflecting surface, the piece of short-side pixel light being a piece of pixel light that is from among the plurality of pieces of pixel light and corresponds to a pixel situated in a middle portion of the short side of the image.

The image generator may emit, to the lens system and along the reference axis, the image light making up a rectangular image that has paired long sides that face each other, and paired short sides that face each other. In this case, when a direction that corresponds to a short-side direction in which the short side of the image extends is defined as a first direction, the image being made up by the image light emitted to the lens system; and when a direction that corresponds to a long-side direction in which the long side of the image extends is defined as a second direction, the image being made up by the image light emitted to the lens system, the projection optical system may be configured such that 0.35<MIN[θa1, θa2]/MAX [θa1, θa2]<0.96, where θa1 represents a certain angle formed when the projection optical system is viewed in the second direction, the certain angle being formed by a piece of first long-side pixel light incident on a final reflecting surface, and the piece of first long-side pixel light reflected off the final reflecting surface, and θa2 represents another angle formed when the projection optical system is viewed in the second direction, the other angle being formed by a piece of second long-side pixel light incident on the final reflecting surface, and the piece of second long-side pixel light reflected off the final reflecting surface, the piece of first long-side pixel light being a piece of pixel light that is from among the plurality of pieces of pixel light and corresponds to a pixel situated in a middle portion of one of the long sides of the image, the piece of second long-side pixel light being a piece of pixel light that is from among the plurality of pieces of pixel light and corresponds to a pixel situated in a middle portion of another of the long sides of the image, the final reflecting surface being a curved reflecting surface that is included in the at least one curved reflecting surface and off which the plurality of pieces of pixel light is reflected to be headed for the onto-projection object.

The image generator may emit, to the lens system and along the reference axis, the image light making up a rectangular image that has paired long sides that face each other, and paired short sides that face each other. In this case, when a direction that corresponds to a short-side direction in which the short side of the image extends is defined as a first direction, the image being made up by the image light emitted to the lens system; and when a direction that corresponds to a long-side direction in which the long side of the image extends is defined as a second direction, the image being made up by the image light emitted to the lens system, the projection optical system may be configured such that −0.1<θLy/360<0.1, where θLy represents an intersection angle formed when the projection optical system is viewed in the second direction, the intersection angle being an angle of intersection of a traveling direction of a piece of first long-side pixel light reflected off a final reflecting surface, and a traveling direction of a piece of second long-side pixel light reflected off the final reflecting surface, the piece of first long-side pixel light being a piece of pixel light that is from among the plurality of pieces of pixel light and corresponds to a pixel situated in a middle portion of one of the long sides of the image, the piece of second long-side pixel light being a piece of pixel light that is from among the plurality of pieces of pixel light and corresponds to a pixel situated in a middle portion of another of the long sides of the image, the final reflecting surface being a curved reflecting surface that is included in the at least one curved reflecting surface and off which the plurality of pieces of pixel light is reflected to be headed for the onto-projection object.

The image generator may emit, to the lens system and along the reference axis, the image light making up a rectangular image that has paired long sides that face each other, and paired short sides that face each other. In this case, when a direction that corresponds to a short-side direction in which the short side of the image extends is defined as a first direction, the image being made up by the image light emitted to the lens system; and when a direction that corresponds to a long-side direction in which the long side of the image extends is defined as a second direction, the image being made up by the image light emitted to the lens system, a curved reflecting surface that is from among the at least one curved reflecting surface and exhibits a largest difference between a power observed in the case in which the projection optical system is viewed in the first direction and a power observed in the case in which the projection optical system is viewed in the second direction, may be a final reflecting surface, the final reflecting surface being a curved reflecting surface that is included in the at least one curved reflecting surface and off which the plurality of pieces of pixel light is reflected to be headed for the onto-projection object.

The image generator may emit, to the lens system and along the reference axis, the image light making up a rectangular image that has paired long sides that face each other, and paired short sides that face each other. In this case, the lens system may include an adjustment optical component that controls one of an angle of view in a short-side direction in which the short side of the image extends, and an angle of view in a long-side direction in which the long side of the image extends.

The adjustment optical component may include a cylindrical lens.

The traveling directions of the plurality of pieces of pixel light may correspond to traveling directions of respective principal rays of the plurality of pieces of pixel light.

An image display system according to an embodiment of the present technology includes an onto-projection object onto which projection is performed, and the image display apparatus.

An image is displayed on the onto-projection object by image light that includes a plurality of pieces of pixel light being projected onto the onto-projection object. Further, the onto-projection object displaying thereon the image in a state in which the traveling directions of the plurality of pieces of pixel light incident on the onto-projection object are controlled.

The onto-projection object may be a hologram screen or a Fresnel lens screen.

A projection optical system according to an embodiment of the present technology is a projection optical system that projects image light including a plurality of pieces of pixel light onto an onto-projection object onto which projection is performed, the image light being generated by light emitted by a light source being modulated. The projection optical system includes the lens system and the reflection optical system.

### BRIEF DESCRIPTION OF DRAWINGS

FIG. 1 is a schematic diagram used to describe another advantage of a super-wide-angle liquid crystal projector.

FIG. 2 schematically illustrates an example of projection of an image onto a hologram screen.

FIG. 3 schematically illustrates an example of a configuration of a projection-type image display apparatus according to a first embodiment.

FIG. 4 schematically illustrates an example of a configuration of an image display system according to the first embodiment.

FIG. 5 schematically illustrates the example of the configuration of the image display system according to the first embodiment.

FIG. 6 schematically illustrates the example of the configuration of the image display system according to the first embodiment.

FIG. 7 is a light-path diagram illustrating an example of a schematic configuration of a projection optical system according to the first embodiment.

FIG. 8 is a light-path diagram illustrating an example of a schematic configuration of the projection optical system according to the first embodiment.

FIG. 9 is a table in which examples of parameters related to image projection are given.

FIG. 10 is a schematic diagram used to describe the parameters illustrated in FIG. 9.

FIG. 11 illustrates lens data of the image display apparatus.

FIG. 12 is a table in which examples of aspheric coefficients for optical components included in the projection optical system are given.

FIG. 13 is a diagram used to describe an assessment of traveling directions of a plurality of pieces of pixel light reflected to be headed for a screen.

FIG. 14 is a table in which a result of assessing the traveling directions of the plurality of pieces of pixel light is given.

FIG. 15 schematically illustrates parameters for feature points regarding the projection optical system.

FIG. 16 schematically illustrates the parameters for the feature points regarding the projection optical system.

FIG. 17 is a table in which values of the parameters set in FIGS. 15 and 16 are given.

FIG. 18 schematically illustrates an example of a distortion in an image projected onto the hologram screen.

FIG. 19 is a set of graphs in which examples of diagrams of transverse aberrations related to a projected image are given.

FIG. 20 schematically illustrates an example of a configuration of an image display system according to a second embodiment.

FIG. 21 schematically illustrates the example of the configuration of the image display system according to the second embodiment.

FIG. 22 schematically illustrates the example of the configuration of the image display system according to the second embodiment.

FIG. 23 is a light-path diagram illustrating an example of a schematic configuration of a projection optical system according to the second embodiment.

FIG. 24 is a light-path diagram illustrating an example of a schematic configuration of the projection optical system according to the second embodiment.

FIG. 25 illustrates lens data of the image display apparatus.

FIG. 26 is a table in which examples of aspheric coefficients for optical components included in the projection optical system are given.

FIG. 27 schematically illustrates parameters for feature points regarding the projection optical system.

FIG. 28 schematically illustrates the parameters for the feature points regarding the projection optical system.

FIG. 29 is a table in which values of the parameters set in FIGS. 27 and 28 are given.

FIG. 30 schematically illustrates an example of a distortion in an image projected onto the hologram screen.

FIG. 31 is a set of graphs in which examples of diagrams of transverse aberrations related to a projected image are given.

FIG. 32 schematically illustrates an example of a configuration of an image display system according to a third embodiment.

FIG. 33 schematically illustrates the example of the configuration of the image display system according to the third embodiment.

FIG. 34 schematically illustrates the example of the configuration of the image display system according to the third embodiment.

FIG. 35 is a light-path diagram illustrating an example of a schematic configuration of a projection optical system according to the third embodiment.

FIG. 36 is a light-path diagram illustrating an example of a schematic configuration of the projection optical system according to the third embodiment.

FIG. 37 illustrates lens data of the image display apparatus.

FIG. 38 is a table in which examples of aspheric coefficients for optical components included in the projection optical system are given.

FIG. 39 schematically illustrates parameters for feature points regarding the projection optical system.

FIG. 40 schematically illustrates the parameters for the feature points regarding the projection optical system.

FIG. 41 is a table in which values of the parameters set in FIGS. 39 and 38 are given.

FIG. 42 schematically illustrates an example of a distortion in an image projected onto the hologram screen.

FIG. 43 is a set of graphs in which examples of diagrams of transverse aberrations related to a projected image are given.

FIG. 44 schematically illustrates an example of a configuration of an image display system according to a fourth embodiment.

FIG. 45 schematically illustrates the example of the configuration of the image display system according to the fourth embodiment.

FIG. 46 schematically illustrates the example of the configuration of the image display system according to the fourth embodiment.

FIG. 47 is a light-path diagram illustrating an example of a schematic configuration of a projection optical system according to the fourth embodiment.

FIG. 48 is a light-path diagram illustrating an example of a schematic configuration of the projection optical system according to the fourth embodiment.

FIG. 49 is a table in which examples of parameters related to image projection are given.

FIG. 50 illustrates lens data of the image display apparatus.

FIG. 51 illustrates the lens data of the image display apparatus.

FIG. 52 is a table in which examples of aspheric coefficients for optical components included in the projection optical system are given.

FIG. 53 is the table in which the examples of the aspheric coefficients for the optical components included in the projection optical system are given.

FIG. 54 is a table in which a result of assessing traveling directions of a plurality of pieces of pixel light is given.

FIG. 55 schematically illustrates parameters for feature points regarding the projection optical system.

FIG. 56 schematically illustrates the parameters for the feature points regarding the projection optical system.

FIG. 57 is a table in which values of the parameters set in FIGS. 55 and 56 are given.

FIG. 58 schematically illustrates an example of a distortion in an image projected onto the hologram screen.

FIG. 59 is a set of graphs in which examples of diagrams of transverse aberrations related to a projected image are given.

### MODE(S) FOR CARRYING OUT THE INVENTION

Embodiments according to the present technology will now be described below with reference to the drawings.

### [Overview of Projection-Type Image Display Apparatus]

An overview of a projection-type image display apparatus is described briefly using a liquid crystal projector as an example.

The liquid crystal projector spatially modulates light irradiated by a light source to form an optical image (image light) depending on a video signal.

For example, a liquid crystal display element that is an image modulation element is used to modulate light. For example, a three-CCD liquid crystal projector that includes panel-shaped liquid crystal display elements (liquid crystal panels) that respectively correspond to red, green, and blue, is used.

The optical image is enlarged to be projected by a projection optical system, and is displayed on a screen.

### [Ultra-Short Focus Projector]

When a super-wide-angle projection optical system is adopted, this makes it possible to obtain a super-wide-angle liquid crystal projector, where the half-field angle is, for example, greater than or equal to 70 degrees. Of course, an angle used to define whether the super-wide angle is supported is not limited to the value greater than or equal to 70 degrees.

In the super-wide-angle liquid crystal projector, a large screen can be displayed even on a small projection space. In other words, enlarged projection can also be performed when a distance between a liquid crystal projector and a screen is small.

Consequently, the following advantages are provided.

A liquid crystal projector can be arranged to be close to a screen. This makes it possible to sufficiently decrease the possibility that light coming from the liquid crystal projector will enter human eyes directly. This results in a high degree of safety.

A shadow of, for example, a human does not appear on a screen. This makes it possible to make a presentation efficiently.

There is a high degree of freedom in selecting a placement location. This makes it possible to easily place in a small placement space or on a ceiling with a large number of obstacles.

When the liquid crystal projector is used by being placed on a wall, this makes it possible to easily perform maintenance such as routing of a cable, compared to when the liquid crystal projector is placed on a ceiling.

A degree of freedom in setting for, for example, a meeting space, a classroom, or a conference room can be increased.

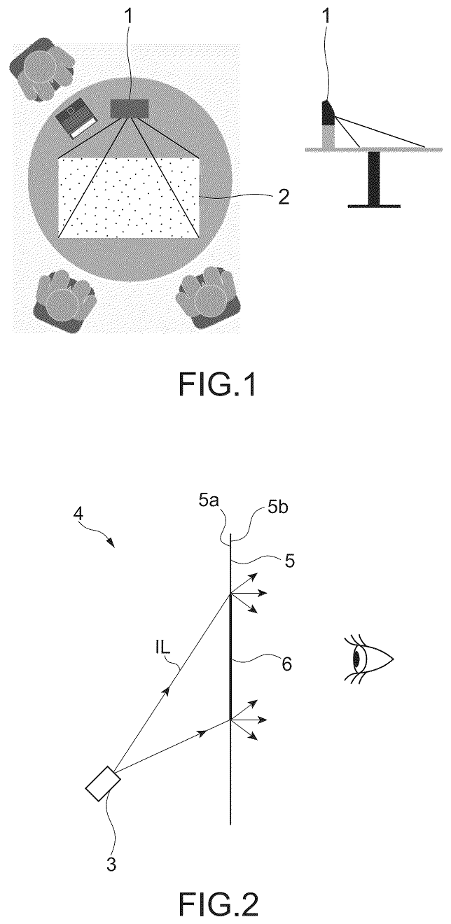

FIG. 1 is a schematic diagram used to describe another advantage of the super-wide-angle liquid crystal projector.

As illustrated in FIG. 1, the placement of a super-wide-angle liquid crystal projector 1 on a table makes it possible to project an enlarged image 2 onto the table.

Such a way of use is also possible, and this makes it possible to use a space efficiently.

Recently, there has been an increasing demand for a super-wide-angle liquid crystal projector with widespread use of, for example, an interactive white board at, for example, school or workplace. Further, similar liquid crystal projectors are used in the field of, for example, digital signage (electronic advertisement).

For example, a technology such as a liquid crystal display (LCD) or a plasma display panel (PDP) can also be used as an interactive white board. The use of a super-wide-angle liquid crystal projector makes it possible to provide a large screen with lower costs, compared to when the technologies described above are used.

Note that the super-wide-angle liquid crystal projector is also called, for example, a short focus projector or an ultra-short focus projector.

[Projection of Image onto Hologram Screen]

FIG. 2 schematically illustrates an example of projection of an image onto a hologram screen.

As illustrated in FIG. 2, a hologram screen 5 can also be used as a transparent screen in an image display system 4 that uses a projector 3.

Note that the super-wide-angle liquid crystal projector 1 illustrated in FIG. 1, or a projector that does not support a super-wide angle may be used as the projector 3 illustrated in FIG. 2.

In the example illustrated in FIG. 2, the hologram screen 5 including a transmissive hologram is used as a transparent screen. A user can view an image 6 that is projected onto the hologram screen 5 to be superimposed on a background.

As illustrated in FIG. 2, image light IL is emitted by the projector 3 toward a back surface 5a of the hologram screen 5.

The image light IL entering the back surface 5a of the hologram screen 5 is diffused (scattered) by the hologram screen 5 to exit a front surface 5b toward the outside of the hologram screen 5.

In the present embodiment, the hologram screen 5 is designed such that the image light IL emitted from diagonally below exhibits a maximum gain when the light exits the hologram screen 5 in a vertical direction relative to the hologram screen 5.

This makes it possible to provide a highly visible high-quality image to a user who is viewing the image 6 at a substantially horizontal position relative to the hologram screen 5. Of course, the design of the hologram screen 5 is not limited to such a design.

As described above, the hologram screen 5 serves to display thereon an image in a state in which a traveling direction of the entering image light IL is controlled.

A material and the like of a transmissive hologram included in the hologram screen are not limited, and, for example, any photosensitive material may be used. Moreover, any holographic optical element (HOE) that serves as a transmissive hologram may be used as appropriate. Further, a method for forming a hologram screen by performing exposure to light is also not limited, and may be set discretionarily according to, for example, the wavelength or the emission direction of object light or reference light.

For example, a screen that uses scatterers such as fine particles, a Fresnel lens, or a microlens to diffuse light may be used as a transparent screen.

Further, the transparent screen may include a transparent display such as a transparent OELD using organic electroluminescence (EL) (OLE).

Furthermore, for example, any film or coating that can diffuse image light IL may be used as the transparent screen. Moreover, any technology for providing a transparent display surface may be used.

### First Embodiment

### [Image Display Apparatus]

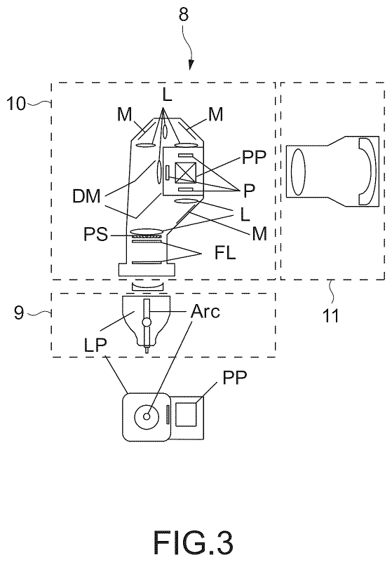

FIG. 3 schematically illustrates an example of a configuration of a projection-type image display apparatus according to a first embodiment of the present technology.

An image display apparatus 8 includes a light source 9, an illumination optical system 10, and a projection optical system 11.

The light source 9 is arranged to emit a light beam to the illumination optical system 10.

For example, a high-pressure mercury lamp is used as the light source 9. Moreover, a solid-state light source such as a light-emitting diode (LED) or a laser diode (LD) may be used.

The illumination optical system 10 uniformly irradiates a light beam emitted by the light source 9 onto a surface of an image modulation element (a liquid crystal panel P) that is a primary image plane.

In the illumination optical system 10, the light beam emitted by the light source 9 passes through two fly eye lenses FL, a polarization conversion element PS, and a condenser L in this order to be converted into a uniform light beam by aligning the polarization.

The light beam passing through the condenser L is split by a dichroic mirror DM into pieces of color component light of red, green, and blue, where only light of a specific wavelength band is reflected off the dichroic mirror DM.

The pieces of color component light of red, green, and blue respectively enter the liquid crystal panels P (the image modulation elements) provided correspondingly to the respective colors of red, green, and blue using total-reflection mirrors M and lenses L. Then, each liquid crystal panel P performs light modulation according to a video signal.

The pieces of color component light are combined by a dichroic prism PP to generate image light that makes up an image. Then, the generated image light is emitted toward the projection optical system 11.

Optical components and others that are included in the illumination optical system 10 are not limited, and an optical component that is different from the optical components described above may be used.

For example, a reflective liquid crystal panel or a digital micromirror device (DMD) may be used as an image modulation element instead of the transmissive liquid crystal panel P.

Further, for example, a polarization beam splitter (PBS); a color combining prism that combines video signals of the respective colors of red, green, and blue; or a total internal reflection (TIR) prism may be used instead of the dichroic prism PP.

In the present embodiment, the illumination optical system 10 serves as an image generator that modulates light emitted by the light source to generate image light including a plurality of pieces of pixel light.

The plurality of pieces of pixel light included in the image light refers to pieces of light each making up a corresponding one of a plurality of pixels included in an image that is projected onto an onto-projection object onto which projection is performed. In the present embodiment, pixel light is light emitted from each one of a plurality of pixels included in the image modulation elements (the liquid crystal panels P) generating to emit image light.

The projection optical system 11 adjusts image light emitted from the illumination optical system 10, and performs enlarged projection onto a screen that is a secondary image plane. In other words, the projection optical system 11 adjusts image information regarding an image in a primary image plane (the liquid crystal panels P), and performs enlarged projection onto a secondary image plane (a screen).

The image display apparatus 8 according to the present embodiment is a super-wide-angle image display apparatus as illustrated in FIG. 1.

Further, the image display apparatus 8 projects image light onto a hologram screen as illustrated in FIG. 2 that serves as the onto-projection object.

Of course, a scope of application of the present technology is not limited to the super-wide-angle image display apparatus. Further, the present technology is not limited to the case in which a hologram screen serves as the onto-projection object.

### [Projection Optical System]

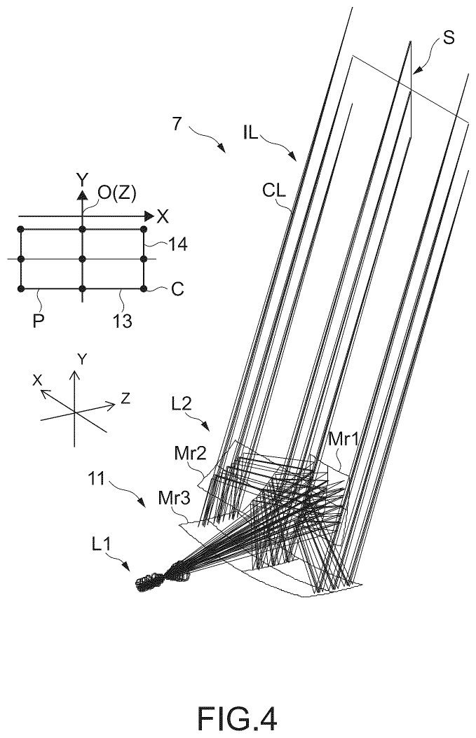

FIGS. 4 to 8 are light-path diagrams each illustrating a specific example of a configuration of an image display system 7 according to the present embodiment, or a specific example of a configuration of the projection optical system 11 according to the present embodiment.

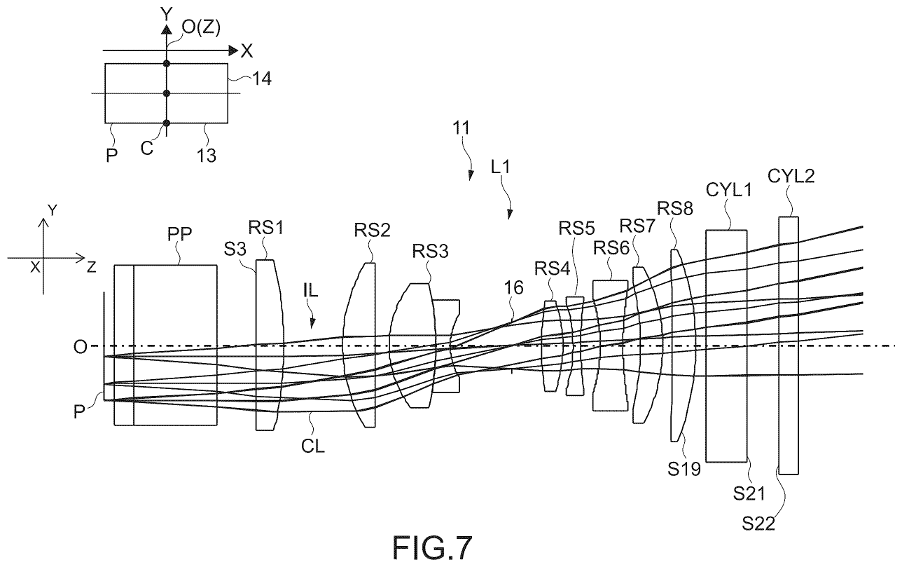

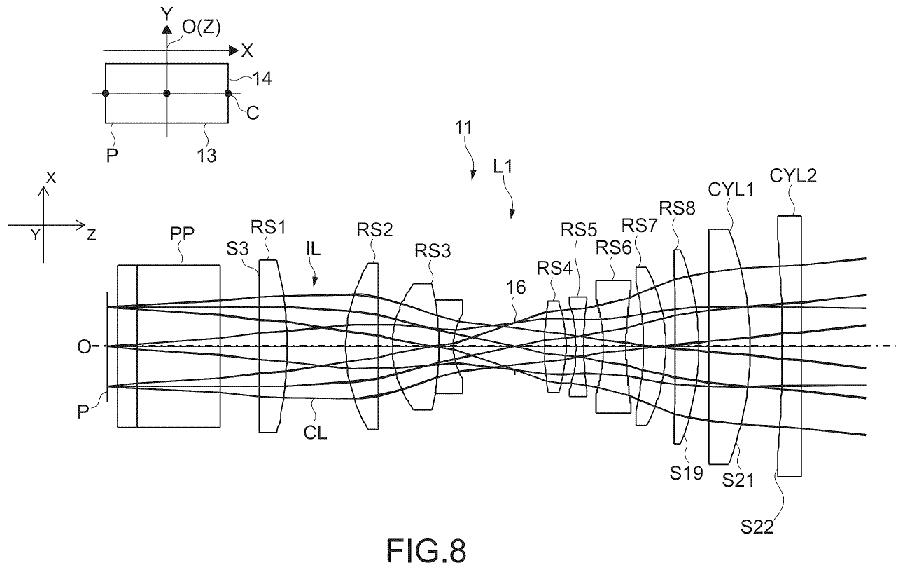

In the present embodiment, image light IL is emitted from the illumination optical system 10 along a reference axis (this reference axis is hereinafter referred to as an optical axis O) that extends in a specified direction, as illustrated in FIGS. 7 and 8.

In other words, pieces of image light IL of red, green, and blue that are respectively emitted from three liquid crystal panels P respectively corresponding to the colors of red, green, and blue are combined by the dichroic prism PP illustrated in FIGS. 7 and 8 to be emitted along the optical axis O.

The liquid crystal panel P illustrated in FIGS. 7 and 8 is arranged such that an emission direction of the image light IL is parallel to the optical axis O, that is, the liquid crystal panel P illustrated in FIGS. 7 and 8 is arranged to be oriented toward a direction that vertically intersects the optical axis O. The two other liquid crystal panels P are arranged relative to the dichroic prism PP such that pieces of image light IL emitted from the two other liquid crystal panels P are combined with the piece of image light IL emitted from the liquid crystal panel P illustrated in FIGS. 7 and 8.

FIGS. 4 to 8 each schematically illustrate the liquid crystal panel P arranged vertically to the optical axis O.

The liquid crystal panel P is rectangular, and has a rectangular shape having paired long sides 13 that face each other, and paired short sides 14 that face each other. Further, the liquid crystal panel P emits image light IL making up a rectangular image that has paired long sides that face each other, and paired short sides that face each other.

Pieces of pixel light CL respectively emitted from a plurality of pixels C arranged on the facing long sides 13 of the liquid crystal panel P are focused on a screen (a hologram screen) S. Accordingly, portions, in the image, that correspond to the facing long sides of the image are displayed.

Pieces of pixel light CL respectively emitted from a plurality of pixels C arranged on the facing short sides 14 of the liquid crystal panel P are focused on the screen S. Accordingly, portions, in the image, that correspond to the facing short sides of the image are displayed.

Note that, when the screen S onto which the image light IL is projected is designed to be curved, an image may have a shape that is not rectangular, and, for example, an aspect ratio of a portion, in the image, that corresponds to the long side of the image (an image made up by pieces of pixel light CL emitted from the long side 13 of the liquid crystal panel P), and a portion, in the image, that corresponds to the short side of the image (an image made up by pieces of pixel light CL emitted from the short side 14 of the liquid crystal panel P) may be changed.

In the present embodiment, the image light IL (a plurality of pieces of pixel light CL) is projected onto the screen S having a planar shape.

Hereinafter, a direction in which the long side 13 of the liquid crystal panel P extends (a long-side direction of the liquid crystal panel P) is referred to as an X direction, and a direction in which the short side 14 of the liquid crystal panel P extends (a short-side direction of the liquid crystal panel P) is referred to as a Y direction. Further, a direction in which the optical axis O extends (an emission direction in which image light IL is emitted from the illumination optical system 10) is referred to as a Z direction.

In this case, the Y direction is a direction that corresponds to a short-side direction in which a short side of the image extends, the image being made up by image light IL emitted to a lens system L1 of the projection optical system 11, and the Y direction corresponds to an embodiment of a first direction according to the present technology.

Further, the X direction is a direction that corresponds to a long-side direction in which a long side of the image extends, the image being made up by the image light IL emitted to the lens system L1 of the projection optical system 11, and the X direction corresponds to an embodiment of a second direction according to the present technology.

For example, the long-side and short-side directions of the image displayed on the screen S in a three-dimensional space (an XYZ space) are changed according to, for example, a position at which the screen S is arranged, an orientation of the screen S, or a shape of the screen S.

The above-described first direction (the Y direction in the present embodiment) and second direction (the X direction in the present embodiment) are not the long-side and short-side directions of the image displayed on the screen S, but directions that are defined by image light L emitted to the projection optical system 11.

Note that, in the present embodiment, the first direction and the long-side direction of an image actually displayed on the screen S are identical to each other (the Y direction), and the second direction and the short-side direction of the image actually displayed on the screen S are identical to each other (the X direction).

Further, an XYZ coordinate system is determined such that the optical axis O is situated on a Z axis, as schematically illustrated in FIGS. 4 to 8. Furthermore, in the description, the Y direction is referred to as an up-and-down direction (the positive side of a Y axis is referred to as an upward side, and the negative side of the Y axis is referred to as a downward side) for convenience. Of course, an orientation, a pose, and the like of the image display apparatus 8 in use are not limited when the present technology is applied.

In the present embodiment, the liquid crystal panel P is arranged at a position offset downward from the optical axis O (on the negative side of the Y axis), as illustrated in FIGS. 4 to 8. Further, image light IL (a plurality of pieces of pixel light CL) is emitted from the liquid crystal panel P along the optical axis O.

Note that the emission of image light IL (a plurality of pieces of pixel light CL) along the optical axis O corresponds to an embodiment of emitting image light along a reference axis.

FIG. 4 is a perspective view of the projection optical system 11 projecting image light IL onto the screen S, as viewed from diagonally above.

FIG. 4 illustrates light paths of pieces of pixel light CL that are respectively emitted from nine pixels C in total that are a pixel situated in a center portion of the liquid crystal panel P, pixels respectively situated in four corner portions of the liquid crystal panel P, pixels respectively situated in middle portions of the respective long sides 13, and pixels respectively situated in middle portions of the respective short sides 14.

Note that the pixel light CL is emitted from a pixel C of the liquid crystal panel P in the form of divergent light (diffused light). The emitted pixel light C is focused on the screen S by the projection optical system 11 to be displayed as a pixel of a projected image.

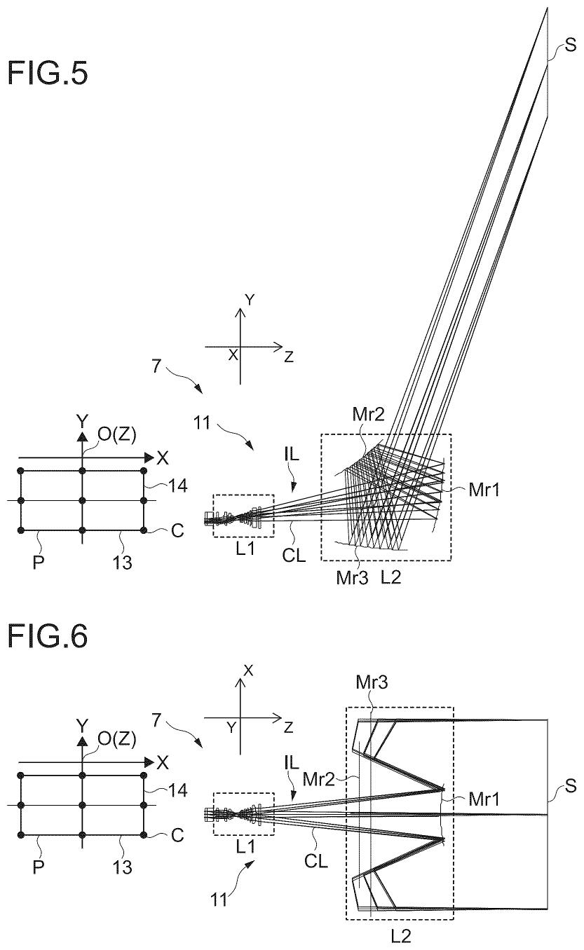

FIG. 5 is a side view of the projection optical system 11 projecting the image light IL onto the screen S, as viewed in the X direction.

FIG. 6 is a side view of the projection optical system 11 projecting the image light IL onto the screen S, as viewed in the Y direction.

As in the case of FIG. 4, FIGS. 5 and 6 each illustrate the light paths of the pieces of pixel light CL respectively emitted from nine pixels C in total that are the pixel situated in the center portion of the liquid crystal panel P, the pixels respectively situated in the four corner portions of the liquid crystal panel P, the pixels respectively situated in the middle portions of the respective long sides 13, and the pixels respectively situated in the middle portions of the respective short sides 14.

FIG. 7 is a cross-sectional view of the lens system L1 when the projection optical system 11 is cut along the Y axis. FIG. 7 illustrates the light paths of the pieces of pixel light CL respectively emitted from three pixels C in total that are the pixel situated in the center portion of the liquid crystal panel P, and the pixels respectively situated in the middle portions of the respective long sides 13.

FIG. 8 is a cross-sectional view of the lens system L1 when the projection optical system 11 is cut along an X axis.

FIG. 8 illustrates the light paths of the pieces of pixel light CL respectively emitted from three pixels C in total that are the pixel situated in the center portion of the liquid crystal panel P, and the pixels respectively situated in the middle portions of the respective short sides 14.

Note that FIGS. 7 and 8 each illustrate cross-sectional shapes of optical surfaces (such as lens surfaces and reflecting surfaces) of optical components included in the projection optical system 11. On the other hand, for example, hatching that represents cross sections of the optical components is omitted, in order to make the illustrations simple.

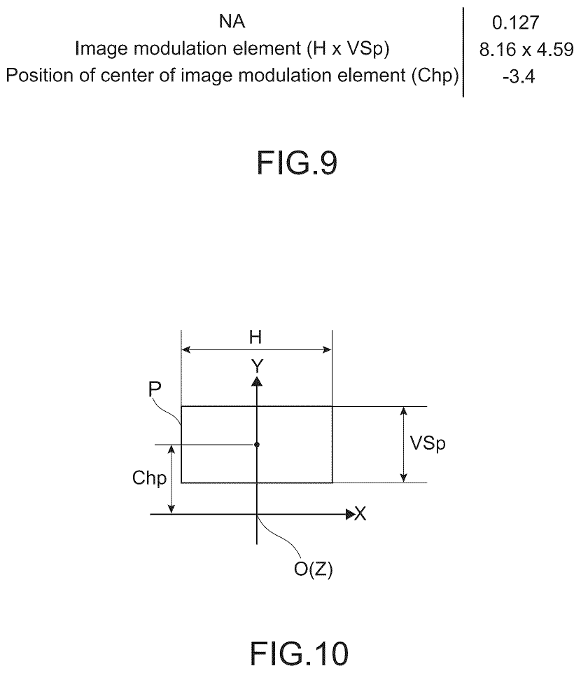

FIG. 9 is a table in which examples of parameters related to image projection are given.

FIG. 10 is a schematic diagram used to describe the parameters illustrated in FIG. 9.

A numerical aperture NA of the projection optical system 11 on the side of the primary image plane is 0.127.

The image modulation element (the liquid crystal panel P) has a length of 8.16 mm in a horizontal direction and a length of 4.59 mm in a vertical direction (H×VSp).

A position (Chp) of the center of the image modulation element is a position corresponding to-3.4 mm, with a portion situated further upward than the optical axis O being a positive side. Thus, the position of the center of the image modulation element is a position situated further downward than the optical axis O by 3.4 mm, as illustrated in FIGS. 4 to 8.

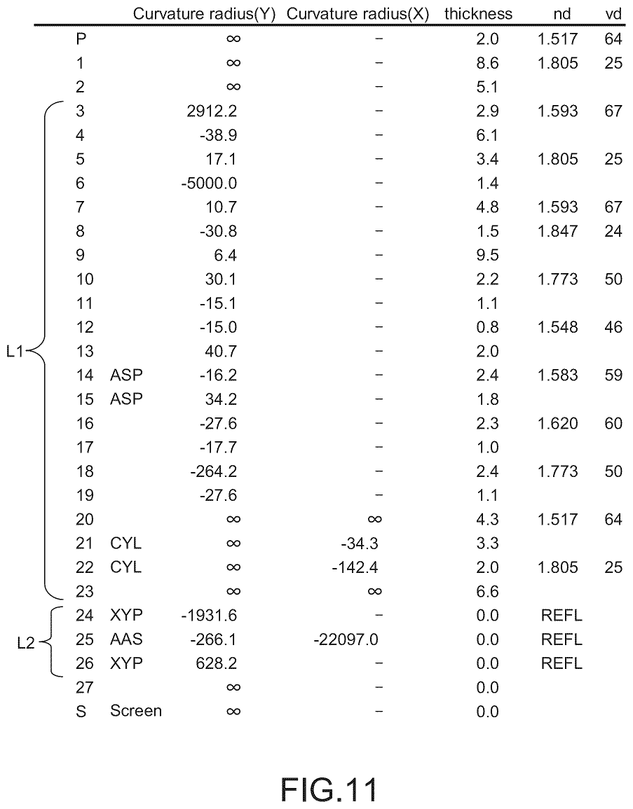

FIG. 11 illustrates lens data of the image display apparatus.

FIG. 11 illustrates data of optical components (lens surfaces) that are denoted by numbers 1 to 27 and arranged from the primary image plane (P) to the secondary image plane(S), and the curved screen S.

A radius of curvature (mm) in the Y direction, a radius of curvature (mm) in the X direction, a core thickness d (mm), a refractive index nd at the D-line (587.56 nm), and an Abbe number νd at the D-line are given as data for the respective optical components (lens surfaces).

The radius of curvature (mm) in the Y direction is typically a parameter that corresponds to a shape of a lens surface as viewed in the X direction. The radius of curvature (mm) in the X direction is typically a parameter that corresponds to a shape of the lens surface as viewed in the Y direction.

In the lens data illustrated in FIG. 11, the lens surfaces S14 and S15 are rotationally symmetric aspheric surfaces (ASP), and a formula indicated below is applied.

$$z = \frac{c {h}^{2}}{1 + {\{ 1 - ( 1 + k ) {c}^{2} {h}^{2} \}}^{1 / 2}} + A {h}^{4} + {Bh}^{6} + C {h}^{8} + D {h}^{10} + E {h}^{12} + F {h}^{14} + G {h}^{16} + H {h}^{18} + J {h}^{20} \qquad [ Math . 1 ]$$

The following parameters are used in Mathematical Formula 1.
z: sag
c: curvature (CUY) at surface vertex
k: conic constant (K)
A, B, C, D, E, F, G, H, and J: the 4th, 6th, 8th, 10th, 12th, 14th, 16th, 18th, and 20th order deformation coefficients
h: height of light ray (h²=x²+y²)

The sag Z when the height h of a light ray is input to Mathematical Formula 1 is used as a parameter that represents a lens-surface shape depending on the height of a light ray. Note that the “sag” refers to a distance between a plane and a point on a lens surface in a direction of the optical axis, the plane being a plane that passes through a surface vertex and is vertical to the optical axis O.

In the lens data illustrated in FIG. 11, the lens surfaces S21 and S22 are cylindrical surfaces (CYL).

A generating-line direction in which a generating line of the cylindrical surface extends is set to be parallel to the Y direction. Thus, the radius of curvature (mm) in the Y direction is ∞.

In the lens data illustrated in FIG. 11, the lens surfaces S24 and S26 are XY polynomial aspheric surfaces (XYP), and a formula indicated below is applied.

$$\begin{matrix}z = \frac{c {r}^{2}}{1 + \{ 1 - ( 1 + k ) {c}^{2} {r}^{2} \} 1 / 2} + {{\sum }_{j = 2}}^{66} {C}_{j} {x}^{m} {y}^{n} \\ j = [ {( m + n )}^{2} + m + 3 n ] / 2 + 1\end{matrix} \qquad [ Math . 2 ]$$

In Mathematical Formula 2, parameters indicated below are used.
z: sag
c: curvature (CUY) at surface vertex
k: conic constant (K)
Cj: coefficient of a monomial x^{m}yⁿ

In the lens data illustrated in FIG. 11, the lens surface S25 is an anamorphic aspheric surface (AAS), and a formula indicated below is applied.

$$z = \frac{{CUXx}^{2} + {CUYy}^{2}}{1 + \{ 1 - ( 1 + K X ) {CUX}^{2} {x}^{2} - ( 1 + K Y ) {CUY}^{2} {y}^{2} \} 1 / 2} + AR {\{ ( 1 - AP ) {x}^{2} + ( 1 + AP ) {y}^{2} \}}^{2} + B R {\{ ( 1 - BP ) {x}^{2} + ( 1 + B P ) {y}^{2} \}}^{3} + CR {\{ ( 1 - CP ) {x}^{2} + ( 1 + CP ) {y}^{2} \}}^{4} + D R {\{ ( 1 - DP ) {x}^{2} + ( 1 + D P ) {y}^{2} \}}^{5} \qquad [ Math . 3 ]$$

In Mathematical Formula 3, parameters indicated below are used.
z: sag
CUX, CUY: curvatures of x and y
KX, KY: conic constants of x and y
AR, BR, CR, and DR: the 4th, 6th, 8th, and 10th order deformation conic rotationally symmetrical portions
AP, BP, CP, and DP: the 4th, 6th, 8th, and 10th order deformation conic rotationally asymmetrical portions

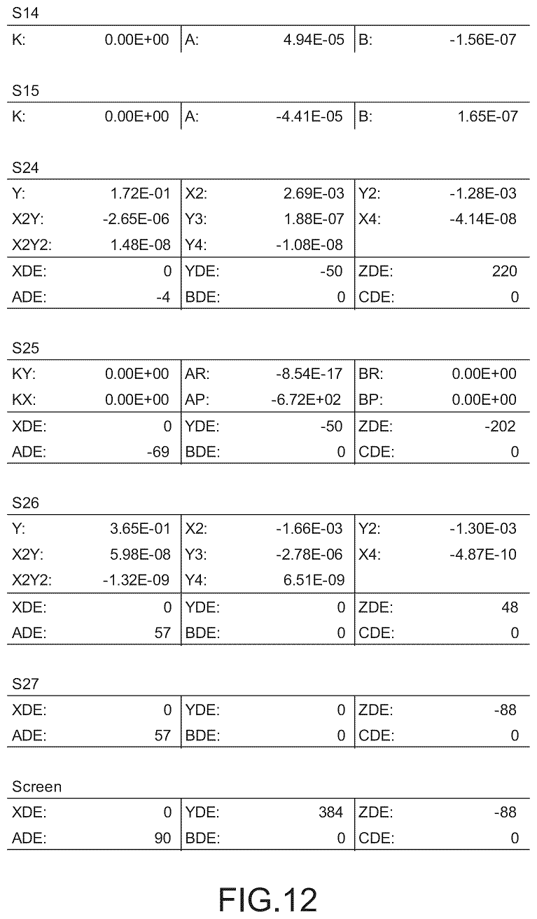

FIG. 12 is a table in which aspheric coefficients for the lens surfaces S14 and S15 (ASP), the lens surfaces S24 and S26 (XYP), and the lens surface S25 (ASS) are given.

Shapes of the respective lens surfaces can be defined using Mathematical Formulas 1 to 3 described above by use of the coefficients illustrated in FIG. 12. Note that, in the present embodiment, the shapes of the respective lens surfaces are defined without using any higher-order coefficients that are not illustrated in FIG. 12.

Further, parallel decentering (XDE, YDE, ZDE) in respective directions of X, Y, and Z, and rotation decentering (ADE, BDE, CDE) for rotation about axes are given with respect to the lens surfaces S24, S25, and S26 in FIG. 12.

The lens surfaces S24 and S25 are each arranged by being decentered parallel to the Y and Z directions and being rotated about the X axis.

The lens surface S26 is arranged by being decentered parallel to the Z direction and being rotated about the X axis.

In the present embodiment, the lens surfaces S24 to S26 are arranged by being decentered, as described above. In other words, the lens surfaces S24 to S26 are decentered aspheric reflecting surfaces.

Further, parallel decentering and rotation decentering are given for a lens surface S27 and the screen S in FIG. 12.

In the present disclosure, configurations of the respective embodiments with respect to the image display apparatus, the image display system, and the projection optical system according to the present technology are calculated by performing simulation using design software, where the configurations are new configurations that never existed before.

In the lens data illustrated in FIG. 12, data for the lens surface S27 is data used to make clear a position of the screen S, and is data necessary for simulation.

The screen S is arranged by being decentered parallel to the Y and Z directions and being rotated 90 degrees about the X axis. Thus, the screen S is arranged vertically to the Z direction.

As illustrated in, for example, FIGS. 5 and 6, the projection optical system 11 according to the present embodiment includes the lens system L1 and a reflection optical system L2.

The lens system L1 is formed along the optical axis O (the reference axis) at a position at which image light IL generated by the illumination optical system 10 enters the lens system L1. The lens system L1 refracts a plurality of pieces of pixel light CL included in the generated image light IL, and emits the plurality of pieces of refracted pixel light CL.

The reflection optical system L2 is formed along the optical axis O (the reference axis). The plurality of pieces of pixel light CL is reflected off the reflection optical system L2 to be headed for the screen S in a state in which traveling directions of the plurality of pieces of pixel light CL emitted from the lens system L1 are aligned.

In the present embodiment, the lens system L1 includes eight optical components (rotationally symmetric lenses) RS1 to RS8 each having an axis of rotational symmetry, and two cylindrical lenses CYL1 and CYL2, as illustrated in FIGS. 7 and 8.

The rotationally symmetric lenses RS1 to RS8 are arranged such that the rotational-symmetry axis of each of the rotationally symmetric lenses RS1 to RS8 and the optical axis O coincide. It can also be said that the rotational-symmetry axes of the rotationally symmetric lenses RS1 to RS8 are optical axes of the rotationally symmetric lenses RS1 to RS8.

The rotationally symmetric lenses RS1 to RS8 are arranged on the optical axis O in this order from the side of the illumination optical system 10 (hereinafter referred to as an input side) to the side of the screen S (hereinafter referred to as an output side).

The cylindrical lenses CYL1 and CYL2 are arranged on the optical axis O in this order on an output side of the rotationally symmetric lens RS8 situated at the end on an output side of the rotationally symmetric lenses. The cylindrical lenses CYL1 and CYL2 are arranged such that a generating line of a cylindrical surface of each of the cylindrical lenses CYL1 and CYL2 intersects the optical axis O. In other words, the cylindrical lenses CYL1 and CYL2 are arranged such that a surface vertex of the cylindrical surface intersects the optical axis O.

A lens surface that is included the rotationally symmetric lens RS1 and situated on the input side of the lens system L1 corresponds to a lens surface S3 in the lens data illustrated in FIG. 10, the rotationally symmetric lens RS1 being the first rotationally symmetric lens situated closest to the illumination optical system 10.

A lens surface that is included in the rotationally symmetric lens RS8 and situated on the output side of the lens system L1 corresponds to a lens surface S19 in the lens data illustrated in FIG. 10, the rotationally symmetric lens RS8 being situated at the end on the output side of the rotationally symmetric lenses.

A lens surface that is included in the cylindrical lens CYL1 and situated on the output side of the lens system L1 corresponds to a surface S21 (CLY) in the lens data illustrated in FIG. 10, the cylindrical lens CYL1 being a cylindrical lens situated on the input side of the lens system L1. A lens surface that is included in the cylindrical lens CYL2 and situated on the input side of the lens system L1 corresponds to a surface S22 (CLY), the cylindrical lens CYL2 being a cylindrical lens situated on the output side of the lens system L1.

The lens surfaces S3 to S23 illustrated in FIG. 10 serve as the lens system L1. The lens surfaces S3 to S23 refract a plurality of pieces of pixel light CL emitted from respective pixels C of the liquid crystal panel P, and emit the plurality of pieces of pixel light CL to the reflection optical system L2.

It can also be said that the lens system L1 is an optical system that partially has rotational symmetry. The rotationally symmetric lenses RS1 to RS8 are arranged such that the rotational-symmetry axis of each of the rotationally symmetric lenses RS1 to RS8 and the optical axis O coincide. This makes it possible to make the lens system L1 smaller in size in the Y direction, and thus to make the apparatus smaller in size.

It can also be said that the two cylindrical lenses CYL1 and CYL2 arranged at the end on the output side of the lens system L1 are a cylindrical lens group.

Only a portion of the optical components included in the lens system L1 that includes an effective region that is a region that image light IL enters may be used. The use of a portion of the optical components makes it possible to make the projection optical system 11 smaller in size.

As illustrated in FIGS. 4 to 6, the reflection optical system L2 includes three aspheric reflecting surfaces Mr1 to Mr3.

From among the three aspheric reflecting surfaces Mr1 to Mr3, the aspheric reflecting surface Mr1 off which a plurality of pieces of pixel light CL emitted from the lens system L1 is reflected is referred to as a first reflecting surface Mr1 using the same reference sign.

The aspheric reflecting surface Mr2 off which the plurality of pieces of pixel light CL reflected off the first reflecting surface Mr1 is reflected is referred to as a second reflecting surface Mr2 using the same reference sign.

The aspheric reflecting surface Mr3 off which the plurality of pieces of pixel light CL reflected off the second reflecting surface Mr2 is reflected to be headed for the screen S (the onto-projection object) is referred to as a third reflecting surface Mr3 using the same reference sign.

The first reflecting surface Mr1 corresponds to the lens surface S24 (XYP) in the lens data illustrated in FIG. 10.

The second reflecting surface Mr2 corresponds to the lens surface S25 (ASS) in the lens data illustrated in FIG. 10.

The third reflecting surface Mr3 corresponds to the lens surface S26 (XXP) in the lens data illustrated in FIG. 10.

The first to third reflecting surfaces Mr1 to Mr3 correspond to an embodiment of at least one curved reflecting surface having rotational asymmetry according to the present technology. These reflecting surfaces are rotationally asymmetric aspheric surfaces, and can also be freeform surfaces. The first to third reflecting surfaces Mr1 to Mr3 are foldable decentered freeform surfaces.

Note that, in the present embodiment, the third reflecting surface Mr3 is a curved reflecting surface that is from among the at least one curved reflecting surface included in the reflection optical system L2 and off which a plurality of pieces of pixel light CL is reflected to be headed for the screen S (the onto-projection object). The third reflecting surface Mr3 corresponds to an embodiment of a final reflecting surface according to the present technology.

As illustrated in FIGS. 4 to 6, the plurality of pieces of pixel light CL emitted from the lens system L1 is reflected off the first reflecting surface Mr1 to be headed upward (toward the positive side of the Y axis).

The plurality of pieces of pixel light CL reflected off the first reflecting surface Mr1 is reflected off the second reflecting surface Mr2 to be headed downward (toward the negative side of the Y axis).

The plurality of pieces of pixel light CL reflected off the second reflecting surface Mr2 is reflected off the third reflecting surface Mr3 to be headed obliquely upward.

The plurality of pieces of pixel light CL reflected off the third reflecting surface Mr3 is projected onto the screen S arranged to be vertical to the Z direction.

In the present embodiment, image display is performed at ultra-short focus, as illustrated in FIGS. 4 to 6.

### [Traveling Directions of Plurality of Pieces of Pixel Light CL Reflected to be Headed for Screen S]

A plurality of pieces of pixel light CL is reflected off the reflection optical system L2 including the first to third reflecting surfaces Mr1 to Mr3 to be headed for the screen S in a state in which traveling directions of the plurality of pieces of pixel light CL are aligned. In other words, traveling directions of a plurality of pieces of pixel light CL headed for the screen S from the third reflecting surface Mr3 are aligned.

The plurality of pieces of image light CL is emitted from the pixels C of the liquid crystal panel P in the form of divergent light (diffused light). The traveling direction of the image light CL is defined by a traveling direction of a principal ray of the image light CL.

In the present embodiment, a stop (an aperture stop) 16 is provided to the lens system L1, as illustrated in FIGS. 7 and 8. Principal rays of the plurality of pieces of pixel light CL are light lays that pass through the center of the stop 16. Note that, in the present embodiment, the center of the stop 16 is situated on the optical axis O.

When the stop 16 is not provided to the lens system L1, the present technology can be applied by, for example, defining, as a principal ray, component light that is included in each of the pieces of pixel light CL and emitted along the optical axis O (in the Z direction).

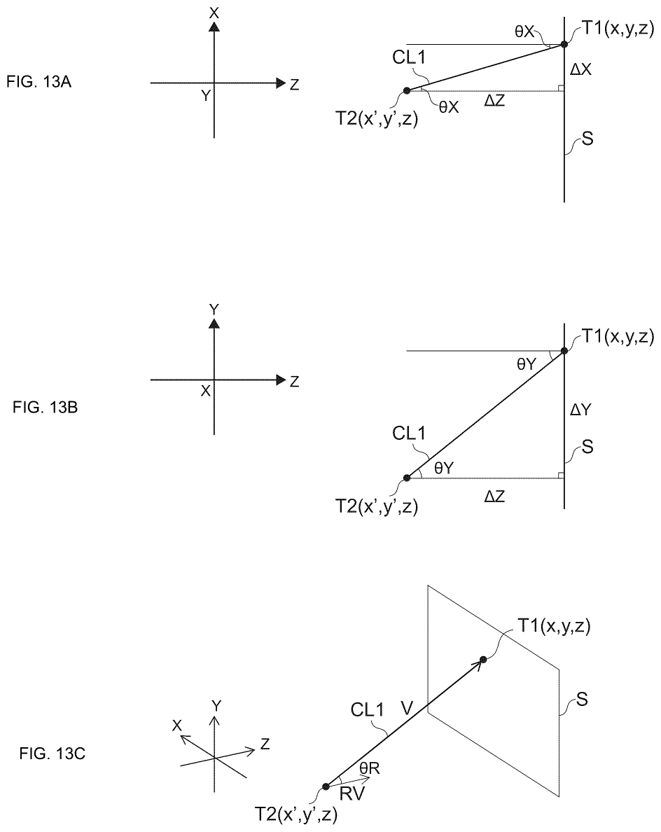

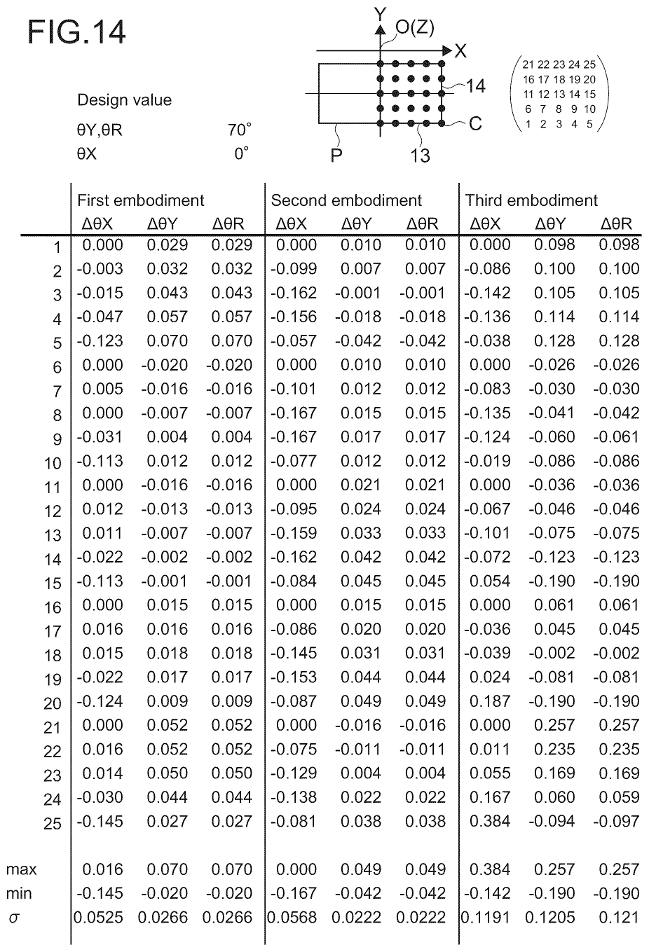

An assessment of traveling directions of a plurality of pieces of pixel light CL reflected to be headed for the screen S is described with reference to FIGS. 13 and 14.

In the present embodiment, a plurality of pieces of pixel light CL is projected onto the planar screen S. Thus, a traveling direction of pixel light CL (a principal ray) reflected to be headed for the screen S can be assessed using an intersection angle (an incident angle) of the image light CL (the principal ray) relative to the screen S, as illustrated in A and b of FIG. 13.

Further, the traveling direction of each piece of pixel light CL (each principal ray) reflected to be headed for the screen S can also be assessed using an angle of intersection of a specified reference vector and a vector that extends in the XYZ space in parallel with the traveling direction of the piece of pixel light CL (the principal ray), as illustrated in C of FIG. 13.

First, a position T1 (x, y, z) of each piece of pixel light CL (each principal ray) on the screen S is calculated using coordinates of X, Y, and Z, as illustrated in A to C of FIG. 13. Further, a position T2 (x′, y′, z′) of each piece of pixel light CL (each principal ray) on the third reflecting surface Mr3 is calculated.

Then, the following are defined: (x-x′)=ΔX, (y-y′)=ΔY, and (z-z′)=ΔZ.

In A and B of FIG. 13, the traveling direction of each piece of pixel light CL is assessed using an angle of intersection of the screen S and a line connecting the position T1 and the position T2.

A of FIG. 13 schematically illustrates an angle θX of intersection of pixel light CL and the screen S when the projection optical system 11 is viewed in the Y direction. In other words, θX represents an angle of intersection of the pixel light CL and the screen S in the X direction. θX can be calculated using a formula indicated below.

$$θ X = arc tan ( Δ X / Δ Z )$$

With respect to a plurality of pieces of pixel light CL, variation in θX can be considered equivalent to variation in a traveling direction of a piece of pixel light CL reflected to be headed for the screen S when the projection optical system 11 is viewed in the Y direction.

In the present embodiment, the projection optical system 11 can project a plurality of pieces of pixel light CL onto the screen S in a state in which traveling directions of the plurality of pieces of pixel light CL are aligned. Thus, the plurality of pieces of pixel light CL can be projected onto the screen S in a state in which the variation in θX is sufficiently reduced.

Of course, the projection onto the screen S can also be performed in a state in which values of Δθ for all of the pieces of pixel light CL are equal. In other words, incident angles of the respective pieces of pixel light CL as viewed from the Y direction can also be equalized.

B of FIG. 13 schematically illustrates an angle θY of intersection of pixel light CL and the screen S when the projection optical system 11 is viewed in the X direction. In other words, θY represents an angle of intersection of the pixel light CL and the screen S in the Y direction. θY can be calculated using a formula indicated below.

$$θ Y = arc tan ( Δ Y / Δ Z )$$

With respect to a plurality of pieces of pixel light CL, variation in θY can be considered equivalent to variation in a traveling direction of a piece of pixel light CL reflected to be headed for the screen S when the projection optical system 11 is viewed in the X direction.

In the present embodiment, the projection optical system 11 can project a plurality of pieces of pixel light CL onto the screen S in a state in which traveling directions of the plurality of pieces of pixel light CL are aligned. Thus, the plurality of pieces of pixel light CL can be projected onto the screen S in a state in which the variation in θY is sufficiently reduced.

Of course, the projection onto the screen S can also be performed in a state in which values of ΔY for all of the pieces of pixel light CL are equal. In other words, incident angles of the respective pieces of pixel light CL as viewed from the X direction can also be equalized.

In C of FIG. 13, a vector V (ΔX, ΔY, ΔZ) of which a start point is the position T2 and of which an end point is the position T1, is assumed. Then, the traveling direction of each piece of pixel light CL is assessed using an angle θR formed by the vector V and a specified reference vector RV.

When the reference vector RV is a unit vector (0,0,1) that is parallel to the Z direction, θR can be calculated using a formula indicated below.

$$θ R = arc cos ( Δ Z / {( Δ {X}^{2} + Δ {Y}^{2} + Δ {Z}^{2} )}^{1 / 2} )$$

With respect to a plurality of pieces of pixel light CL, variation in θR can be considered equivalent to variation in a traveling direction of a piece of pixel light CL reflected to be headed for the screen S in a three-dimensional space (a space represented by coordinates of X, Y, and Z).

In the present embodiment, the projection optical system 11 can project a plurality of pieces of pixel light CL onto the screen S in a state in which traveling directions of the plurality of pieces of pixel light CL are aligned. Thus, the plurality of pieces of pixel light CL can be projected onto the screen S in a state in which the variation in θR is sufficiently reduced.

Of course, the projection onto the screen S can also be performed in a state in which values of ΔR for all of the pieces of pixel light CL are equal. In other words, incident angles of the respective pieces of pixel light CL can also be equalized in the three-dimensional space (the space represented by coordinates of X, Y, and Z).

It can also be said that θX and θY, which are respectively illustrated in A and B of FIG. 13, are parameters each used to assess a traveling direction of pixel light CL (a principal ray) as viewed from a specified direction.

It can also be said that θR, which is illustrated in C of FIG. 13, is a parameter used to assess a traveling direction of pixel light CL (a principal ray) in a three-dimensional space (a space represented by coordinates of X, Y, and Z).

FIG. 14 illustrates a result of assessing traveling directions of pieces of pixel light CL from 25 pixels C that are extracted at even intervals from a region that is half the liquid crystal panel P and is situated on a positive side in the X direction. Specifically, 25 pixels C in total are extracted from the region that is half the liquid crystal panel P, where the 25 pixels includes five pixels in the X direction and five pixels in the Y direction.

Note that a light path of image light CL emitted from a pixel C situated in a region that is half the liquid crystal panel P and is situated on the positive side in the X direction, and a light path of pixel light CL emitted from a pixel C situated in a region that is half the liquid crystal panel P and is situated on a negative side in the X direction have a symmetric relationship with each other in the XYZ space.

Numbers 1 to 25 given on the left in the table illustrated in FIG. 13 are numbers for the pixel C. On the right of the liquid crystal panel P illustrated in FIG. 13, the numbers 1 to 25 are assigned correspondingly to positions of the respective pixels C.

For example, in the region that is half the liquid crystal panel P, a pixel C situated in a lower-left corner portion in the figure is numbered 1, and a pixel C situated in a lower-right corner portion in the figure is numbered 5. In the region that is half the liquid crystal panel P, a pixel C situated in an upper-left corner portion in the figure is numbered 21, and a pixel C situated in an upper-right corner portion in the figure is numbered 25. A pixel C situated in a center portion in the region that is half the liquid crystal panel P, is numbered 13.

Note that FIG. 14 also illustrates assessments of the traveling direction of each piece of pixel light CL for second and third embodiments described later.

ΔθX, which is illustrated in FIG. 14, represents a difference between a design value used as a reference and a value of θX, which is illustrated in A of FIG. 13. In the present embodiment, the design value is set to 0 degrees. In other words, the projection optical system 11 is designed such that a direction that intersects the screen S vertically is a reference direction for a traveling direction of a piece of pixel light CL when the projection optical system 11 is viewed in the Y direction.

It can also be said that the design value used as a reference is an ideal design value. Thus, it can also be said that, in the present embodiment, the projection optical system 11 is designed considering that a principal ray of each piece of pixel light CL is ideally incident on the screen S vertically when the projection optical system 11 is viewed in the Y direction.

Since the design value is set to 0 degrees, ΔθX, which is illustrated in FIG. 14, is equal to θX, which is calculated using the formula above. In other words, ΔθX=θX.

ΔθY represents a difference between a design value used as a reference and a value of θY, which is illustrated in B of FIG. 13. In the present embodiment, the design value is set to 70 degrees. In other words, the projection optical system 11 is designed such that a direction that intersects the screen S at an angle of 70 degrees is a reference direction for the traveling direction of the piece of pixel light CL when the projection optical system 11 is viewed in the X direction.

In other words, it can also be said that the projection optical system 11 is designed considering that the principal ray of each piece of pixel light CL is ideally incident on the screen S at an angle of 70 degrees when the projection optical system 11 is viewed in the X direction. Note that an angle formed by the principal ray and the screen S is set to be an incident angle, the incident angle is obtained using the following formula: 90 degrees−70 degrees=20 degrees.

Since the design value is set to 70 degrees, ΔθY, which is illustrated in FIG. 14, is obtained by subtracting 70 from θY, which is calculated using the formula above. In other words, ΔθY=θY−70.

ΔθR represents a difference between a design value used as a reference and a value of θR, which is illustrated in C of FIG. 13. In the present embodiment, the design value is set to 70 degrees. In other words, the projection optical system 11 is designed such that a direction that intersects the Z direction at an angle of 70 degrees is a reference direction for the traveling direction of the piece of pixel light CL, where the reference vector RV extends in the Z direction.

In other words, the projection optical system 11 is designed considering that the principal ray of each piece of pixel light CL is ideally incident on the screen S at an angle of 70 degrees with respect to the Z direction.

Since the design value is set to 70 degrees, ΔθR, which is illustrated in FIG. 14, is obtained by subtracting 70 from θR, which is calculated using the formula above. In other words, ΔθR=θR−70.

FIG. 14 illustrates maximum values (max), minimum values (min), and standard deviations σ for ΔθX, ΔθY, and ΔθR. The maximum value (max) represents a maximum amount of shift from a set value on a positive side. The minimum value (min) represents a maximum amount of shift from the set value on a negative side.

The standard deviation σ for ΔθX corresponds to a standard deviation of a distribution of traveling directions of a plurality of pieces of pixel light CL reflected off the reflection optical system L2, the traveling directions of the plurality of pieces of pixel light CL being traveling directions when the projection optical system 11 is viewed in the Y direction. In the present embodiment, the standard deviation σ for ΔθX is 0.0525.

The standard deviation σ for ΔθY corresponds to a standard deviation of a distribution of traveling directions of the plurality of pieces of pixel light CL reflected off the reflection optical system L2, the traveling directions of the plurality of pieces of pixel light CL being traveling directions when the projection optical system 11 is viewed in the X direction. In the present embodiment, the standard deviation σ for ΔθΥ is 0.0266.

The standard deviation σ for ΔθR corresponds to a standard deviation of a distribution of traveling directions of the plurality of pieces of pixel light CL reflected off the reflection optical system L2. In the present embodiment, the standard deviation σ for ΔθR is 0.0266.

As the assessment result illustrated in FIG. 14 shows, the projection optical system 11 according to the present embodiment can project a plurality of pieces of pixel light CL onto the screen S in a state in which traveling directions of principal rays of the plurality of pieces of pixel light CL are aligned.

### [Points of Features of Projection Optical System 11]

Feature points regarding the projection optical system 11 according to the present embodiment are described.

The points described below are not necessarily indispensable conditions. On the other hand, the provision of features described below results in being advantageous in aligning traveling directions of respective pieces of pixel light CL.

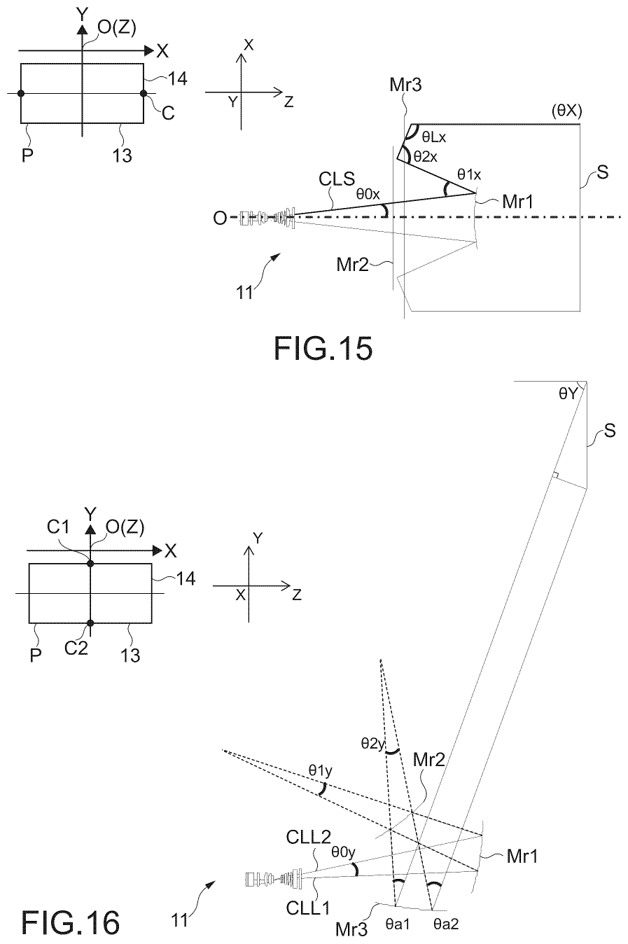

As illustrated in FIGS. 15 and 16, parameters are set for light paths of pieces of image light IL (pieces of pixel light CL) as described below in order to describe the feature points regarding the projection optical system 11.

FIGS. 15 and 16 illustrate light paths of principal rays of pieces of pixel light CL. The parameters illustrated in FIGS. 15 and 16 are set for the light paths of the principal rays of the pieces of pixel light CL.

FIG. 15 illustrates the projection optical system 11 as viewed in the Y direction.

FIG. 15 illustrates light paths of pieces of pixel light (principal rays) CL emitted from pixels C respectively situated in middle portions of the respective short sides 14 of the liquid crystal panel P.

The pieces of pixel light CL emitted from the pixels C respectively situated in the middle portions of the respective short sides 14 of the liquid crystal panel P are pieces of pixel light that respectively correspond to pixels respectively situated in middle portions of respective short sides of a projected image, and are hereinafter referred to as pieces of short-side pixel light CLS.

FIG. 15 illustrates light paths of two pieces of short-side pixel light CLS. When the projection optical system 11 is viewed in the Y direction, the light paths of the two pieces of short-side pixel light CLS are symmetric about the optical axis O.

As illustrated in FIG. 15, parameters indicated below are set for pieces of short-side pixel light CLS when the projection optical system 11 is viewed in the Y direction.
θ0x: an angle formed by the short-side pixel light CLS and the optical axis O
θ1x: an angle formed by the short-side pixel light CLS incident on the first reflecting surface Mr1 and the short-side pixel light CLS reflected off the first reflecting surface Mr1
θ2x: an angle formed by the short-side pixel light CLS incident on the second reflecting surface Mr2 and the short-side pixel light CLS reflected off the second reflecting surface Mr2
θLx: an angle formed by the short-side pixel light CLS incident on the third reflecting surface Mr3 and the short-side pixel light CLS reflected off the third reflecting surface Mr3

Note that FIG. 15 schematically illustrates an angle θX of intersection (a design value of 0 degrees) of the short-side of pixel light CLS and the screen S when the projection optical system 11 is viewed in the Y direction.

FIG. 16 illustrates the projection optical system 11 as viewed in the X direction.

FIG. 16 illustrates light paths of pieces of pixel light (principal rays) CL emitted from pixels C respectively situated in middle portions of the respective long sides 13 of the liquid crystal panel P.

The pieces of pixel light CL emitted from the pixels C respectively situated in the middle portions of the respective long sides 13 of the liquid crystal panel P are pieces of pixel light that respectively correspond to pixels respectively situated in middle portions of respective long sides of a projected image, and are hereinafter referred to as pieces of long-side pixel light CLL.

Further, the two pieces of long-side pixel light CLL are referred in a distinguished manner. In the present embodiment, the long-side pixel light CLL emitted from a pixel C1 of the liquid crystal panel P that is situated closer to the optical axis is referred to as a first long-side pixel light CLL1. The long-side pixel light CLL emitted from a pixel C2 of the liquid crystal panel P that is situated more distant from the optical axis is referred to as a second long-side pixel light CLL1.

The first long-side pixel light CLL1 corresponds to pixel light corresponding to a pixel situated in a middle portion of one of long sides of an image. The second long-side pixel light CLL2 corresponds to pixel light corresponding to a pixel situated in a middle portion of another of the long sides of the image.

In the example illustrated in FIG. 16, the first long-side pixel light CLL1 makes up a portion that is included in an image and corresponds to an upper long side of the image. The second long-side pixel light CLL2 makes up a portion that is included in the image and corresponds to an upper long side of the image.

Note that which of two long sides of an image is selected to be associated with the first long-side pixel light CLL1 or the second long-side pixel light CLL2 in order to define the first long-side pixel light CLL1 and the second long-side pixel light CLL2, is not limited. One of long sides of an image can be selected to define the first long-side pixel light CLL1. Then, it is sufficient if the second long-side pixel light CLL2 is defined by another of the long sides.

As illustrated in FIG. 16, parameters indicated below are set for the first long-side pixel light CLL1 and the second long-side pixel light CLL2 when the projection optical system 11 is viewed in the X direction.
θ0y: an angle of intersection of a traveling direction of the first long-side pixel light CLL1 and a traveling direction of the second long-side pixel light CLL2
θ1y: an angle of intersection of the traveling direction of the first long-side pixel light CLL1 reflected off the first reflecting surface Mr1, and the traveling direction of the second long-side pixel light CLL2 reflected off the first reflecting surface Mr1
θ2y: an angle of intersection of the traveling direction of the first long-side pixel light CLL1 reflected off the second reflecting surface Mr2, and the traveling direction of the second long-side pixel light CLL2 reflected off the second reflecting surface Mr2
θLy: an angle of intersection of the traveling direction of the first long-side pixel light CLL1 reflected off the third reflecting surface Mr3, and the traveling direction of the second long-side pixel light CLL2 reflected off the third reflecting surface Mr3
θa1: an angle formed by the first long-side pixel light CLL1 incident on the third reflecting surface Mr3, and the first long-side pixel light CLL1 reflected off the third reflecting surface Mr3
θa2: an angle formed by the second long-side pixel light CLL2 incident on the third reflecting surface Mr3, and the second long-side pixel light CLL2 reflected off the third reflecting surface Mr3

Note that θLy represents an intersection angle when the first long-side pixel light CLL1 incident on the screen S and the second long-side pixel light CLL2 incident on the screen S intersect in a state of being situated very distant from each other, and it is difficult to illustrate the intersection angle θLy. Thus, the illustration is omitted (In the present embodiment, θLy is 0.0 degrees, and the two light rays do not intersect).

Note that FIG. 16 schematically illustrates an angle θY of intersection (a design value of 70 degrees) of the long-side of pixel light CLL and the screen S when the projection optical system 11 is viewed in the X direction.

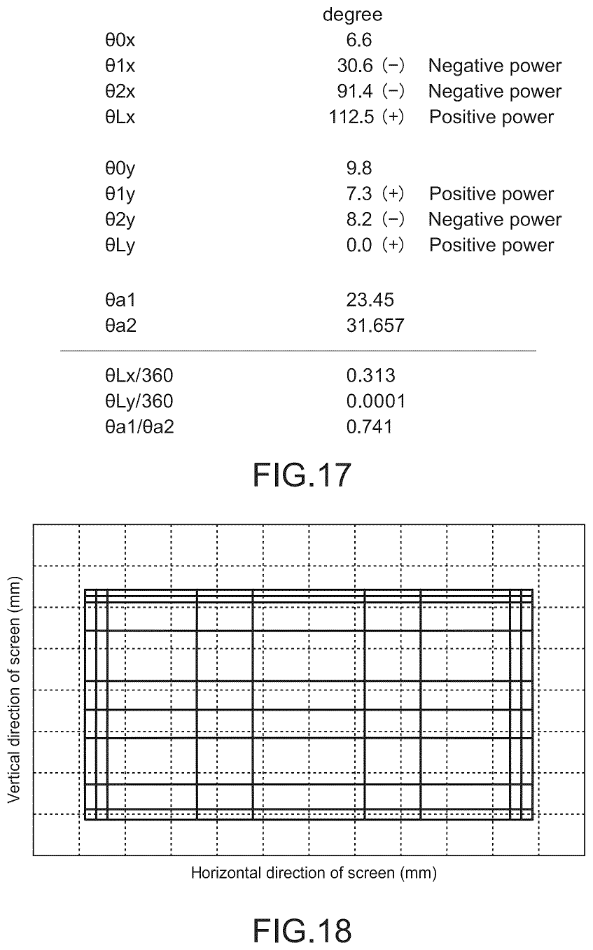

FIG. 17 is a table in which values of the parameters set in FIGS. 15 and 16 are given. The feature points regarding the projection optical system 11 are described in reference to the values as necessary.

### (Powers of First to Third Reflecting Surfaces Mr1 to Mr3)

The following are the values of the parameters illustrated in FIG. 15.
θ0x: 6.6 degrees
θ1x: 30.6 degrees
θ2x: 91.4 degrees
θLx: 112.5 degrees

It is possible to understand, from these values, optical powers (refractive powers) of the first to third reflecting surfaces Mr1 to Mr3 when the projection optical system 11 is viewed in the Y direction.

Specifically, it is understood that the first reflecting surface Mr1 has a negative power, the second reflecting surface Mr2 has a negative power, and the third reflecting surface Mr3 has a positive power when the projection optical system 11 is viewed in the Y direction.

The following are the values of the parameters illustrated in FIG. 16.
θ0y: 9.8 degrees
θ1y: 7.3 degrees
θ2y: 8.2 degrees
θLy: 0.0 degrees

It is possible to understand, from these values, optical powers (refractive powers) of the first to third reflecting surfaces Mr1 to Mr3 when the projection optical system 11 is viewed in the X direction.

Specifically, it is understood that the first reflecting surface Mr1 has a positive power, the second reflecting surface Mr2 has a negative power, and the third reflecting surface Mr3 has a positive power when the projection optical system 11 is viewed in the X direction.

In the present embodiment, three curved reflecting surfaces are used in order to align traveling directions of a plurality of pieces of pixel light CL. Further, at least one curved reflecting surface is set to have a negative power to make the angle of view wider in both the case in which the projection optical system 11 is viewed in the Y direction and the case in which the projection optical system 11 is viewed in the X direction. It can be said that these points are one of the features of the projection optical system 11 according to the present embodiment.

Image light IL generated by the liquid crystal panel P is enlarged to be projected onto the screen S. In this case, pieces of pixel light CL of a plurality of pieces of pixel light CL are reflected off the first to third reflecting surfaces Mr1 to Mr3 in three stages, and traveling directions of principal rays of the plurality of pieces of pixel light CL are aligned. Further, the plurality of pieces of pixel light CL is reflected in a certain direction in at least one of the three stages in both the X and Y directions, the certain direction being a direction in which the plurality of pieces of pixel light CL is diffused by the negative power. This results in being advantageous in aligning traveling directions of a plurality of pieces of pixel light CL while maintaining the image quality.

Of course, which of the first to third reflecting surfaces Mr1 to Mr3 is set to have a negative power, may be designed discretionarily.

Discussion is held focused on a difference in power between the case in which the projection optical system 11 is viewed in the Y direction, and the case in which the projection optical system 11 is viewed in the X direction. The third reflecting surface Mr3 corresponding to a final reflecting surface exhibits a largest difference in power.

As described above, a curved reflecting surface that is from among at least one curved reflecting surface included in the reflection optical system L2 and exhibits a largest difference between a power observed when the projection optical system 11 is in the Y direction (a first direction), and a power observed when the projection optical system 11 is viewed in the X direction (a second direction), is a final reflecting surface. It can be said that this is also one of the features.

Such a configuration results in being advantageous in maintaining an aspect ratio of an image projected onto the screen S, and thus in being able to perform high-quality image display. Note that a difference between optical powers of lens surfaces can also be represented by a difference between curvatures of lens surfaces.

### (Conditional Expression (1) Regarding θLx)

The projection optical system 11 according to the present embodiment is configured such that the following is satisfied.

$$0.25 < θ Lx / 360 < 0.47 \qquad ( 1 )$$

When a value obtained by “θLx/360” exceeds an upper limit defined by the conditional expression (1), the third reflecting surface Mr3 is closer to the screen S in the Z direction than the first reflecting surface Mr1. In other words, the third reflecting surface Mr3 illustrated in FIG. 16 is shifted to be situated further rightward than the first reflecting surface Mr1 in the figure. This results in there being a good possibility that pixel light CL reflected off the third reflecting surface Mr3 will interfere with the first reflecting surface Mr1.

When the value obtained by “θLx/360” falls below a lower limit defined by the conditional expression (1), the third reflecting surface Mr3 is more distant from the screen S in the Z direction than the second reflecting surface Mr2. In other words, the third reflecting surface Mr3 illustrated in FIG. 16 is shifted to be situated further leftward than the second reflecting surface Mr2 in the figure. This results in there being a good possibility that pixel light CL reflected off the third reflecting surface Mr3 will interfere with the second reflecting surface Mr2.

When the projection optical system 11 is configured such that the conditional expression (1) is satisfied, this makes it possible to sufficiently avoid the interference of pixel light CL.

Note that, in the present embodiment, 0.313 is obtained by “θLx/360”, as illustrated in FIG. 17. Thus, the conditional expression (1) is satisfied.

Note that a conditional expression indicated below can also be obtained by multiplying a value of each member of the conditional expression (1) by 360.

$$90 < θ Lx < 170$$

### (Conditional Expression (2) Regarding θLy)

The projection optical system 11 according to the present embodiment is configured such that the following is satisfied.

$$- 0 \text{.1} < θ Ly / 360 < 0.1 \qquad ( 2 )$$

When a value obtained by “θLy/360” exceeds an upper limit defined by the conditional expression (2), an angle of incidence of a light ray will be large, and thus a reflecting surface will have a high curvature. This results in there being a good possibility that a degree of optical performance will be made lower.

When the value obtained by “θLy/360” falls below a lower limit defined by the conditional expression (2), the angle of incidence of a light ray will be small, and thus there will be a need for a larger distance between the optical systems L1 and L2 in order to perform projection in a desired size. This results in there being a good possibility that the optical systems will be made larger in size.

When the projection optical system 11 is configured such that the conditional expression (2) is satisfied, this makes it possible to sufficiently prevent a degree of optical performance from being made lower, and to prevent the optical systems from being made larger in size.

Note that, in the present embodiment, 0.0001 is obtained by “θLy/360”, as illustrated in FIG. 16. Thus, the conditional expression (2) is satisfied.

Note that a conditional expression indicated below can also be obtained by multiplying a value of each member of the conditional expression (2) by 360.

$$- 36 < θ Lx < 36$$

### (Conditional Expression (3) Regarding θa1 and θa2)

The projection optical system 11 according to the present embodiment is configured such that the following is satisfied.

$$0.35 < MIN [ θ a 1 , θ a 2 ] / MAX [ θ a 1 , θ a 2 ] < 0.96 \qquad ( 3 )$$

MIN[θa1, θa2] represents a smaller value from between θa1 and θa2.

MAX[θa1, θa2] represents a larger value from between θa1 and θa2.

When a value obtained by “MIN[θa1, θa2]/MAX[θa1, θa2]” exceeds an upper limit defined by the conditional expression (3), there is a good possibility that a plurality of pieces of pixel light CL will be concentrated onto the screen S and that an image will not be displayed properly.

When the value obtained by “MIN[θa1, θa2]/MAX[θa1, θa2]” falls below a lower limit defined by the conditional expression (3), there is a good possibility that the plurality of pieces of pixel light CL will be diffused on the screen S and that an image will not be displayed properly.

When the projection optical system 11 is configured such that the conditional expression (3) is satisfied, this makes it possible to sufficiently prevent an image from being displayed improperly due to the concentration or diffusion of the plurality of pieces of pixel light CL.

Note that, in the present embodiment, MIN[θa1, θa2]/MAX[θa1, θa2] corresponds to θa1/θa2, and 0.741 is obtained by “θa1/θa2”, as illustrated in FIG. 16. Thus, the conditional expression (3) is satisfied.

With respect to the conditional expression (3), it can also be said that MAX[θa1, θa2] represents a light ray that has a largest angle of view from among light rays coming from the lens system L1 when the projection optical system 11 is viewed in the X direction.

Further, it can also be said that MIN[θa1, θa2] represents a light ray that has a smallest angle of view from among the light rays coming from the lens system L1 when the projection optical system 11 is viewed in the X direction.

The upper and lower limits defined by each of the conditional expressions (1) to (3) can also be changed as appropriate according to, for example, the configuration of the illumination optical system 10 or the configuration of projection optical system 11. For example, two values included in the range described above can be respectively selected as a lower limit and an upper limit, and an optimal range can also be newly arranged using the selected upper and lower limits.

For example, ranges indicated below can be set for the conditional expression (1).

$$0.3 < θ Lx / 360 < 0.45$$

$$0.35 < θ Lx / 360 < 0 \text{.42}$$

$$0.4 < θ Lx / 360 < 0.40$$

For example, ranges indicated below can be set for the conditional expression (2).

$$- 0. 8 < θ Ly / 360 < 0.08$$

$$- 0.06 < θ Ly / 360 < 0 \text{.06}$$

$$- 0. 4 < θ Ly / 360 < 0.04$$

For example, ranges indicated below can be set for the conditional expression (3).

$$0.5 < MIN [ θ a 1 , θ a 2 ] / MAX [ θ a 1 , θ a 2 ] < 0.96$$

$$0.6 < MIN [ θ a 1 , θ a 2 ] / MAX [ θ a 1 , θ a 2 ] < 0.96$$

$$0.7 < MIN [ θ a 1 , θ a 2 ] / MAX [ θ a 1 , θ a 2 ] < 0.96$$

$$0.75 < MIN [ θ a 1 , θ a 2 ] / MAX [ θ a 1 , θ a 2 ] < 0.91$$

$$0.78 < MIN [ θ a 1 , θ a 2 ] / MAX [ θ a 1 , θ a 2 ] < 0.88$$

$$0.81 < MIN [ θ a 1 , θ a 2 ] / MAX [ θ a 1 , θ a 2 ] < 0.85$$

When, for example, discussion is held focused on the projection optical system 11 according to the present embodiment, a projection optical system 26 according to the second embodiment that will be described later, and a projection optical system 29 according to the third embodiment that will be described later, a conditional expression indicated below can be adopted.

$$0.7 < MIN [ θ a 1 , θ a 2 ] / MAX [ θ a 1 , θ a 2 ] < 0.96$$

[Projection of Image onto Hologram Screen]

In the present embodiment, the hologram screen 5 illustrated in FIG. 2 is used as the screen S. The screen S may be hereinafter referred to as a hologram screen S.

As illustrated in FIGS. 4 to 6, a plurality of pieces of pixel light CL of which directions of principal rays are aligned is projected onto the vertically arranged hologram screen S at an incident angle of 70 degrees. The plurality of pieces of pixel light CL incident on the hologram screen S is diffused (scattered) by the hologram screen S to exit the hologram screen S toward a user (a viewer).

In the present embodiment, the hologram screen S is designed such that the plurality of pieces of pixel light CL emitted from diagonally below exhibits a maximum gain when the pieces of light exit the hologram screen 5 in a vertical direction relative to the surface of the screen (that is, in the Z direction).

This makes it possible to provide a highly visible high-quality image to a user who is viewing an image at a substantially horizontal position relative to the hologram screen S.

A diffraction efficiency of a transmissive hologram included in the hologram screen S corresponds to a parameter that is dependent on an incident angle of light that is incident on the transmissive hologram. In other words, the diffraction efficiency of a transmissive hologram is dependent on the incident angle. It can also be said that the dependency on the incident angle is the selectivity of incident angle.

When traveling directions of a plurality of pieces of pixel light CL incident on the hologram screen S are not aligned, there will be variation in an incident angle of the piece of pixel light CL incident on the hologram screen S. Consequently, diffraction efficiencies for the respective pieces of pixel light CL will not be constant, and there is a good possibility that pixel light diffused to be oriented toward a viewer with a high degree of diffraction efficiency, and pixel light diffused to be oriented toward the viewer with a low degree of diffraction efficiency will be mixed.

In other words, when traveling directions of a plurality of pieces of pixel light CL are not aligned, there will be variation in, for example, the intensity of pixel light CL diffracted by the hologram screen S, and thus an image with unevenness of color or brightness may be displayed. Further, significant distortions may also be caused.

When the above-described unevenness or distortions caused in an image are corrected for by performing signal processing, an amount of correction may be increased to greatly decrease the brightness of the entirety of the image, or the unevenness or distortions may fail to be corrected for.

Further, an approach of generating interference fringes of different orientations (multi-slant) by changing, for each position, the angle of irradiating reference light when the hologram screen S is exposed to light, is conceivable as a method for correcting for unevenness or distortions in an image.

In the case of such a multi-slant hologram screen, the image quality is greatly affected by an angular offset of an angle formed by the image display apparatus 8 and the hologram screen S. This may result in difficulty in alignment. Further, there is a need for, for example, a large optical system used to change the angle of irradiating reference light, and a high-light-power-density light source. This may result in an increase in manufacturing costs.

In the image display apparatus 8 according to the present embodiment, the projection optical system 11 projects a plurality of pieces of pixel light CL in a state in which traveling directions of principal rays of the plurality of pieces of pixel light CL are aligned. In other words, pieces of pixel light CL of a plurality of pieces of pixel light CL have the same incident angle at any positions on a screen surface of the hologram screen S.

The incident angle of image light IL is made substantially constant. This makes it possible to sufficiently reduce, for example, unevenness or distortions caused in an image due to the hologram screen S being dependent on the incident angle. This enables high-quality image display to be performed on the hologram screen S.

Further, there is no longer a need to correct, for example, an image signal. This makes it possible to project an image with the original irradiation intensity of the image display apparatus 8. This makes it possible to display a bright image.

Furthermore, interference fringes can be generated by making the angle of irradiating reference light constant when the hologram screen S is exposed to light. In the case of such a mono-slant hologram screen S, a high degree of diffraction efficiency can be achieved by a plurality of pieces of pixel light CL being incident at an incident angle that is identical to the angle of irradiating reference light.

For example, a mono-slant transmissive hologram screen for which an angle of irradiating reference light is set according to the incident angles of a plurality of pieces of pixel light CL reflected off the reflection optical system L2 to be headed for the hologram screen S, is used. This makes it possible to obtain, for example, a very high-intensity transparent display.

The processes of manufacturing a mono-slant hologram screen can be made simpler than the processes of manufacturing a multi-slant hologram screen. This makes it possible to reduce, for example, production costs.

Further, when the mono-slant is applied, interference fringes have the same orientation. This makes it easy to perform, for example, alignment of a screen with respect to image light IL.

Thus, the use of a mono-slant hologram screen S makes it possible to provide, at low costs, the image display apparatus 8 of which, for example, the maintenance can be easily carried out. Further, the easy alignment makes it possible to sufficiently reduce an impact that, for example, assembly variation has on the accuracy of the product. This makes it possible to provide a highly accurate product.

### [Aspect Ratio of Image]

In the present embodiment, designing is performed such that an angle θX of intersection of pixel light CL and the screen S is 0 degrees when the projection optical system 11 is viewed in the Y direction, as illustrated in FIG. 15. In other words, traveling directions of a plurality of pieces of pixel light CL are aligned such that the plurality of pieces of pixel light CL is incident on the screen S vertically when the projection optical system 11 is viewed in the Y direction.

On the other hand, designing is performed such that an angle θY of intersection of the pixel light CL and the screen S is 70 degrees when the projection optical system 11 is viewed in the X direction, as illustrated in FIG. 16. In other words, the traveling directions of the plurality of pieces of pixel light CL are aligned such that the plurality of pieces of pixel light CL is incident on the screen S at an incident angle of 70 degrees when the projection optical system 11 is viewed in the X direction.

When, in the X direction and the Y direction, image light IL is projected onto the screen S at an angle of θX as illustrated in FIG. 15 and at an angle of θY as illustrated in FIG. 16, a formula indicated below holds true for an angle of view (size) in a short-side direction in which a short side of an image extends, the image being projected onto the screen S.

an angle of view in a short-side direction in which a short side of a projected image extends=angle of view in a short-side direction in which a short side of an original image extends/cos θY

In the present embodiment, θY=70 degrees. Thus, the angle of view in the short-side direction in which the short side of the projected image extends is made wider about 1.58-fold. Thus, in order to maintain the aspect ratio of the projected image, it is necessary that an angle of view (size) in a long-side direction in which a long side of the projected image extends be also made wider to a similar extent.

In the present embodiment, the two cylindrical lenses CYL1 and CYL2 are arranged such that generating lines of the cylindrical surfaces (the lens surfaces S21 and S22) are each parallel to the Y axis, as illustrated in FIG. 8. Further, an angle of view for image light IL in the long-side direction is made wider by the two cylindrical surfaces (the lens surfaces S21 and S22).

When the cylindrical lenses CYL1 and CYL2 are arranged in the lens system L1, as described above, this makes it possible to display a high-quality image for which an aspect ratio of an original image is maintained with a simple configuration.

In the present embodiment, three curved reflecting surfaces (the first to third reflecting surfaces Mr1 to Mr3) are used, and the cylindrical lenses CYL1 and CYL2 are used. These two points result in easily maintaining an aspect ratio.

Of course, an appropriate adjustment of powers (curvatures) of the three curved reflecting surfaces (the first to third reflecting surfaces Mr1 to Mr3) also makes it possible to maintain an aspect ratio of an image without using the cylindrical lenses CYL1 and CYL2. On the other hand, the use of the cylindrical lenses CYL1 and CYL2 makes it easy to maintain the aspect ratio.

In the present embodiment, the cylindrical lenses CYL1 and CYL2 are an embodiment of an adjustment optical component that controls one of an angle of view in a long-side direction in which a long side of an image extends, and an angle of view in a short-side direction in which a short side of the image extends. For example, an optical component that is different from the cylindrical lens may be used as an embodiment of the adjustment optical component according to the present technology.

Further, in the present embodiment, an angle of view in a long-side direction in which a long side of an image extends is made wider by the adjustment optical component. Without being limited thereto, the angle of view in the long-side direction in which the long side of the image extends may be made narrower by the adjustment optical component. Further, an angle of view in a short-side direction in which a short side of the image extends may be made wider or narrower by the adjustment optical component.

For example, it is sufficient if an angle of view is controlled as appropriate according to the incident angles in the X and Y directions, in order to maintain an aspect ratio.

Note that the arrangement of the cylindrical lenses CYL1 and CYL2 may result in performing distortion correction. In other words, the adjustment of the optical component according to the present technology may result in being also advantageous in performing distortion correction.

### [Distortion in Image]

FIG. 18 schematically illustrates an example of a distortion in an image projected onto the hologram screen S. It is understood that a substantially rectangular planar image is projected, and that a high performance is achieved, as illustrated in FIG. 18. Further, an aspect ratio of an image is also maintained, and thus high-quality image display is performed.

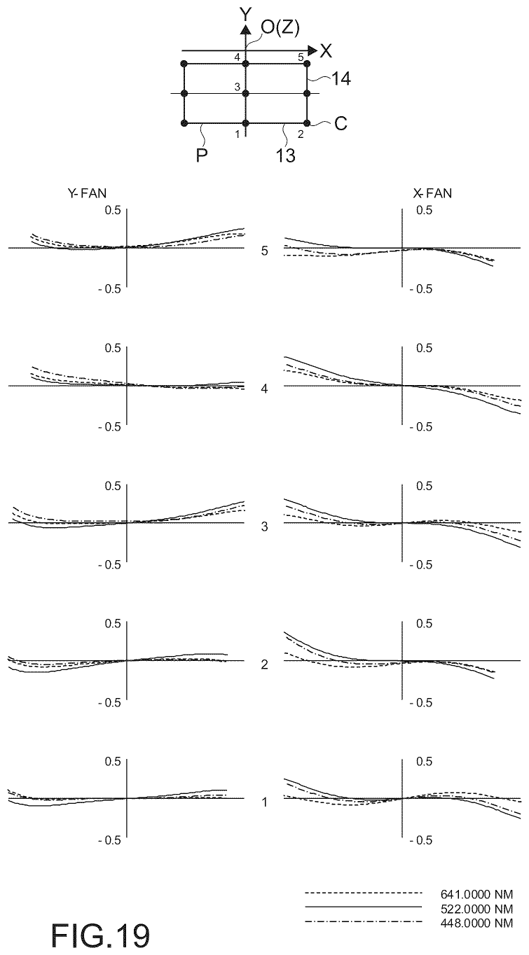

FIG. 19 is a set of graphs in which examples of diagrams of transverse aberrations related to a projected image are given.

FIG. 19 illustrates an aberration in a cross section of the liquid crystal panel P in the horizontal direction (the X direction) with respect to each of five pixels C (number 1 to number 5), and an aberration in a cross section of the liquid crystal panel P in the vertical direction (the Y direction) with respect to each of the five pixels C.

A shift in an image plane (on a vertical axis) is within about 0.5 mm at each of wavelengths of 641 nm, 522 nm, and 448 nm that are respectively indicated by a dotted line, a solid line, and a dot-dash line. It is understood that a highly accurate image can be projected.

In the image display system 7 and the image display apparatus 8 according to the present embodiment, a plurality of pieces of pixel light CL making up an image is refracted by the lens system L1 to be emitted to the reflection optical system L2, as described above. The plurality of pieces of pixel light CL is reflected off the reflection optical system L2 to be headed for the screen S in a state in which traveling directions of the plurality of pieces of pixel light CL are aligned. This makes it possible to perform high-quality image display.

In the present embodiment, the first to third reflecting surfaces Mr1 to Mr3 included in the reflection optical system L2 are foldable decentered freeform surfaces. This makes it possible to align traveling directions of a plurality of pieces of pixel light CL while maintaining a high resolution, a small amount of distortion, and the property of being small in size. Consequently, angles of incidence on the hologram screen S can be made equal.

### Second Embodiment

An image display apparatus according to the second embodiment of the present technology is described.

In the following description, descriptions of a configuration and an operation that are similar to those of the image display system 7 and image display apparatus 8 described in the embodiment above are omitted or simplified.

In an image display system 25 according to the present embodiment, the screen S is arranged more closely to the projection optical system 26, compared to the case of the first embodiment. Regarding the other points, the image display system 25 has a configuration almost similar to the configuration of the image display system according to the first embodiment.

Parameters related to image projection are the values illustrated in FIG. 9, as in the case of the first embodiment.

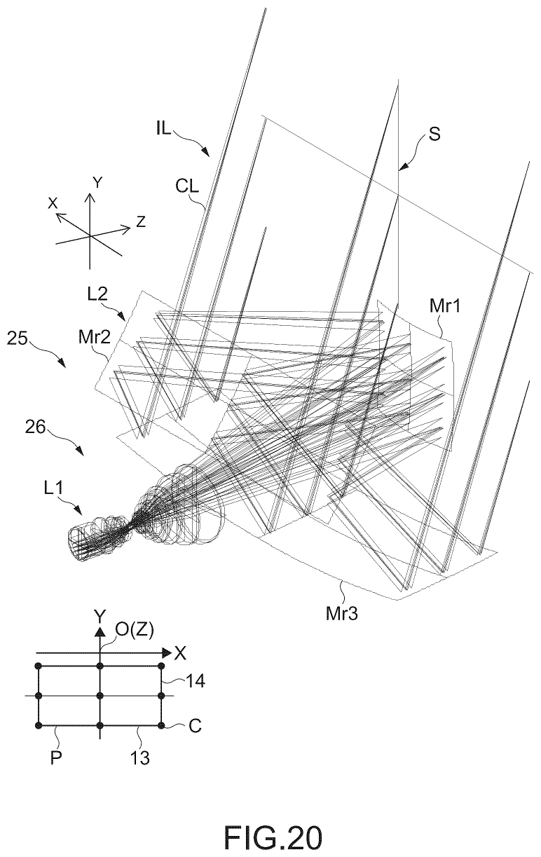

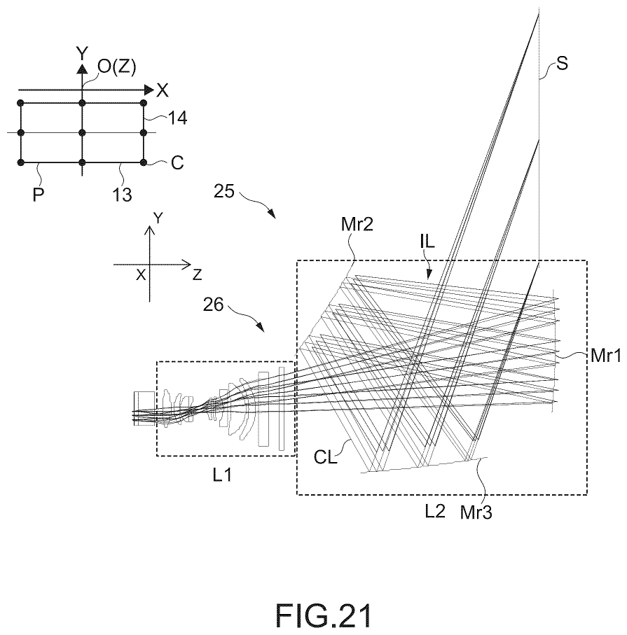

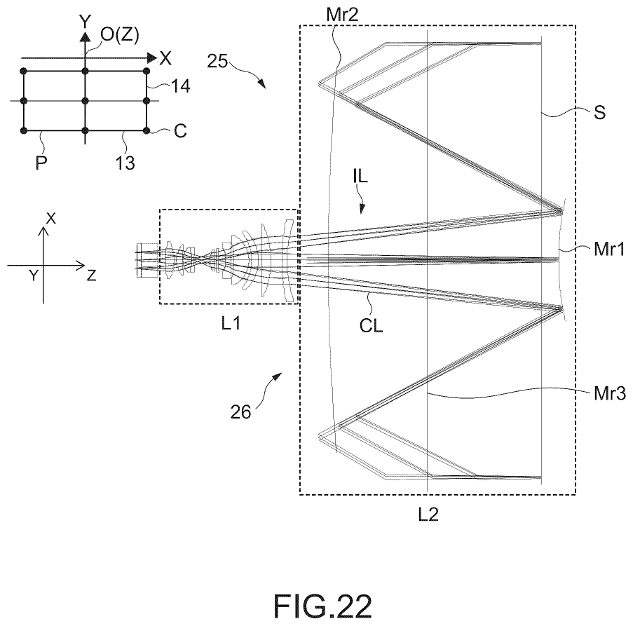

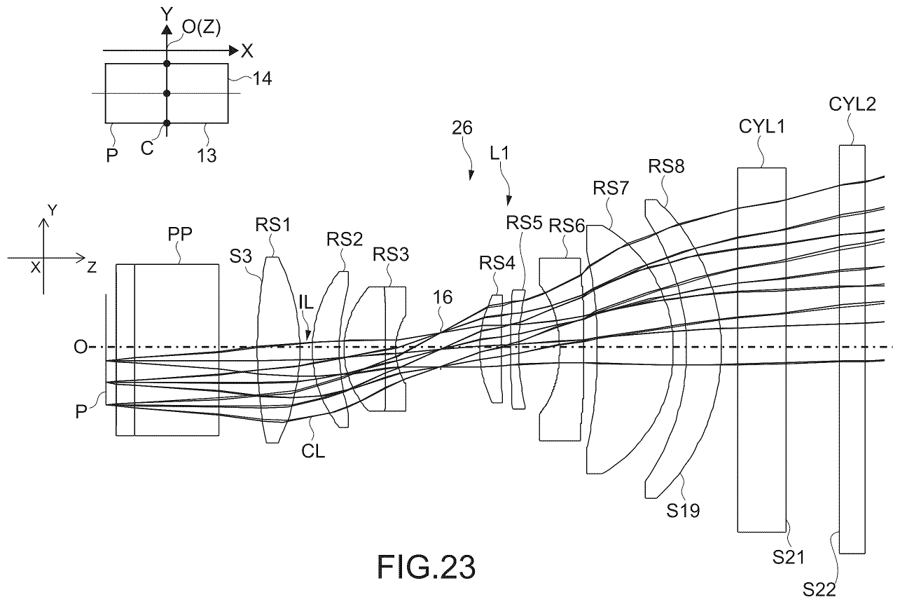

FIGS. 20 to 24 are light-path diagrams each illustrating a specific example of a configuration of the image display system 25 according to the present embodiment, or a specific example of a configuration of the projection optical system 26 according to the present embodiment.

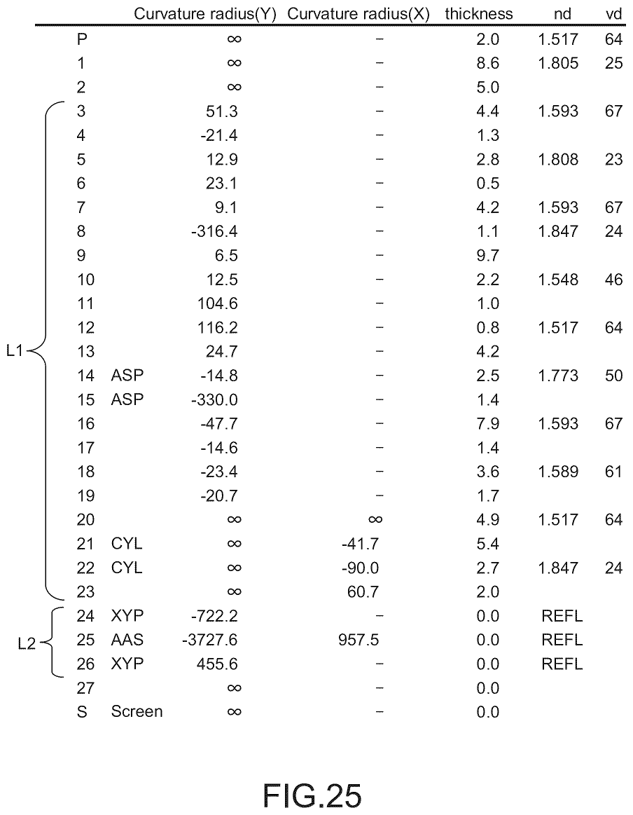

FIG. 25 illustrates lens data of the image display apparatus.

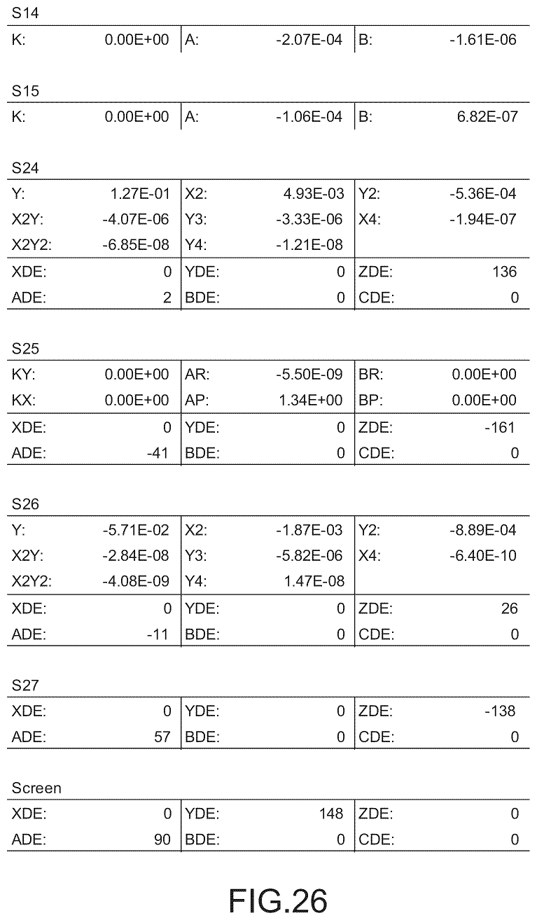

FIG. 26 is a table in which aspheric coefficients for the lens surfaces S14 and S15 (ASP), the lens surfaces S24 and S26 (XYP), and the lens surface S25 (ASS) are given. Further, parallel decentering and rotation decentering are given for the lens surface S27 and the screen S in FIG. 26.

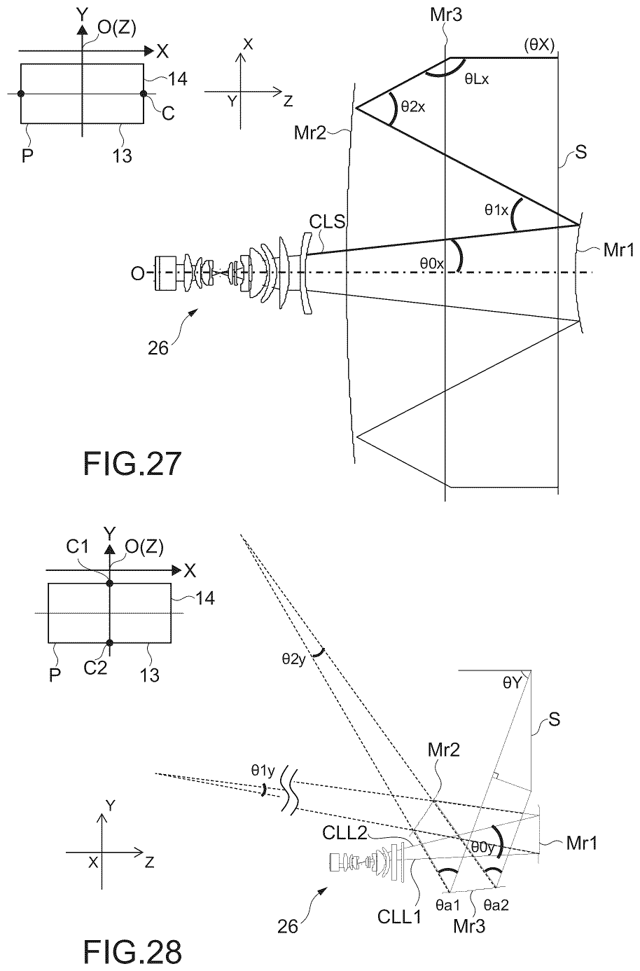

FIGS. 27 and 28 schematically illustrate parameters for feature points regarding the projection optical system 26.

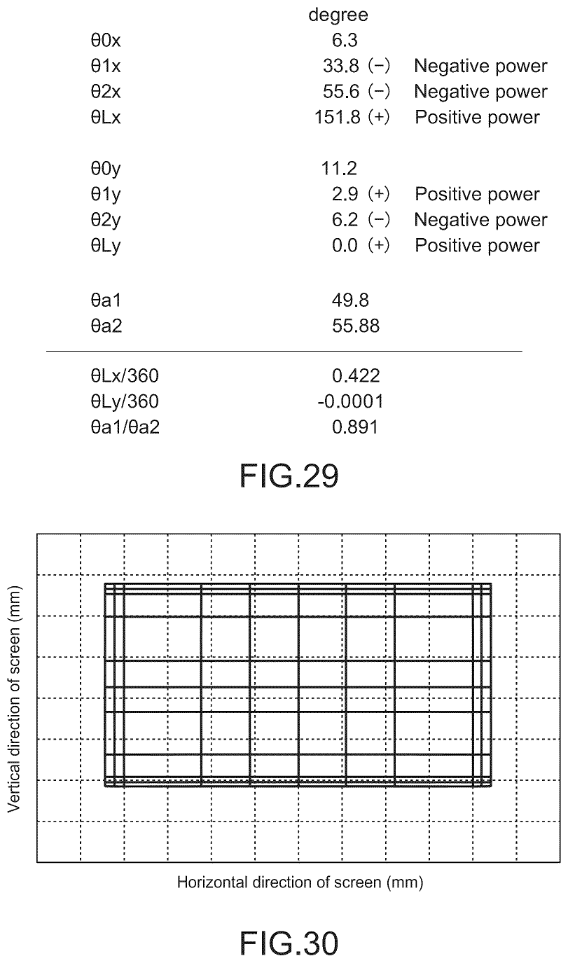

FIG. 29 is a table in which values of the parameters set in FIGS. 27 and 28 are given. Further, FIG. 29 also illustrates values related to the conditional expressions (1) to (3).

FIG. 30 schematically illustrates an example of a distortion in an image projected onto the hologram screen S.

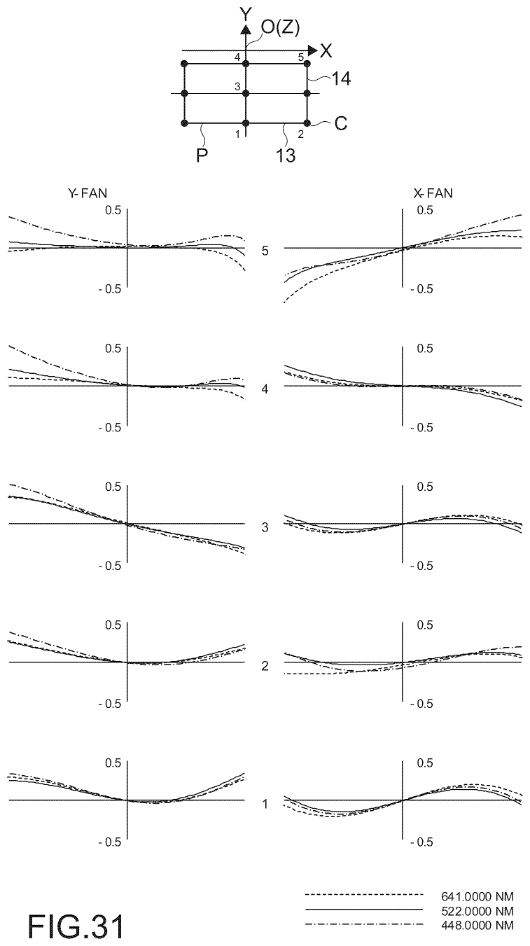

FIG. 31 is a set of graphs in which examples of diagrams of transverse aberrations related to a projected image are given.

FIGS. 20 to 31 respectively correspond to FIGS. 4 to 8, 11, 12, and 15 to 19 described in the first embodiment. Thus, descriptions thereof are omitted.

### [Traveling Directions of Plurality of Pieces of Pixel Light CL Reflected to be Headed for Screen S]

As illustrated in FIG. 14, in the present embodiment, the standard deviation σ for ΔθX is 0.0568. The standard deviation σ for ΔθY is 0.0222. The standard deviation σ for ΔθR is 0.0222.

It is understood that the variation is also sufficiently reduced with respect to each of the values of ΔθX, ΔθΥ, and ΔθR in the present embodiment, as described above.

The projection optical system 26 according to the present embodiment can project a plurality of pieces of pixel light CL onto the screen S in a state in which traveling directions of principal rays of the plurality of pieces of pixel light CL are aligned.

### [Points of Features of Projection Optical System 26]

The projection optical system 26 according to the present embodiment has the feature points described above, as in the case of the first embodiment. This is simply described below.

### (Powers of First to Third Reflecting Surfaces Mr1 to Mr3)

As illustrated in FIG. 29, the first reflecting surface Mr1 has a negative power, the second reflecting surface Mr2 has a negative power, and the third reflecting surface Mr3 has a positive power when the projection optical system 26 is viewed in the Y direction.

The first reflecting surface Mr1 has a positive power, the second reflecting surface Mr2 has a negative power, and the third reflecting surface Mr3 has a positive power when the projection optical system 26 is viewed in the X direction.

Three curved reflecting surfaces (the first to third reflecting surfaces Mr1 to Mr3) are used as the reflection optical system L2. Further, at least one curved reflecting surface is set to have a negative power to make the angle of view wider in both the case in which the projection optical system 26 is viewed in the Y direction and the case in which the projection optical system 26 is viewed in the X direction. This results in providing a configuration that is advantageous in aligning traveling directions of a plurality of pieces of pixel light CL while maintaining the image quality.

Further, the third reflecting surface Mr3 corresponding to a final reflecting surface exhibits a largest difference in power. This results in being advantageous in maintaining an aspect ratio of an image projected onto the screen S.

### (Conditional Expression (1) Regarding θLx)

As illustrated in FIG. 29, 0.422 is obtained by “θLx/360”. Thus, the conditional expression (1) is satisfied.

### (Conditional Expression (2) Regarding θLy)

As illustrated in FIG. 29, −0.0001 is obtained by “θLy/360”. Thus, the conditional expression (2) is satisfied.

### (Conditional Expression (3) Regarding θa1 and θa2)

As illustrated in FIG. 29, MIN[θa1, θa2]/MAX[θa1, θa2] corresponds to θa1/θa2, and 0.891 is obtained by “θa1/θa2”. Thus, the conditional expression (3) is satisfied.

[Projection of Image onto Hologram Screen]

Effects similar to the effects provided by the first embodiment can be provided.

### [Aspect Ratio of Image]

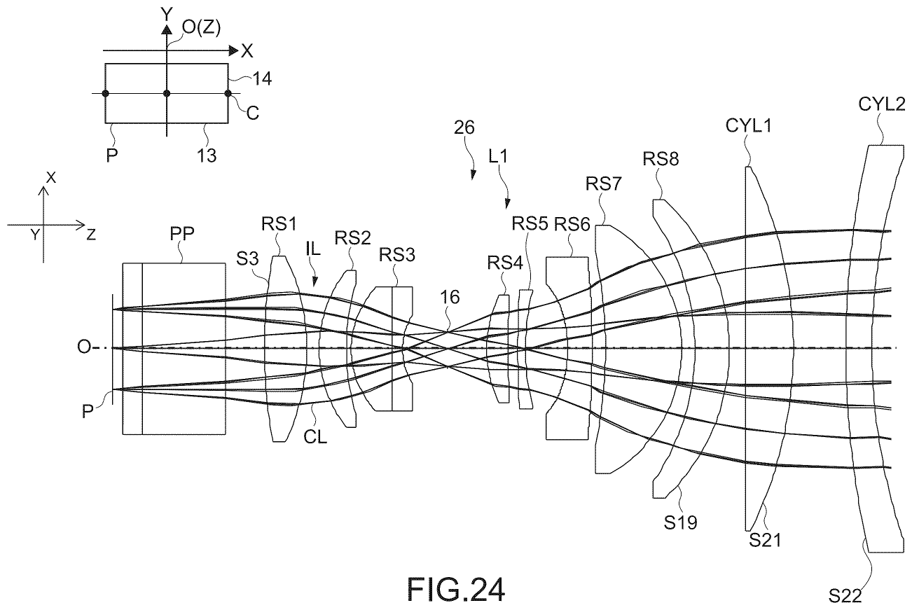

As in the case of the first embodiment, the cylindrical lenses CYL1 and CYL2 are arranged, as illustrated in, for example, FIG. 24.

Also in the present embodiment, three curved reflecting surfaces (the first to third reflecting surfaces Mr1 to Mr3) are used, and the cylindrical lenses CYL1 and CYL2 are used. These two points result in easily maintaining an aspect ratio.

### [Distortion in Image]

It is understood that a substantially rectangular planar image is projected, and a high performance is achieved, as illustrated in FIG. 30. Further, an aspect ratio of an image is also maintained, and thus high-quality image display is performed.

A shift in an image plane (on a vertical axis) is within about 0.5 mm at each of wavelengths of 641 nm, 522 nm, and 448 nm that are respectively indicated by a dotted line, a solid line, and a dot-dash line. It is understood that a highly accurate image can be projected.

### Third Embodiment

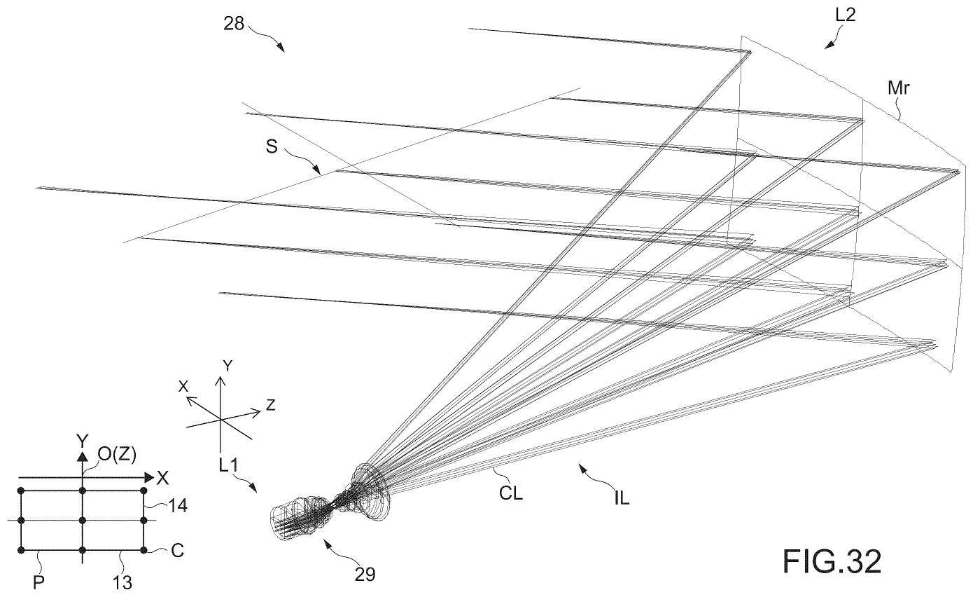

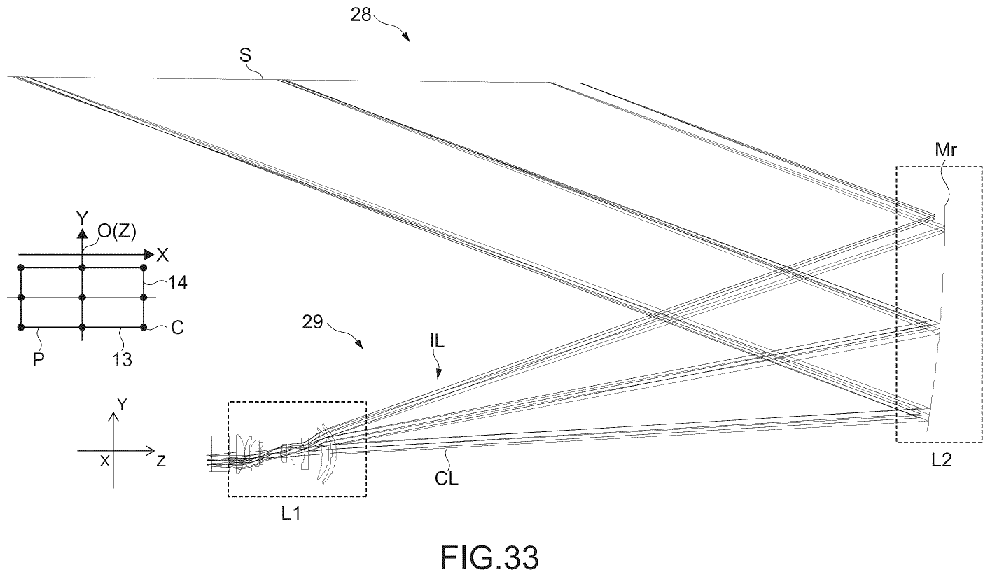

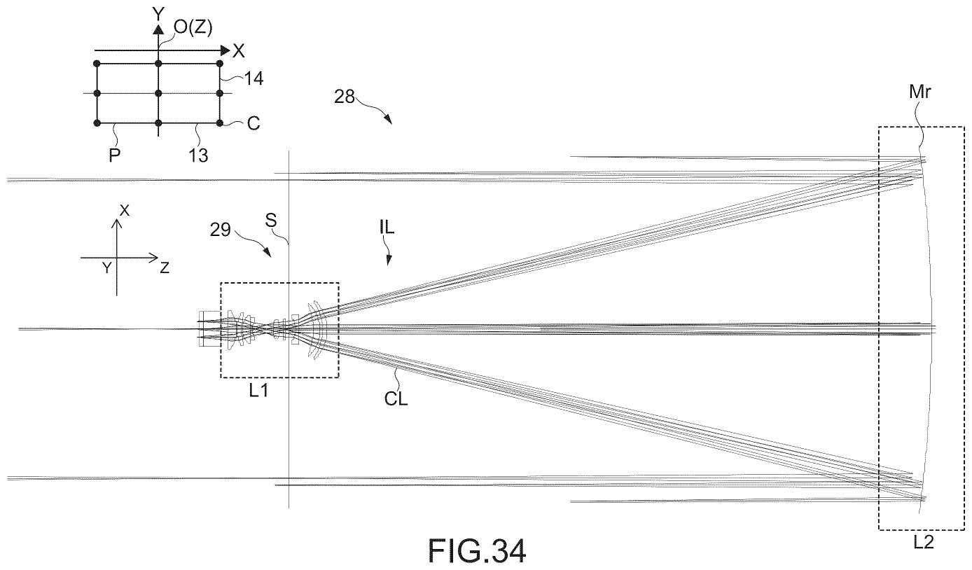

FIGS. 32 to 36 are light-path diagrams each illustrating a specific example of a configuration of an image display system 28 according to the third embodiment of the present technology, or a specific example of a configuration of the projection optical system 29 according to the third embodiment of the present technology.

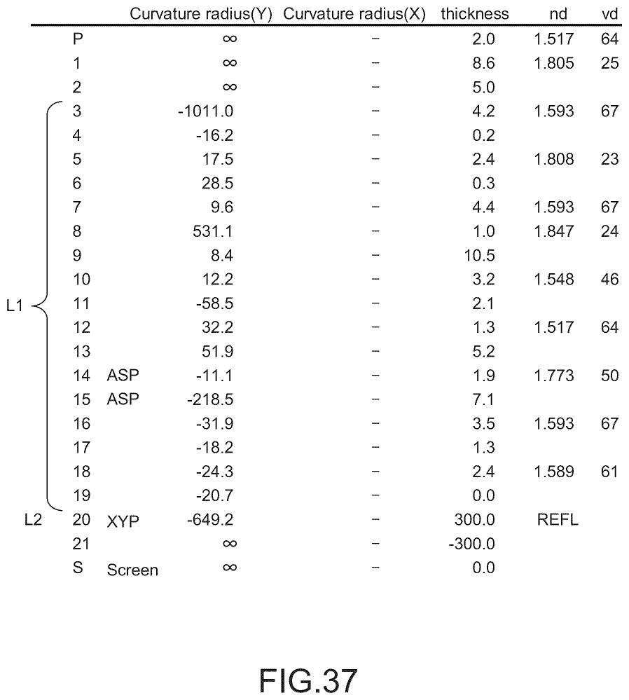

FIG. 37 illustrates lens data of the image display apparatus.

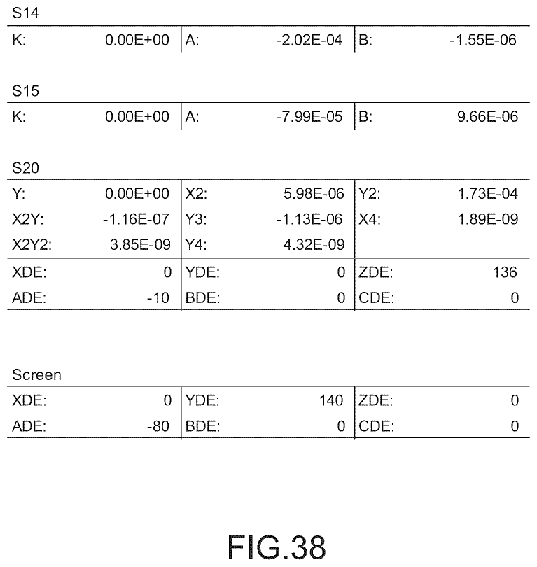

FIG. 38 is a table in which aspheric coefficients for the lens surfaces S14 and S15 (ASP) and the lens surface S20 (XYP) are given. Further, parallel decentering and rotation decentering are given for the screen S in FIG. 38.

Note that data for a lens surface S21 that is illustrated in FIG. 38 is data used to make clear a position of the screen S, and is data necessary for simulation.

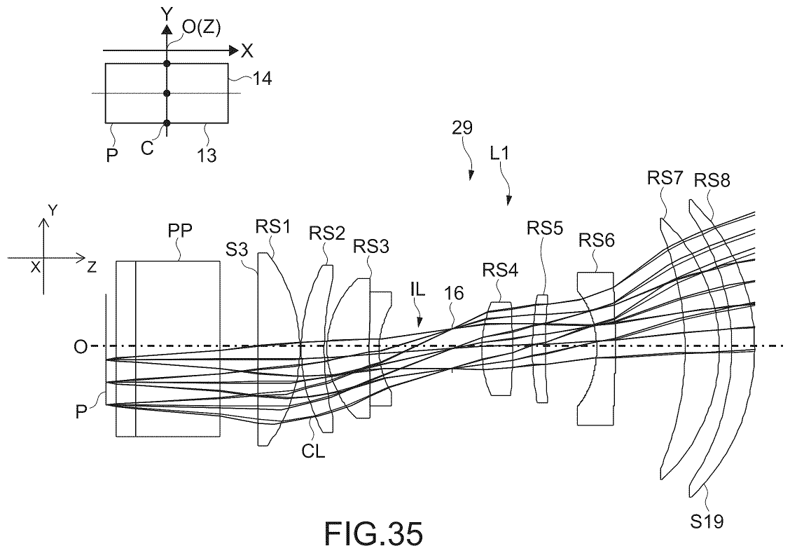

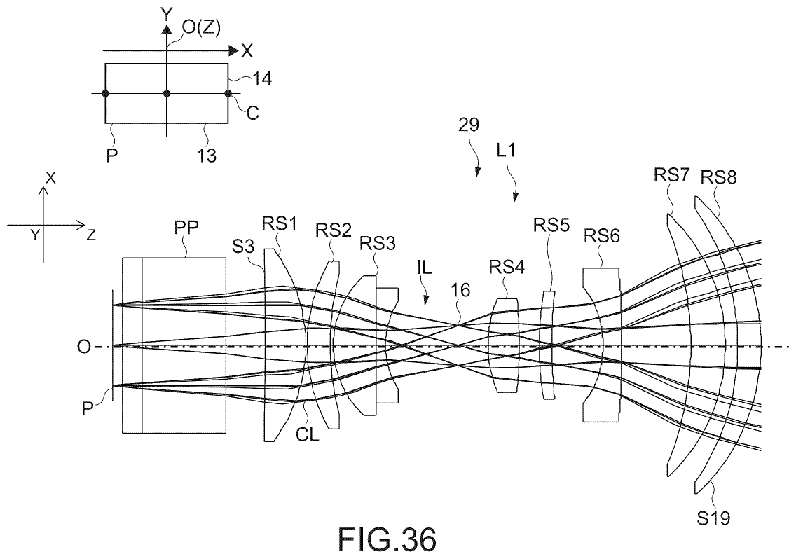

In the present embodiment, the lens system L1 includes eight optical components (rotationally symmetric lenses) RS1 to RS8 each having an axis of rotational symmetry, and no cylindrical lens is arranged, as illustrated in FIGS. 35 and 36.

A lens surface that is included the rotationally symmetric lens RS1 and situated on the input side of the lens system L1 corresponds to the lens surface S3 in the lens data illustrated in FIG. 37, the rotationally symmetric lens RS1 being the first rotationally symmetric lens situated closest to the illumination optical system 10.

A lens surface that is included in the rotationally symmetric lens RS8 and situated on the output side of the lens system L1 corresponds to the lens surface S19 in the lens data illustrated in FIG. 37, the rotationally symmetric lens RS8 being situated at the end on the output side of the rotationally symmetric lenses.

The lens surfaces S3 to S19 illustrated in FIG. 37 serve as the lens system L1. The lens surfaces S3 to S19 refract a plurality of pieces of pixel light CL emitted from respective pixels C of the liquid crystal panel P, and emit the plurality of pieces of pixel light CL to the reflection optical system L2.

It can also be said that the lens system L1 is an optical system that has rotational symmetry.

In the present embodiment, the reflection optical system L2 includes one aspheric reflecting surface Mr, as illustrated in FIGS. 32 to 34. The one aspheric reflecting surface Mr is hereinafter simply referred to as a reflecting surface Mr. The reflecting surface Mr corresponds to an embodiment of one curved reflecting surface.

The reflecting surface Mr is a curved reflecting surface off which a plurality of pieces of pixel light CL emitted from the lens system L1 is reflected to be headed for the screen S (the onto-projection object). The reflecting surface Mr corresponds to an embodiment of the final reflecting surface according to the present technology.

The reflecting surface Mr corresponds to the lens surface S20 (XYP) illustrated in FIG. 37.

Further, the reflecting surface Mr (the lens surface S20) is arranged by being decentered parallel to the Z direction and being rotated about the X axis, as illustrated in FIG. 38.

As illustrated in FIGS. 32 to 34 and 38, the position of the screen S in the present embodiment is also significantly different from the position of the screen S in the first and second embodiments. Specifically, the screen S is arranged above the image display apparatus 8 to be substantially horizontal (to be substantially parallel to an XZ-plane).

As illustrated in FIGS. 32 to 34, the plurality of pieces of pixel light CL emitted from the lens system L1 is reflected off the reflecting surface Mr to be headed upward (toward the positive side of the Y axis) for the screen S.

### [Traveling Directions of Plurality of Pieces of Pixel Light CL Reflected to be Headed for Screen S]

In the present embodiment, a plurality of pieces of pixel light CL is reflected off the reflection optical system L2 including a single reflecting surface Mr to be headed for the screen S in a state in which traveling directions of principal rays of the plurality of pieces of pixel light CL are aligned.

Note that the stop (an aperture stop) 16 is provided to the lens system L1. Light lays that pass through the center of the stop 16 are principal rays of the plurality of pieces of pixel light CL.

In the present embodiment, traveling directions of a plurality of pieces of pixel light CL reflected to be headed for the screen S are assessed using ΔθX, ΔθΥ, and ΔθR, which are illustrated in A and B of FIG. 13. The position of the screen S in the present embodiment is significantly different from the position of the screen S in the first and second embodiments. On the other hand, values of ΔθX, ΔθΥ, and ΔθR can be calculated on the basis of the position of the screen S.

As illustrated in FIG. 14, in the present embodiment, the standard deviation σ for ΔθX is 0.1191. The standard deviation σ for ΔθY is 0.1205. The standard deviation σ for ΔθR is 0.121.

It is understood that the variation is also sufficiently reduced with respect to each of the values of ΔθX, ΔθY, and ΔθR in the present embodiment, as described above.

The projection optical system 29 according to the present embodiment can project a plurality of pieces of pixel light CL onto the screen S in a state in which traveling directions of principal rays of the plurality of pieces of pixel light CL are aligned.

Note that, in the present embodiment, the variation is relatively large for each of the values of ΔθX, ΔθY, and ΔθR, compared to the case of the first and second embodiments, as illustrated in FIG. 14. In other words, it can be said that the configuration of the reflection optical system L2 using three concave reflecting surfaces is advantageous in aligning traveling directions of a plurality of pieces of pixel light CL.

On the other hand, the configuration of the reflection optical system L2 using a single concave reflecting surface is advantageous in, for example, reducing the number of parts, reducing costs for parts, and making an apparatus smaller in size.

### [Points of Features of Projection Optical System 29]

Feature points regarding the projection optical system 29 according to the present embodiment are described.

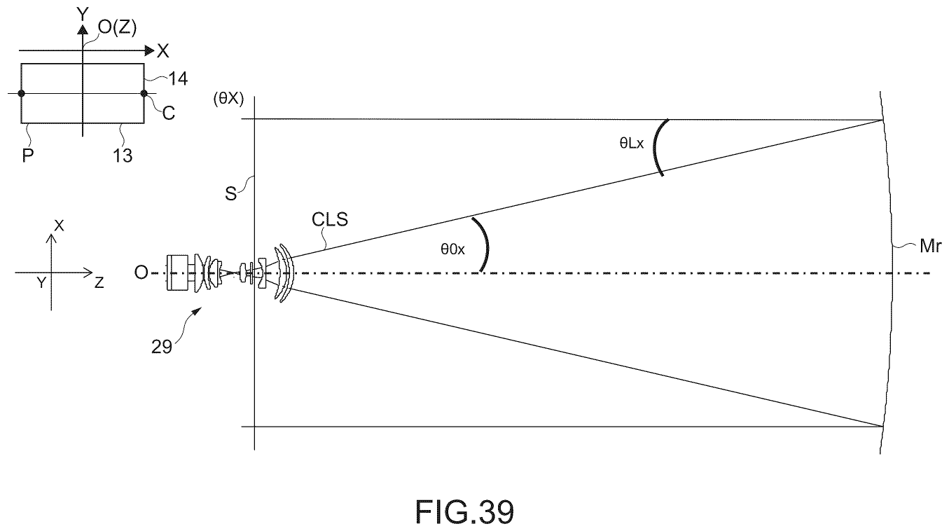

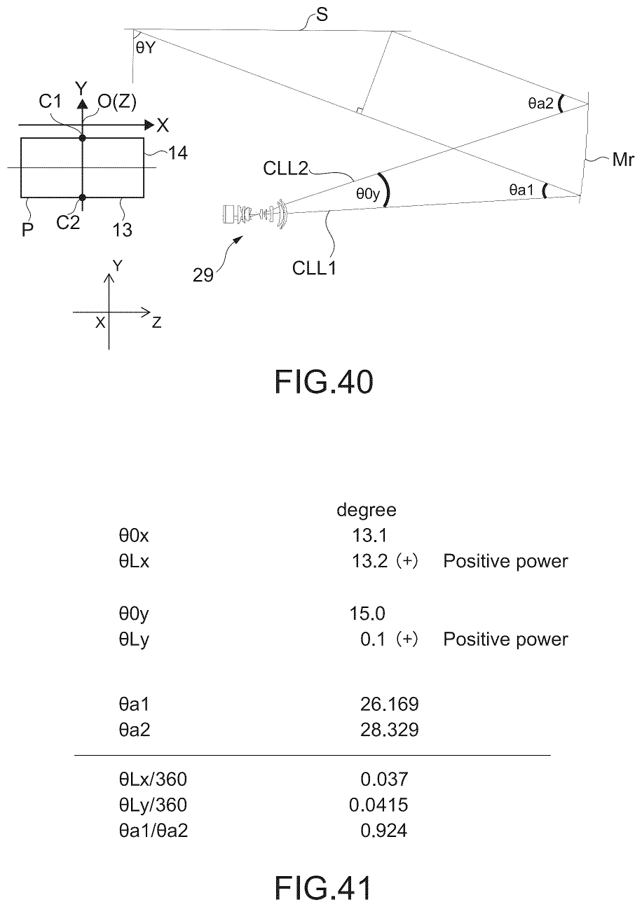

As illustrated in FIGS. 39 and 40, parameters are set for light paths of pieces of image light IL (pieces of pixel light CL) as described below in order to describe the feature points regarding the projection optical system 29.

As illustrated in FIG. 39, parameters indicated below are set for pieces of short-side pixel light CLS when the projection optical system 29 is viewed in the Y direction.
θ0x: an angle formed by the short-side pixel light CLS and the optical axis O
ΔLx: an angle formed by the short-side pixel light CLS incident on the reflecting surface Mr and the short-side pixel light CLS reflected off the reflecting surface Mr

As illustrated in FIG. 40, parameters indicated below are set for the first long-side pixel light CLL1 and the second long-side pixel light CLL2 when the projection optical system 29 is viewed in the X direction.
θ0y: an angle of intersection of a traveling direction of the first long-side pixel light CLL1 and a traveling direction of the second long-side pixel light CLL2
θLy: an angle of intersection of the traveling direction of the first long-side pixel light CLL1 reflected off the reflecting surface Mr, and the traveling direction of the second long-side pixel light CLL2 reflected off the reflecting surface Mr
θa1: an angle formed by the first long-side pixel light CLL1 incident on the reflecting surface Mr, and the first long-side pixel light CLL1 reflected off the reflecting surface Mr
θa2: an angle formed by the second long-side pixel light CLL2 incident on the reflecting surface Mr, and the second long-side pixel light CLL2 reflected off the reflecting surface Mr

Note that the third reflecting surface Mr3 in the first and second embodiments and the reflecting surface Mr in the present embodiment each serve as a final reflecting surface. Discussion is held focused on this point. Thus, it can be considered that θ0x, θLx, θ0y, θLy, θa2, and θa1 in FIGS. 39 to 40 represent parameters that are the same as the parameters represented by θ0x, θLx, θ0y, θLy, θa2, and θa1, which are used to describe the features according to the first and second embodiments.

FIG. 41 is a table in which values of the parameters set in FIGS. 39 and 40 are given. The feature points regarding the projection optical system 29 are described in reference to the values as necessary.

### (Power of Reflecting Surface Mr)

The following are the values of the parameters illustrated in FIG. 39.
θ0x: 13.1 degrees
θLx: 13.2 degrees

It is understood, from these values, that the reflecting surface Mr has a positive power when the projection optical system 29 is viewed in the Y direction.

The following are the values of the parameters illustrated in FIG. 40.
θ0y: 15.0 degrees
θLy: 0.1 degrees

It is understood, from these values, that the reflecting surface Mr has a positive power when the projection optical system 29 is viewed in the X direction.

It can be said that such a configuration is one of the features of the projection optical system 29 according to the present embodiment. This configuration results in being advantageous in aligning traveling directions of a plurality of pieces of pixel light CL.

### (Conditional Expression (4) Regarding θLx)

The projection optical system 29 according to the present embodiment is configured such that the following is satisfied.

$$0.02 < θ Lx / 360 < 0.47 \qquad ( 4 )$$

When a value obtained by “θLx/360” exceeds an upper limit defined by the conditional expression (4), an incident angle at which a plurality of pieces of pixel light CL is incident on the reflecting surface Mr1 is close to 180 degrees. Thus, it is more likely to become difficult to cause the plurality of pieces of pixel light CL to be reflected off the reflecting surface Mr1.

When the value obtained by “θLx/360” falls below a lower limit defined by the conditional expression (4), the incident angle at which the plurality of pieces of pixel light CL is incident on the reflecting surface Mr1 is small. This results in there being a need for a space in order to perform projection with a desired angle of view (in a desired projection size). Thus, the projection optical system is more likely to be made in large in size.

When the projection optical system 29 is configured such that the conditional expression (4) is satisfied, this results in being advantageous in performing high-quality image display.

Note that a conditional expression indicated below can also be obtained by multiplying a value of each member of the conditional expression (4) by 360.

$$7.2 < θ Lx < 170$$

The upper and lower limits defined by the conditional expression (4) can also be changed as appropriate according to, for example, the configuration of projection optical system 29. For example, two values included in the range described above can be respectively selected as a lower limit and an upper limit, and an optimal range can be newly arranged using the selected upper and lower limits.

For example, ranges indicated below can be set for the conditional expression (4).

$$0.04 < θ Lx / 360 < 0.45$$

$$0.06 < θ Lx / 360 < 0 \text{.42}$$

$$0.08 < θ Lx / 360 < 0.40$$

### (Conditional Expression (2) Regarding θLy)

As illustrated in FIG. 41, 0.0415 is obtained by “θLy/360”. Thus, the conditional expression (2) is satisfied.

### (Conditional Expression (3) Regarding θa1 and θa2)

MIN[θa1, θa2]/MAX[θa1, θa2] corresponds to θa1/θa2, and 0.924 is obtained by “θa1/θa2”, as illustrated in FIG. 41. Thus, the conditional expression (3) is satisfied.

[Projection of Image onto Hologram Screen]

Effects similar to the effects provided by the embodiments described above can be provided.

### [Distortion in Image]

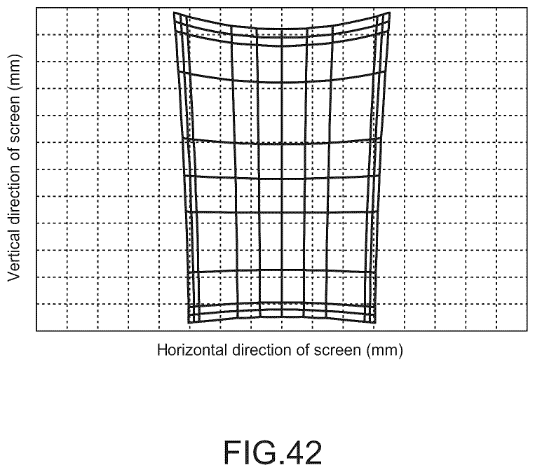

FIG. 42 schematically illustrates an example of a distortion in an image projected onto the hologram screen S.

In the present embodiment, an adjustment optical component such as a cylindrical lens is not used. This results in being slightly difficult to maintain an aspect ratio, compared to the case of the first and second embodiments. Specifically, there is a change in a positional relationship between a long side and a short side of a projected image, and the projected image is vertically long, as illustrated in FIG. 42. On the other hand, a substantially rectangular planar image is displayed.

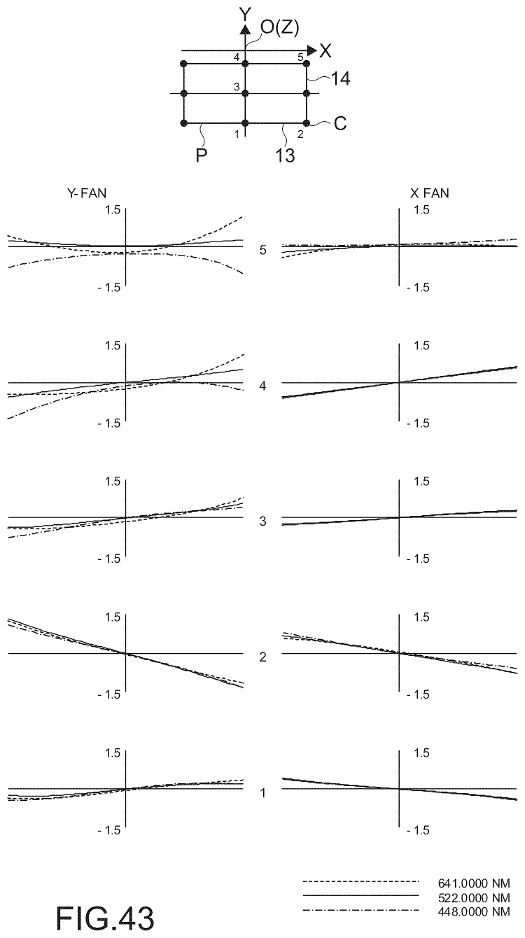

FIG. 43 is a set of graphs in which examples of diagrams of transverse aberrations related to a projected image are given.

A shift in an image plane (on a vertical axis) is slightly larger, compared to the case of the first and second embodiments. Specifically, the shift in the image plane (on the vertical axis) is within about 1.5 mm at each of wavelengths of 641 nm, 522 nm, and 448 nm that are respectively indicated by a dotted line, a solid line, and a dot-dash line, as illustrated in FIG. 43.

On the other hand, an image can be projected in a range of this shift, and high-quality image display is performed.

### Fourth Embodiment

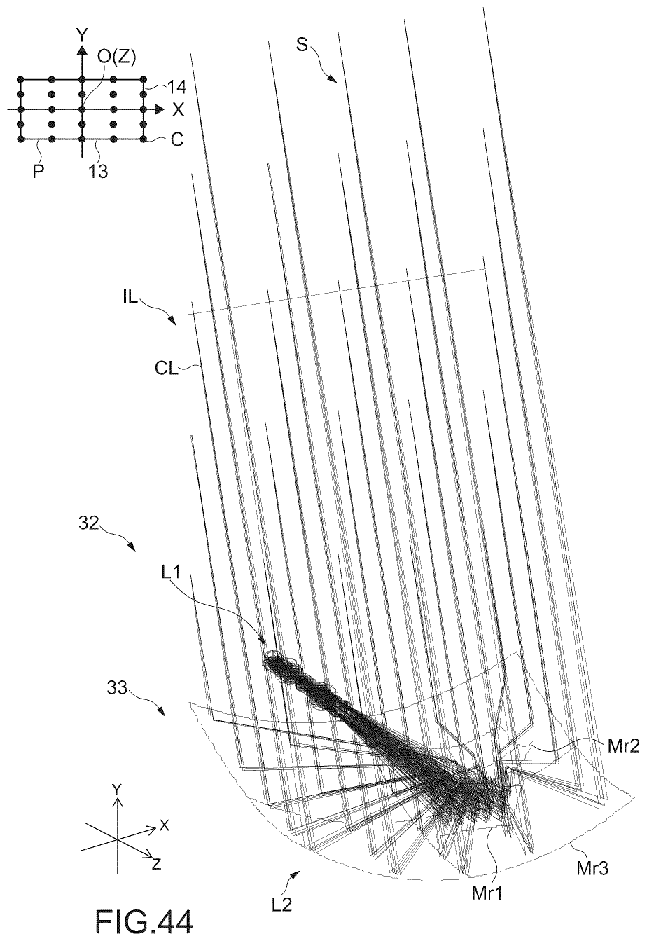

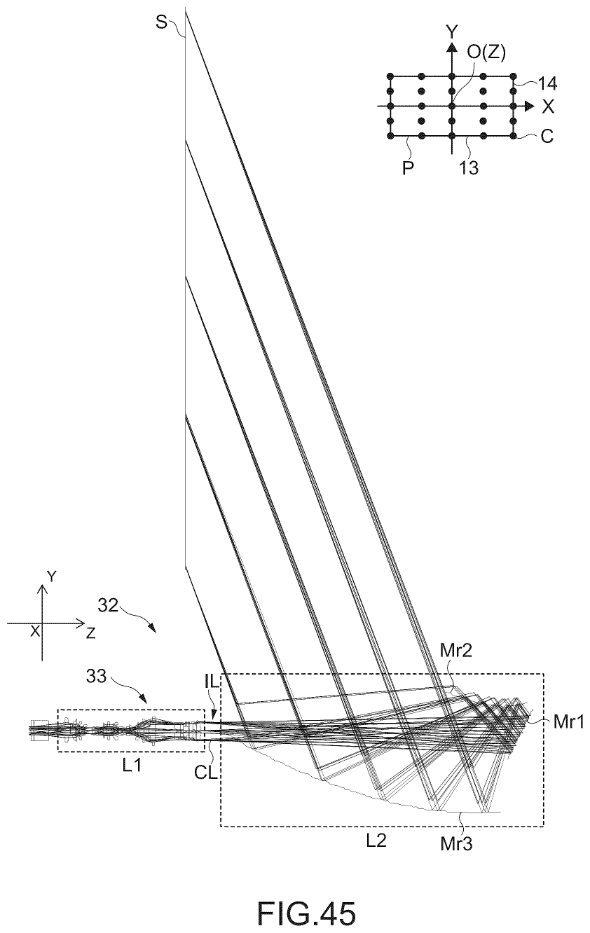

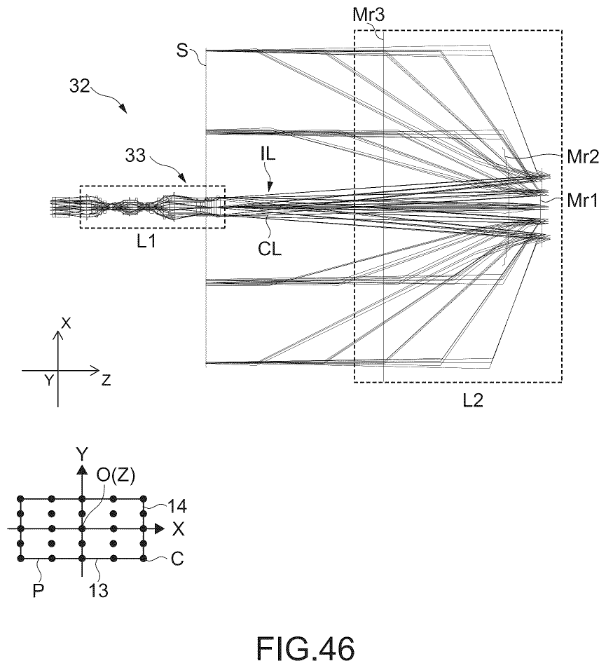

FIGS. 44 to 48 are light-path diagrams each illustrating a specific example of a configuration of an image display system 32 according to a fourth embodiment of the present technology, or a specific example of a configuration of a projection optical system 33 according to the third embodiment of the present technology.

FIGS. 44 to 46 each illustrate light paths of pieces of pixel light CL respectively emitted from 25 pixels C in total that are situated in an entire region of the liquid crystal panel P, where the 25 pixels C includes five pixels arranged at even intervals in the X direction and five pixels arranged at even intervals in the Y direction.

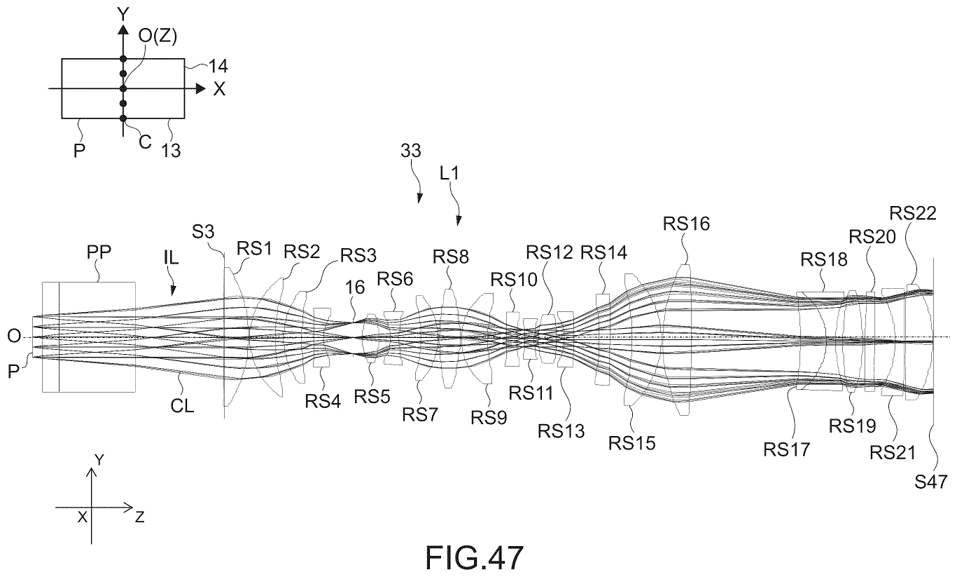

FIG. 47 is a cross-sectional view of the lens system L1 when the projection optical system 33 is cut along the Y axis. FIG. 47 illustrates the light paths of the pieces of pixel light CL respectively emitted from five pixels C in total that are the pixel situated in a center portion of the liquid crystal panel P, the pixels respectively situated in middle portions of the respective long sides 13, and the pixels each situated midway between the center portion and a corresponding one of the middle portions of the respective long sides 13. In other words, FIG. 47 illustrates the light paths of the pieces of pixel light CL respectively emitted from five pixels C arranged at even intervals in the Y direction in a middle region of the liquid crystal panel P.

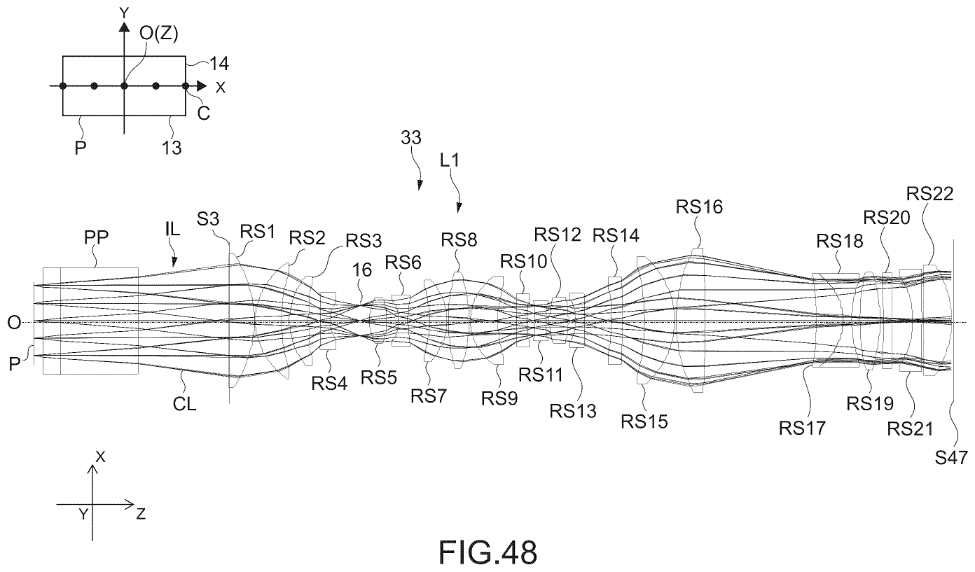

FIG. 48 is a cross-sectional view of the lens system L1 when the projection optical system 33 is cut along the Y axis. FIG. 48 illustrates the light paths of the pieces of pixel light CL respectively emitted from five pixels C in total that are the pixel situated in the center portion of the liquid crystal panel P, the pixels respectively situated in middle portions of the respective short sides 14, and the pixels each situated midway between the center portion and a corresponding one of the middle portions of the respective short sides 14. In other words, FIG. 48 illustrates the light paths of the pieces of pixel light CL respectively emitted from five pixels C arranged at even intervals in the X direction in a middle region of the liquid crystal panel P.

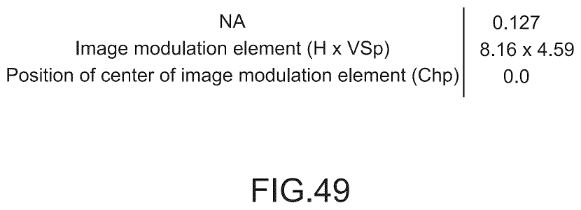

FIG. 49 is a table in which examples of parameters related to image projection are given.

In the present embodiment, a position (Chp) of the center of the image modulation element coincides with the position of the optical axis O (an offset amount of 0.0). Thus, the optical axis O passes through the position of the center of the image modulation element, as illustrated in FIGS. 44 to 48.

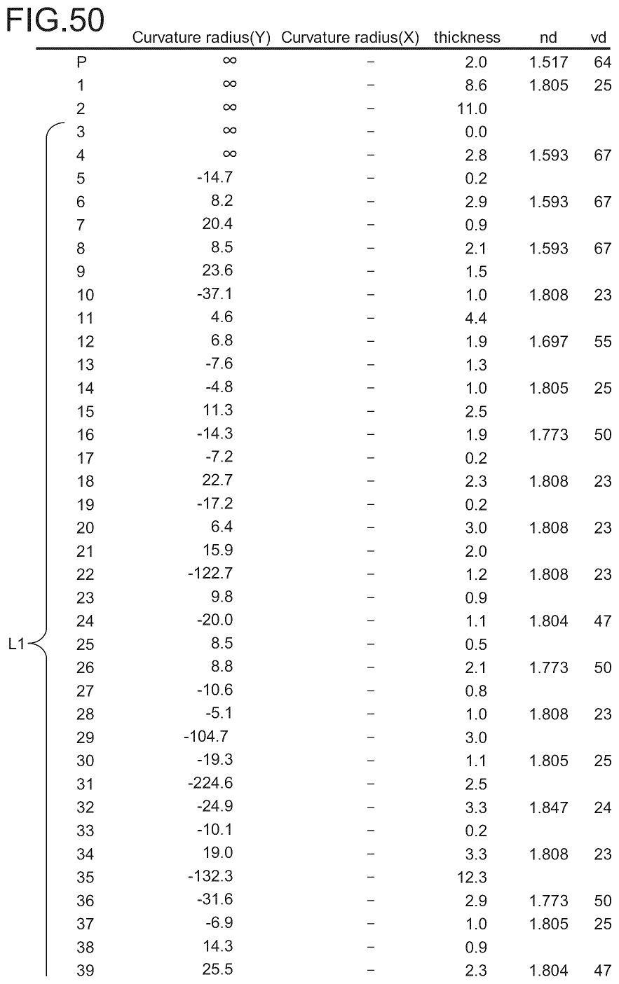

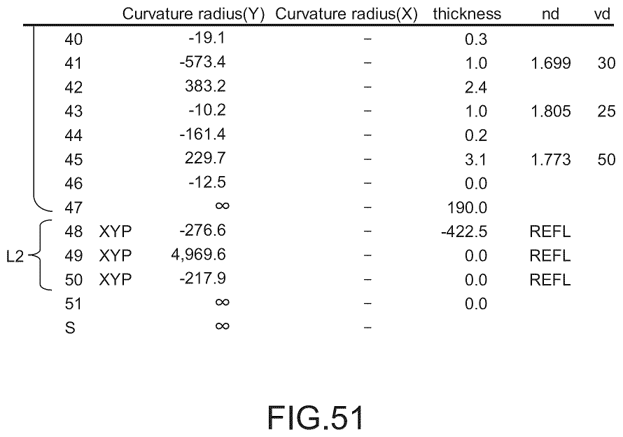

FIGS. 50 and 51 illustrate lens data of the image display apparatus.

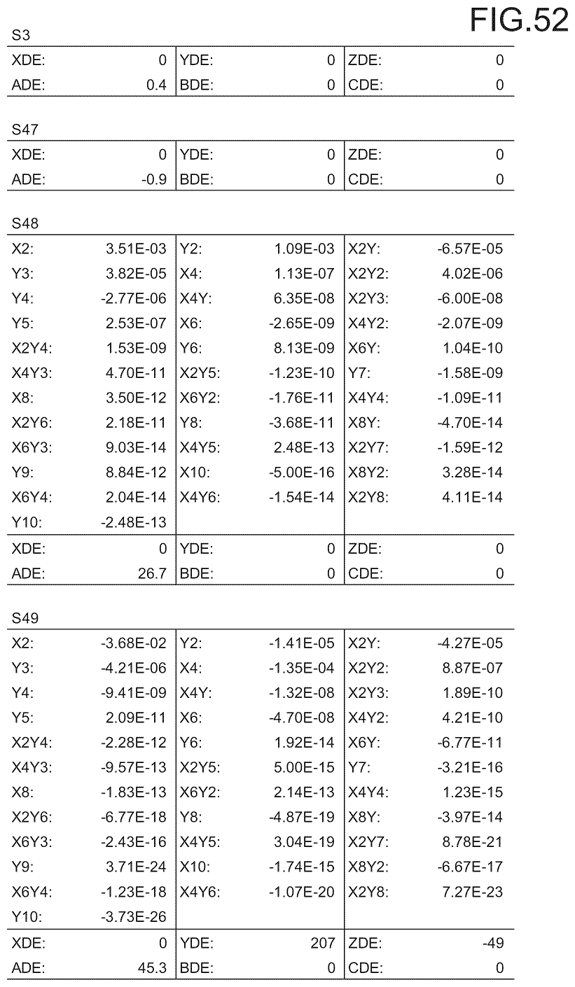

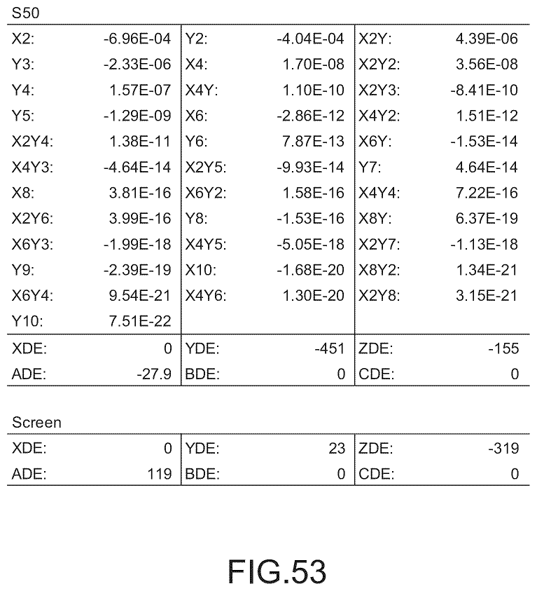

FIGS. 52 and 53 are a table in which aspheric coefficients for lens surfaces S48 to S50 (XYP) are given. Further, parallel decentering and rotation decentering are given for lens surfaces S3 and S47 and the screen S in FIGS. 52 and 53.

Note that data for a lens surface S51 that is illustrated in FIG. 51 is data used to make clear a position of the screen S, and is data necessary for simulation.

In the present embodiment, the lens system L1 includes 22 optical components (rotationally symmetric lenses) RS1 to RS22 each having an axis of rotational symmetry, and no cylindrical lens is arranged, as illustrated in FIGS. 47 and 48.

A lens surface that is included the rotationally symmetric lens RS1 and situated on the input side of the lens system L1 corresponds to a lens surface S4 in the lens data illustrated in FIG. 50, the rotationally symmetric lens RS1 being the first rotationally symmetric lens situated closest to the illumination optical system 10. A lens surface that is included in the rotationally symmetric lens RS22 and situated on the output side of the lens system L1 corresponds to a lens surface S46 in the lens data illustrated in FIG. 51, the rotationally symmetric lens RS22 being situated at the end on the output side of the rotationally symmetric lenses.

Further, in the present embodiment, the lens surface S3, which is an eccentric surface, is defined on an input side of the rotationally symmetric lens RS1. Furthermore, the lens surface S47, which is an eccentric surface, is defined on an output side of the rotationally symmetric lens RS22.

The lens surfaces S3 to S47 illustrated in FIGS. 50 and 51 serve as the lens system L1. The lens surfaces S3 to S47 refract a plurality of pieces of pixel light CL emitted from respective pixels C of the liquid crystal panel P, and emit the plurality of pieces of pixel light CL to the reflection optical system L2.

As illustrated in FIGS. 44 to 46, the reflection optical system L2 includes the first reflecting surface Mr1, the second reflecting surface Mr2, and the third reflecting surface Mr3, as in the case of the first and second embodiments.

The first reflecting surface Mr1 corresponds to the lens surface S48 (XYP) in the lens data illustrated in FIG. 51.

The second reflecting surface Mr2 corresponds to the lens surface S49 (XYP) in the lens data illustrated in FIG. 51.

The third reflecting surface Mr3 corresponds to the lens surface S50 (XYP) in the lens data illustrated in FIG. 51.

As illustrated in FIGS. 44 to 46, the plurality of pieces of pixel light CL emitted from the lens system L1 is reflected off the first reflecting surface Mr1 to be headed upward (toward the positive side of the Y axis).

The plurality of pieces of pixel light CL reflected off the first reflecting surface Mr1 is reflected off the second reflecting surface Mr2 to be headed downward (toward the negative side of the Y axis).

The plurality of pieces of pixel light CL reflected off the second reflecting surface Mr2 is reflected off the third reflecting surface Mr3 to be headed obliquely upward toward the lens system L1.

Thus, in the present embodiment, the plurality of pieces of pixel light CL reflected off the third reflecting surface Mr3 is projected onto the screen S in a direction from the positive side to the negative side on the Z axis. In other words, in the present embodiment, the image light IL is projected onto the screen S in a direction (an orientation) opposite to the direction of the projection performed in the first and second embodiments, and image display is performed at ultra-short focus in such a state.

### [Traveling Directions of Plurality of Pieces of Pixel Light CL Reflected to be Headed for Screen S]

A plurality of pieces of pixel light CL is reflected off the reflection optical system L2 including the first to third reflecting surfaces Mr1 to Mr3 to be headed for the screen S in a state in which traveling directions of the plurality of pieces of pixel light CL are aligned. In other words, traveling directions of a plurality of pieces of pixel light CL headed for the screen S from the third reflecting surface Mr3 are aligned.

Note that the stop (an aperture stop) 16 is provided to the lens system L1. Light rays that pass through the center of the stop 16 are principal rays of the plurality of pieces of pixel light CL.

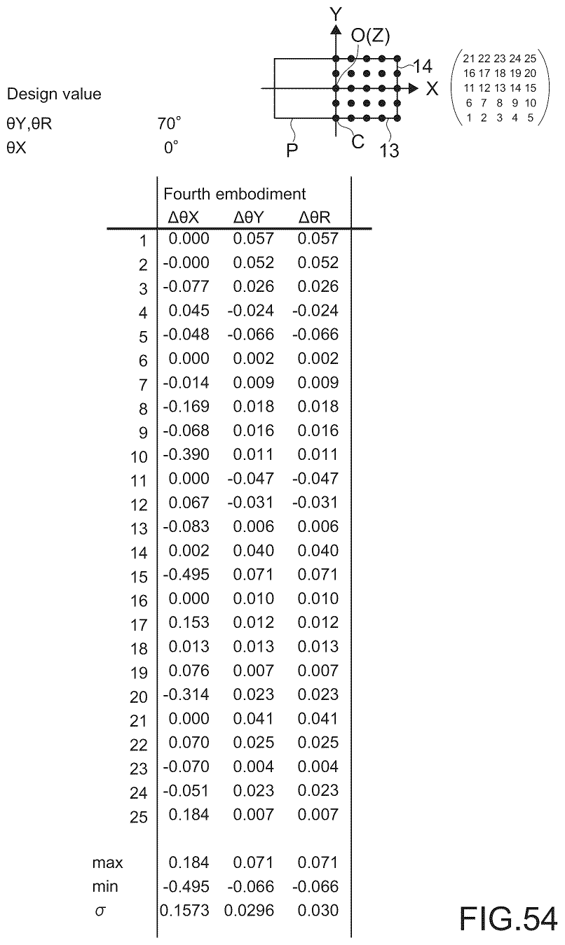

FIG. 54 is a table in which a result of assessing traveling directions of a plurality of pieces of pixel light CL reflected to be headed for the screen S is given.

As illustrated in FIG. 54, in the present embodiment, the standard deviation σ for ΔθX is 0.1573. The standard deviation σ for ΔθY is 0.0296. The standard deviation σ for ΔθR is 0.030.

It is understood that the variation is also sufficiently reduced with respect to each of the values of ΔθX, ΔθY, and ΔθR in the present embodiment, as described above.

The projection optical system 33 according to the present embodiment can project a plurality of pieces of pixel light CL onto the screen S in a state in which traveling directions of principal rays of the plurality of pieces of pixel light CL are aligned.

In the present embodiment, the variation in ΔθX is relatively large. On the other hand, the variation is also sufficiently reduced with respect to each of the values of ΔθY and ΔθR. In other words, it can be said that the configuration of the reflection optical system L2 using three concave reflecting surfaces is also advantageous in sufficiently reduce the variation in at least one of the values of ΔθX, ΔθY, and ΔθR.

### [Points of Features of Projection Optical System 33]

The projection optical system 33 according to the present embodiment has the feature points described above, as in the case of the first and second embodiments. This is simply described below.

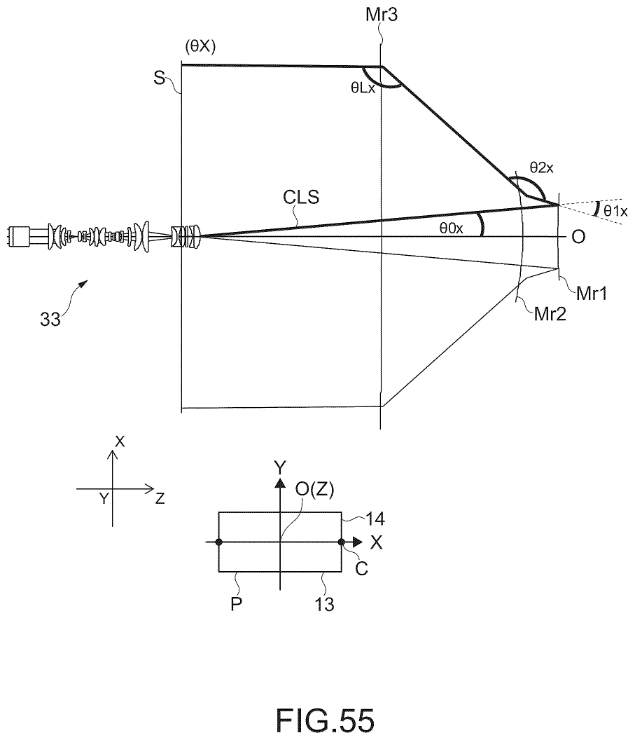

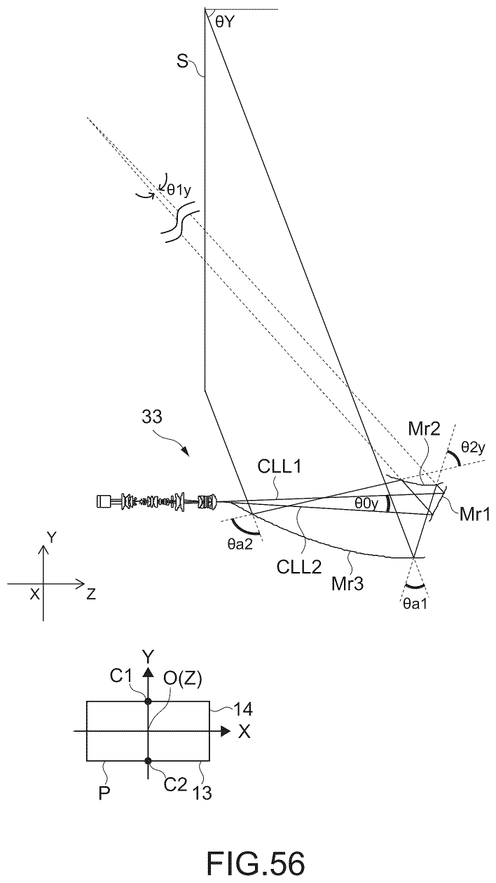

FIGS. 55 and 56 schematically illustrate parameters for feature points regarding the projection optical system 33.

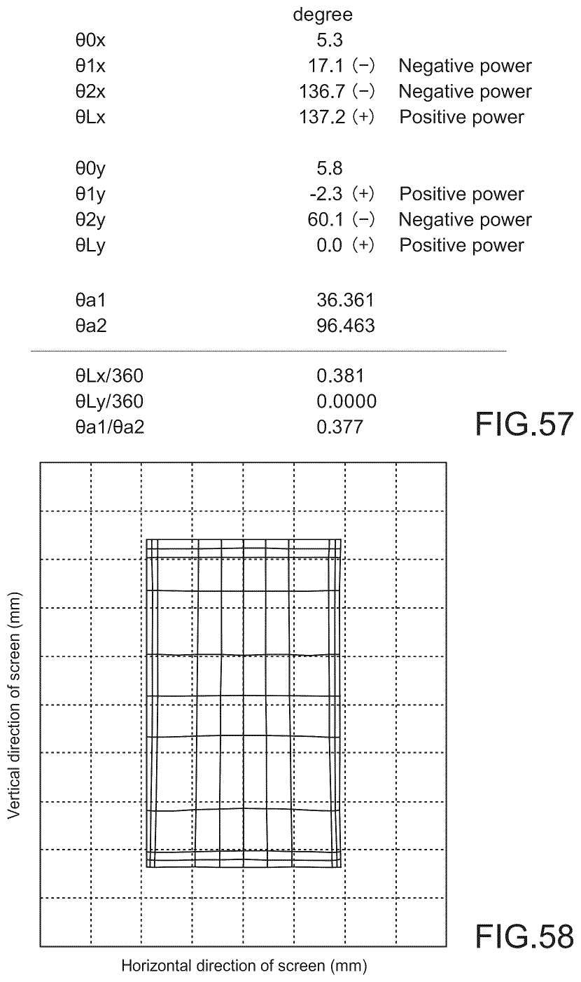

FIG. 57 is a table in which values of the parameters set in FIGS. 55 and 56 are given. Further, FIG. 57 also illustrates values related to the conditional expressions (1) to (3).

### (Powers of First to Third Reflecting Surfaces Mr1 to Mr3)

As illustrated in FIG. 57, the first reflecting surface Mr1 has a negative power, the second reflecting surface Mr2 has a negative power, and the third reflecting surface Mr3 has a positive power when the projection optical system 33 is viewed in the Y direction.

The first reflecting surface Mr1 has a positive power, the second reflecting surface Mr2 has a negative power, and the third reflecting surface Mr3 has a positive power when the projection optical system 33 is viewed in the X direction.

Three curved reflecting surfaces (the first to third reflecting surfaces Mr1 to Mr3) are used as the reflection optical system L2. Further, at least one curved reflecting surface is set to have a negative power to make the angle of view wider in both the case in which the projection optical system 33 is viewed in the Y direction and the case in which the projection optical system 33 is viewed in the X direction. This results in providing a configuration that is advantageous in aligning traveling directions of a plurality of pieces of pixel light CL while maintaining the image quality.

Further, the third reflecting surface Mr3 corresponding to a final reflecting surface exhibits a largest difference in power. This results in being advantageous in maintaining an aspect ratio of an image projected onto the screen S.

### (Conditional Expression (1) Regarding θLx)

As illustrated in FIG. 29, 0.381 is obtained by “θLx/360”. Thus, the conditional expression (1) is satisfied.

### (Conditional Expression (2) Regarding θLy)

As illustrated in FIG. 29, −0.0000 is obtained by “θLy/360”. Thus, the conditional expression (2) is satisfied.

### (Conditional Expression (3) Regarding θa1 and θa2)

As illustrated in FIG. 29, MIN[θa1, θa2]/MAX[θa1, θa2] corresponds to θa1/θa2, and 0.377 is obtained by “θa1/θa2”. Thus, the conditional expression (3) is satisfied.

[Projection of Image onto Hologram Screen]

Effects similar to the effects provided by the embodiments described above can be provided.

### [Distortion in Image]

FIG. 58 schematically illustrates an example of a distortion in an image projected onto the hologram screen S.

In the present embodiment, an adjustment optical component such as a cylindrical lens is not used. This results in being slightly difficult to maintain an aspect ratio, compared to the case of the first and second embodiments. Specifically, there is a change in a positional relationship between a long side and a short side of a projected image, and the projected image is vertically long, as illustrated in FIG. 58. On the other hand, a substantially rectangular planar image is displayed.

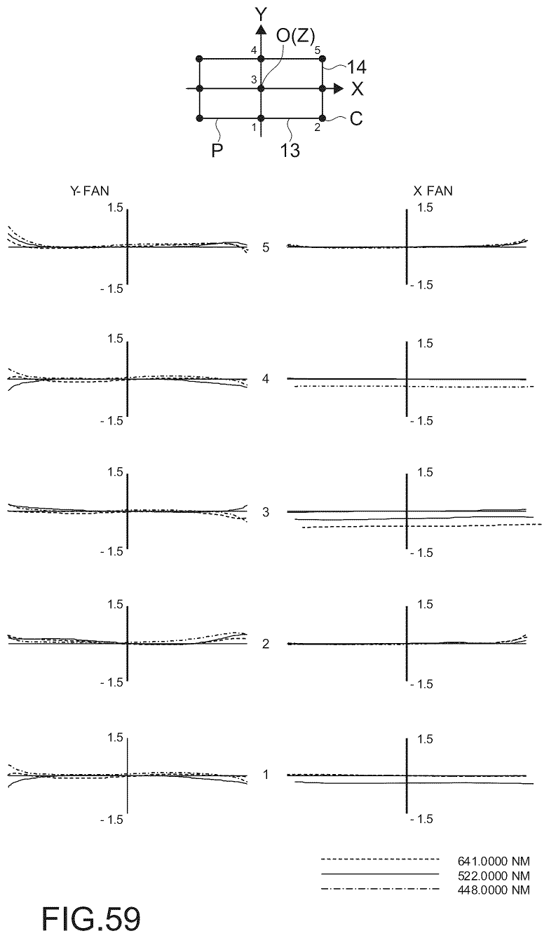

FIG. 59 is a set of graphs in which examples of diagrams of transverse aberrations related to a projected image are given.

A shift in an image plane (on a vertical axis) is sufficiently reduce within about 1.5 mm at each of wavelengths of 641 nm, 522 nm, and 448 nm that are respectively indicated by a dotted line, a solid line, and a dot-dash line, and high-quality image display is performed.

### [Conditions Regarding Traveling Directions of Plurality of Pieces of Pixel Light CL]

On the basis of the results of assessing traveling directions of pieces of pixel light CL according to the first to third embodiments in FIG. 14, and on the basis of the result of assessing traveling directions of pieces of pixel light CL according to the fourth embodiment in FIG. 54, points of features of the projection optical system according to the present technology projection optical system are further described. Note that the features described below are not necessarily indispensable conditions.

Discussion is held focused on the values of ΔθR illustrated in FIGS. 14 and 54 with respect to the respective embodiments. The fact that a standard deviation of a distribution of traveling directions of a plurality of pieces of pixel light CL reflected off the reflection optical system L2 is smaller than 0.13, could be a feature of the projection optical system.

Further, discussion is held focused on the values of ΔθR illustrated in FIGS. 14 and 54 with respect to the first, second, and fourth embodiments. The fact that a standard deviation of a distribution of traveling directions of a plurality of pieces of pixel light CL reflected off the third reflecting surface Mr3 is smaller than 0.03, could be a feature of the projection optical system when the reflection optical system L2 includes the first to third reflecting surfaces Mr1 to Mr3.

Furthermore, discussion is held focused on the values of ΔθR illustrated in FIG. 14 with respect to the third embodiment. The fact that a standard deviation of a distribution of traveling directions of a plurality of pieces of pixel light CL reflected off a single reflecting surface Mr is smaller than 0.13, could be a feature of the projection optical system when the reflection optical system L2 includes the single reflecting surface Mr.

Discussion is held focused on the values of ΔθX illustrated in FIGS. 14 and 54 with respect to the respective embodiments. The fact that a standard deviation of a distribution of traveling directions of a plurality of pieces of pixel light CL reflected off the reflection optical system L2 is smaller than 0.16, could be a feature of the projection optical system, the traveling directions of the plurality of pieces of pixel light CL being traveling directions when the projection optical system is viewed in the Y direction.

Further, discussion is held focused on the values of ΔθX illustrated in FIGS. 14 and 54 with respect to the first, second, and fourth embodiments. The fact that a standard deviation of a distribution of traveling directions of a plurality of pieces of pixel light CL reflected off the third reflecting surface Mr3 is smaller than 0.16, could be a feature of the projection optical system when the reflection optical system L2 includes the first to third reflecting surfaces Mr1 to Mr3, the traveling directions of the plurality of pieces of pixel light CL being traveling directions when the projection optical system is viewed in the Y direction.

Furthermore, discussion is held focused on the values of ΔθX illustrated in FIG. 14 with respect to the third embodiment. The fact that a standard deviation of a distribution of traveling directions of a plurality of pieces of pixel light CL reflected off a single reflecting surface Mr is smaller than 0.12, could be a feature of the projection optical system when the reflection optical system L2 includes the single reflecting surface Mr, the traveling directions of the plurality of pieces of pixel light CL being traveling directions when the projection optical system is viewed in the Y direction.

Note that, when discussion is held focused on the values of Δθx illustrated in FIG. 14 with respect to the first to third embodiments, the fact that a standard deviation of a distribution of traveling directions of a plurality of pieces of pixel light CL reflected off the reflection optical system L2 is smaller than 0.12, could be a feature of the projection optical system, the traveling directions of the plurality of pieces of pixel light CL being traveling directions when the projection optical system is viewed in the Y direction.

Further, when discussion is held focused on the values of ΔθX illustrated in FIG. 14 with respect to the first and second embodiments, the fact that a standard deviation of a distribution of traveling directions of a plurality of pieces of pixel light CL reflected off the third reflecting surface Mr3 is smaller than 0.06, could be a feature of the projection optical system when the reflection optical system L2 includes the first to third reflecting surfaces Mr1 to Mr3, the traveling directions of the plurality of pieces of pixel light CL being traveling directions when the projection optical system is viewed in the Y direction.

Discussion is held focused on the values of ΔθY illustrated in FIGS. 14 and 54 with respect to the respective embodiments. The fact that a standard deviation of a distribution of traveling directions of a plurality of pieces of pixel light CL reflected off the reflection optical system L2 is smaller than 0.13, could be a feature of the projection optical system, the traveling directions of the plurality of pieces of pixel light CL being traveling directions when the projection optical system is viewed in the X direction.

Further, discussion is held focused on the values of ΔθY illustrated in FIGS. 14 and 54 with respect to the first, second, and fourth embodiments. The fact that a standard deviation of a distribution of traveling directions of a plurality of pieces of pixel light CL reflected off the third reflecting surface Mr3 is smaller than 0.03, could be a feature of the projection optical system when the reflection optical system L2 includes the first to third reflecting surfaces Mr1 to Mr3, the traveling directions of the plurality of pieces of pixel light CL being traveling directions when the projection optical system is viewed in the X direction.

Furthermore, discussion is held focused on the values of ΔθY illustrated in FIG. 14 with respect to the third embodiment. The fact that a standard deviation of a distribution of traveling directions of a plurality of pieces of pixel light CL reflected off a single reflecting surface Mr is smaller than 0.13, could be a feature of the projection optical system when the reflection optical system L2 includes the single reflecting surface Mr, the traveling directions of the plurality of pieces of pixel light CL being traveling directions when the projection optical system is viewed in the X direction.

When such conditions for the standard deviation σ are satisfied, this results in being advantageous in performing high-quality image display.

### Other Embodiments

The present technology is not limited to the embodiments described above, and can achieve various other embodiments.

The example in which the reflection optical system L2 includes three concave reflecting surfaces and the example in which the reflection optical system L2 includes a single concave reflecting surface have been described in the embodiments above as examples of the configuration of the reflection optical system L2.

The example of the configuration of the reflection optical system L2 is not limited to these examples. For example, the reflection optical system L2 may be formed using, for example, two concave reflecting surfaces or four concave reflecting surfaces. In other words, any number of concave reflecting surfaces may be used to form the reflection optical system L2.

Further, the reflection optical system L2 may be formed by at least one concave reflecting surface being arranged without being decentered.

Furthermore, the reflection optical system L2 may be formed only using a concave reflecting surface having rotational symmetry. Moreover, any configuration may be adopted in order to form the reflection optical system L2.

The example in which a hologram screen is used as the screen S has been described in the embodiments above.

The present technology is not limited to being applied when the onto-projection object is a hologram screen.

For example, the present technology can also be applied when a Fresnel lens screen is used, and this makes it possible to provide the effects described above.

Moreover, the present technology can be widely applied to, for example, a transparent screen having any configuration.

Typically, the image display system, the image display apparatus, and the projection optical system according to the present technology can be widely applied to any onto-projection objects for which the quality of a projection image is dependent on traveling directions (incident angles) of a plurality of pieces of pixel light CL, and this makes it possible to provide advantageous effects.

Further, the present technology can be applied to displaying an image on not only a screen, but also any onto-projection objects such as a table and a wall of, for example, a building. A shape of the onto-projection object is not limited to a planar shape, and the present technology can also be applied to a curved onto-projection object.

The configurations of the image display system, the image display apparatus, the projection optical system, the lens system, the reflection optical system, the curved reflecting surface, the screen, and the like described with reference to the respective figures are merely embodiments, and any modifications may be made thereto without departing from the spirit of the present technology. In other words, for example, any other configurations or algorithms for purpose of practicing the present technology may be adopted.

In the present disclosure, wording such as “substantially”, “almost”, and “approximately” may be used as appropriate in order to facilitate the understanding of the description. On the other hand, whether the wording such as “substantially”, “almost”, and “approximately” is used does not result in a clear difference.

In other words, in the present disclosure, expressions, such as “center”, “middle”, “uniform”, “equal”, “similar”, “orthogonal”, “parallel”, “symmetric”, “extend”, “axial direction”, “columnar”, “cylindrical”, “ring-shaped”, and “annular” that define, for example, a shape, a size, a positional relationship, and a state respectively include, in concept, expressions such as “substantially the center/substantial center”, “substantially the middle/substantially middle”, “substantially uniform”, “substantially equal”, “substantially similar”, “substantially orthogonal”, “substantially parallel”, “substantially symmetric”, “substantially extend”, “substantially axial direction”, “substantially columnar”, “substantially cylindrical”, “substantially ring-shaped”, and “substantially annular”.

For example, the expressions such as “center”, “middle”, “uniform”, “equal”, “similar”, “orthogonal”, “parallel”, “symmetric”, “extend”, “axial direction”, “columnar”, “cylindrical”, “ring-shaped”, and “annular” also respectively include states within specified ranges (such as a range of +/−10%), with expressions such as “exactly the center/exact center”, “exactly the middle/exactly middle”, “exactly uniform”, “exactly equal”, “exactly similar”, “completely orthogonal”, “completely parallel”, “completely symmetric”, “completely extend”, “fully axial direction”, “perfectly columnar”, “perfectly cylindrical”, “perfectly ring-shaped”, and “perfectly annular” being respectively used as references.

Thus, an expression that does not include the wording such as “substantially”, “almost”, and “approximately” can also include, in concept, an expression including the wording such as “substantially”, “almost”, and “approximately”. Conversely, a state expressed using the expression including the wording such as “substantially”, “almost”, and “approximately” may include a state of “exactly/exact”, “completely”, “fully”, or “perfectly”.

In the present disclosure, an expression using “-er than” such as “being larger than A” and “being smaller than A” comprehensively includes, in concept, an expression that includes “being equal to A” and an expression that does not include “being equal to A”. For example, “being larger than A” is not limited to the expression that does not include “being equal to A”, and also includes “being equal to or greater than A”. Further, “being smaller than A” is not limited to “being less than A”, and also includes “being equal to or less than A”.

When the present technology is carried out, it is sufficient if a specific setting or the like is adopted as appropriate from expressions included in “being larger than A” and expressions included in “being smaller than A”, in order to provide the effects described above.

At least two of the features of the present technology described above can also be combined. In other words, the various features described in the respective embodiments may be combined discretionarily regardless of the embodiments. Further, the various effects described above are not limitative but are merely illustrative, and other effects may be provided.

Note that the present technology may also take the following configurations.

(1) An image display apparatus, including:
a light source;
an image generator that modulates light emitted by the light source to generate image light that includes a plurality of pieces of pixel light; and
a projection optical system that includes
   a lens system that is formed along a reference axis at a position at which the generated image light enters the lens system, the lens system refracting the plurality of pieces of pixel light included in the generated image light, the lens system emitting the plurality of pieces of refracted pixel light, and
   a reflection optical system that is formed along the reference axis, the reflection optical system being a reflection optical system off which the plurality of pieces of pixel light emitted from the lens system is reflected to be headed for an onto-projection object in a state in which traveling directions of the plurality of pieces of pixel light are aligned, the onto-projection object being an object onto which projection is performed.

(2) The image display apparatus according to (1), in which
a standard deviation of a distribution of the traveling directions of the plurality of pieces of pixel light reflected off the reflection optical system is smaller than 0.16.

(3) The image display apparatus according to (1) or (2), in which
the reflection optical system includes at least one curved reflecting surface having a rotationally asymmetric shape.

(4) The image display apparatus according to (3), in which
the at least one curved reflecting surface includes
   a first reflecting surface off which the plurality of pieces of pixel light emitted from the lens system is reflected,
   a second reflecting surface off which the plurality of pieces of pixel light reflected off the first reflecting surface is reflected, and
   a third reflecting surface off which the plurality of pieces of pixel light reflected off the second reflecting surface is reflected to be headed for the onto-projection object.

(5) The image display apparatus according to (4), in which
a standard deviation of a distribution of the traveling directions of the plurality of pieces of pixel light reflected off the third reflecting surface is smaller than 0.16.

(6) The image display apparatus according to (4) or (5), in which
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
   the first reflecting surface has a negative power, the second reflecting surface has a negative power, and the third reflecting surface has a positive power in the case in which the projection optical system is viewed in the first direction, and
   the first reflecting surface has a positive power, the second reflecting surface has a negative power, and the third reflecting surface has a positive power in the case in which the projection optical system is viewed in the second direction.

(7) The image display apparatus according to (6), in which
the projection optical system is configured such that 0.25<θLx/360<0.47, where θLx represents an angle formed when the projection optical system is viewed in the first direction, the angle being formed by a piece of short-side pixel light incident on the third reflecting surface and the piece of short-side pixel light reflected off the third reflecting surface, the piece of short-side pixel light being a piece of pixel light that is from among the plurality of pieces of pixel light and corresponds to a pixel situated in a middle portion of the short side of the image.

(8) The image display apparatus according to (3), in which
the at least one curved reflecting surface is a single curved reflecting surface.

(9) The image display apparatus according to (8), in which
a standard deviation of a distribution of the traveling directions of the plurality of pieces of pixel light reflected off the single reflecting surface is smaller than 0.13.

(10) The image display apparatus according to (8) or (9), in which
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
   the single reflecting surface has a positive power in the case in which the projection optical system is viewed in the first direction, and
   the single reflecting surface has a positive power in the case in which the projection optical system is viewed in the second direction.

(11) The image display apparatus according to (10), in which
the projection optical system is configured such that 0.02<θLx/360<0.47, where θLx represents an angle formed when the projection optical system is viewed in the first direction, the angle being formed by a piece of short-side pixel light incident on the single reflecting surface and the piece of short-side pixel light reflected off the single reflecting surface, the piece of short-side pixel light being a piece of pixel light that is from among the plurality of pieces of pixel light and corresponds to a pixel situated in a middle portion of the short side of the image.

(12) The image display apparatus according to any one of (3) to (11), in which
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
   the projection optical system is configured such that 0.35<MIN[θa1, θa2]/MAX[θa1, θa2]<0.96, where θa1 represents a certain angle formed when the projection optical system is viewed in the second direction, the certain angle being formed by a piece of first long-side pixel light incident on a final reflecting surface, and the piece of first long-side pixel light reflected off the final reflecting surface, and θa2 represents another angle formed when the projection optical system is viewed in the second direction, the other angle being formed by a piece of second long-side pixel light incident on the final reflecting surface, and the piece of second long-side pixel light reflected off the final reflecting surface, the piece of first long-side pixel light being a piece of pixel light that is from among the plurality of pieces of pixel light and corresponds to a pixel situated in a middle portion of one of the long sides of the image, the piece of second long-side pixel light being a piece of pixel light that is from among the plurality of pieces of pixel light and corresponds to a pixel situated in a middle portion of another of the long sides of the image, the final reflecting surface being a curved reflecting surface that is included in the at least one curved reflecting surface and off which the plurality of pieces of pixel light is reflected to be headed for the onto-projection object.

(13) The image display apparatus according to any one of (3) to (12), in which
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
   the projection optical system is configured such that −0.1<θLy/360<0.1, where θLy represents an intersection angle formed when the projection optical system is viewed in the second direction, the intersection angle being an angle of intersection of a traveling direction of a piece of first long-side pixel light reflected off a final reflecting surface, and a traveling direction of a piece of second long-side pixel light reflected off the final reflecting surface, the piece of first long-side pixel light being a piece of pixel light that is from among the plurality of pieces of pixel light and corresponds to a pixel situated in a middle portion of one of the long sides of the image, the piece of second long-side pixel light being a piece of pixel light that is from among the plurality of pieces of pixel light and corresponds to a pixel situated in a middle portion of another of the long sides of the image, the final reflecting surface being a curved reflecting surface that is included in the at least one curved reflecting surface and off which the plurality of pieces of pixel light is reflected to be headed for the onto-projection object.

(14) The image display apparatus according to any one of (3) to (13), in which
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
   a curved reflecting surface that is from among the at least one curved reflecting surface and exhibits a largest difference between a power observed in the case in which the projection optical system is viewed in the first direction and a power observed in the case in which the projection optical system is viewed in the second direction, is a final reflecting surface, the final reflecting surface being a curved reflecting surface that is included in the at least one curved reflecting surface and off which the plurality of pieces of pixel light is reflected to be headed for the onto-projection object.

(15) The image display apparatus according to any one of (1) to (14), in which
the image generator emits, to the lens system and along the reference axis, the image light making up a rectangular image that has paired long sides that face each other, and paired short sides that face each other, and
the lens system includes an adjustment optical component that controls one of an angle of view in a short-side direction in which the short side of the image extends, and an angle of view in a long-side direction in which the long side of the image extends.

(16) The image display apparatus according to (15), in which
the adjustment optical component includes a cylindrical lens.

(17) The image display apparatus according to any one of (1) to (16), in which
the traveling directions of the plurality of pieces of pixel light correspond to traveling directions of respective principal rays of the plurality of pieces of pixel light.

(18) An image display system, including:
(a) an onto-projection object onto which projection is performed, the onto-projection object being an object on which an image is displayed by image light that includes a plurality of pieces of pixel light being projected onto the object; and
(b) an image display apparatus that includes
   a light source,
   an image generator that modulates light emitted by the light source to generate the image light including the plurality of pieces of pixel light, and
   a projection optical system that includes
      a lens system that is formed along a reference axis at a position at which the generated image light enters the lens system, the lens system refracting the plurality of pieces of pixel light included in the generated image light, the lens system emitting the plurality of pieces of refracted pixel light, and
      a reflection optical system that is formed along the reference axis, the reflection optical system being a reflection optical system off which the plurality of pieces of pixel light emitted from the lens system is reflected to be headed for the onto-projection object in a state in which traveling directions of the plurality of pieces of pixel light are aligned,
the onto-projection object displaying thereon the image in a state in which the traveling directions of the plurality of pieces of pixel light incident on the onto-projection object are controlled.

(19) The image display system according to (18), in which
the onto-projection object is a hologram screen or a Fresnel lens screen.

(20) A projection optical system that projects image light including a plurality of pieces of pixel light onto an onto-projection object onto which projection is performed, the image light being generated by light emitted by a light source being modulated, the projection optical system including:
a lens system that is formed along a reference axis at a position at which the generated image light enters the lens system, the lens system refracting the plurality of pieces of pixel light included in the generated image light, the lens system emitting the plurality of pieces of refracted pixel light; and
a reflection optical system that is formed along the reference axis, the reflection optical system being a reflection optical system off which the plurality of pieces of pixel light emitted from the lens system is reflected to be headed for the onto-projection object in a state in which traveling directions of the plurality of pieces of pixel light are aligned.

(21) The image display apparatus according to (2), in which
the standard deviation of the distribution of the traveling directions of the plurality of pieces of pixel light reflected off the reflection optical system is smaller than 0.13.

(22) The image display apparatus according to (5), in which
a standard deviation of a distribution of the traveling directions of the plurality of pieces of pixel light reflected off the reflection optical system is smaller than 0.06.

(23) The image display apparatus according to (2), in which
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
   the standard deviation of the distribution of the traveling directions of the plurality of pieces of pixel light reflected off the reflection optical system is smaller than 0.16 in the case in which the projection optical system is viewed in the first direction.

(24) The image display apparatus according to (23), in which
the standard deviation of the distribution of the traveling directions of the plurality of pieces of pixel light reflected off the reflection optical system is smaller than 0.12 in the case in which the projection optical system is viewed in the first direction.

(25) The image display apparatus according to (2) or any one of (21) to (24), in which
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
   the standard deviation of the distribution of the traveling directions of the plurality of pieces of pixel light reflected off the reflection optical system is smaller than 0.13 in the case in which the projection optical system is viewed in the second direction.

(26) The image display apparatus according to (5), in which
a standard deviation of a distribution of the traveling directions of the plurality of pieces of pixel light reflected off the third reflecting surface is smaller than 0.16 in the case in which the projection optical system is viewed in the first direction.

(27) The image display apparatus according to (26), in which
the standard deviation of the distribution of the traveling directions of the plurality of pieces of pixel light reflected off the third reflecting surface is smaller than 0.06 in the case in which the projection optical system is viewed in the first direction.

(28) The image display apparatus according to any one of (5), (26), and (27), in which
a standard deviation of a distribution of the traveling directions of the plurality of pieces of pixel light reflected off the third reflecting surface is smaller than 0.03 in the case in which the projection optical system is viewed in the second direction.

(29) The image display apparatus according to (9), in which
the standard deviation of the distribution of the traveling directions of the plurality of pieces of pixel light reflected off the single reflecting surface is smaller than 0.12 in the case in which the projection optical system is viewed in the first direction.

(30) The image display apparatus according to (9) or (29), in which
the standard deviation of the distribution of the traveling directions of the plurality of pieces of pixel light reflected off the single reflecting surface is smaller than 0.13 in the case in which the projection optical system is viewed in the second direction.

(31) The image display apparatus according to (12), in which
the projection optical system is configured such that 0.7<MIN[θa1, θa2]/MAX[θa1, θa2]<0.96.

(32) The image display apparatus according to (17), in which
the lens system includes a stop, and
light rays that pass through the center of the stop are respective principal rays of the plurality of pieces of pixel light.

### REFERENCE SIGNS LIST

C pixel
CL pixel light
CLL long-side pixel light
CLL1 first long-side pixel light
CLL2 second long-side pixel light
CLS short-side pixel light
CYL cylindrical lens
IL image light
L1 lens system
L2 reflection optical system
Mr single reflecting surface
Mr1 first reflecting surface
Mr2 second reflecting surface
Mr3 third reflecting surface
RS rotationally symmetric lens
O optical axis
P liquid crystal panel
S screen
7, 25, 28, 32 image display system
8 image display apparatus
9 light source
10 illumination optical system
11, 26, 29, 33 projection optical system
13 long side of liquid crystal panel
14 short side of liquid crystal panel
16 stop

1. An image display apparatus, comprising:
a light source;
an image generator that modulates light emitted by the light source to generate image light that includes a plurality of pieces of pixel light; and
a projection optical system that includes
a lens system that is formed along a reference axis at a position at which the generated image light enters the lens system, the lens system refracting the plurality of pieces of pixel light included in the generated image light, the lens system emitting the plurality of pieces of refracted pixel light, and
a reflection optical system that is formed along the reference axis, the reflection optical system being a reflection optical system off which the plurality of pieces of pixel light emitted from the lens system is reflected to be headed for an onto-projection object in a state in which traveling directions of the plurality of pieces of pixel light are aligned, the onto-projection object being an object onto which projection is performed.

2. The image display apparatus according to claim 1, wherein
a standard deviation of a distribution of the traveling directions of the plurality of pieces of pixel light reflected off the reflection optical system is smaller than 0.16.

3. The image display apparatus according to claim 1, wherein
the reflection optical system includes at least one curved reflecting surface having a rotationally asymmetric shape.

4. The image display apparatus according to claim 3, wherein
the at least one curved reflecting surface includes
a first reflecting surface off which the plurality of pieces of pixel light emitted from the lens system is reflected,
a second reflecting surface off which the plurality of pieces of pixel light reflected off the first reflecting surface is reflected, and
a third reflecting surface off which the plurality of pieces of pixel light reflected off the second reflecting surface is reflected to be headed for the onto-projection object.

5. The image display apparatus according to claim 4, wherein
a standard deviation of a distribution of the traveling directions of the plurality of pieces of pixel light reflected off the third reflecting surface is smaller than 0.16.

6. The image display apparatus according to claim 4, wherein
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
the first reflecting surface has a negative power, the second reflecting surface has a negative power, and the third reflecting surface has a positive power in the case in which the projection optical system is viewed in the first direction, and
the first reflecting surface has a positive power, the second reflecting surface has a negative power, and the third reflecting surface has a positive power in the case in which the projection optical system is viewed in the second direction.

7. The image display apparatus according to claim 6, wherein
the projection optical system is configured such that 0.25<θLx/360<0.47, where θLx represents an angle formed when the projection optical system is viewed in the first direction, the angle being formed by a piece of short-side pixel light incident on the third reflecting surface and the piece of short-side pixel light reflected off the third reflecting surface, the piece of short-side pixel light being a piece of pixel light that is from among the plurality of pieces of pixel light and corresponds to a pixel situated in a middle portion of the short side of the image.

8. The image display apparatus according to claim 3, wherein
the at least one curved reflecting surface is a single curved reflecting surface.

9. The image display apparatus according to claim 8, wherein
a standard deviation of a distribution of the traveling directions of the plurality of pieces of pixel light reflected off the single reflecting surface is smaller than 0.13.

10. The image display apparatus according to claim 8, wherein
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
the single reflecting surface has a positive power in the case in which the projection optical system is viewed in the first direction, and
the single reflecting surface has a positive power in the case in which the projection optical system is viewed in the second direction.

11. The image display apparatus according to claim 10, wherein
the projection optical system is configured such that 0.02<θLx/360<0.47, where θLx represents an angle formed when the projection optical system is viewed in the first direction, the angle being formed by a piece of short-side pixel light incident on the single reflecting surface and the piece of short-side pixel light reflected off the single reflecting surface, the piece of short-side pixel light being a piece of pixel light that is from among the plurality of pieces of pixel light and corresponds to a pixel situated in a middle portion of the short side of the image.

12. The image display apparatus according to claim 3, wherein
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
the projection optical system is configured such that 0.35<MIN[θa1, θa2]/MAX[θa1, θa2]<0.96, where θa1 represents a certain angle formed when the projection optical system is viewed in the second direction, the certain angle being formed by a piece of first long-side pixel light incident on a final reflecting surface, and the piece of first long-side pixel light reflected off the final reflecting surface, and θa2 represents another angle formed when the projection optical system is viewed in the second direction, the other angle being formed by a piece of second long-side pixel light incident on the final reflecting surface, and the piece of second long-side pixel light reflected off the final reflecting surface, the piece of first long-side pixel light being a piece of pixel light that is from among the plurality of pieces of pixel light and corresponds to a pixel situated in a middle portion of one of the long sides of the image, the piece of second long-side pixel light being a piece of pixel light that is from among the plurality of pieces of pixel light and corresponds to a pixel situated in a middle portion of another of the long sides of the image, the final reflecting surface being a curved reflecting surface that is included in the at least one curved reflecting surface and off which the plurality of pieces of pixel light is reflected to be headed for the onto-projection object.

13. The image display apparatus according to claim 3, wherein
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
the projection optical system is configured such that −0.1<θLy/360<0.1, where θLy represents an intersection angle formed when the projection optical system is viewed in the second direction, the intersection angle being an angle of intersection of a traveling direction of a piece of first long-side pixel light reflected off a final reflecting surface, and a traveling direction of a piece of second long-side pixel light reflected off the final reflecting surface, the piece of first long-side pixel light being a piece of pixel light that is from among the plurality of pieces of pixel light and corresponds to a pixel situated in a middle portion of one of the long sides of the image, the piece of second long-side pixel light being a piece of pixel light that is from among the plurality of pieces of pixel light and corresponds to a pixel situated in a middle portion of another of the long sides of the image, the final reflecting surface being a curved reflecting surface that is included in the at least one curved reflecting surface and off which the plurality of pieces of pixel light is reflected to be headed for the onto-projection object.

14. The image display apparatus according to claim 3, wherein
the image generator emits, to the lens system and along the reference axis, the image light making up a rectangular image that has paired long sides that face each other, and paired short sides that face each other, and
when a direction that corresponds to a short-side direction in which the short side of the image extends is defined as a first direction, the image being made up by the image light emitted to the lens system, and when a direction that corresponds to a long-side direction in which the long side of the image extends is defined as a second direction, the image being made up by the image light emitted to the lens system,
a curved reflecting surface that is from among the at least one curved reflecting surface and exhibits a largest difference between a power observed in the case in which the projection optical system is viewed in the first direction and a power observed in the case in which the projection optical system is viewed in the second direction, is a final reflecting surface, the final reflecting surface being a curved reflecting surface that is included in the at least one curved reflecting surface and off which the plurality of pieces of pixel light is reflected to be headed for the onto-projection object.

15. The image display apparatus according to claim 1, wherein
the image generator emits, to the lens system and along the reference axis, the image light making up a rectangular image that has paired long sides that face each other, and paired short sides that face each other, and
the lens system includes an adjustment optical component that controls one of an angle of view in a short-side direction in which the short side of the image extends, and an angle of view in a long-side direction in which the long side of the image extends.

16. The image display apparatus according to claim 15, wherein
the adjustment optical component includes a cylindrical lens.

17. The image display apparatus according to claim 1, wherein
the traveling directions of the plurality of pieces of pixel light correspond to traveling directions of respective principal rays of the plurality of pieces of pixel light.

18. An image display system, comprising:
(a) an onto-projection object onto which projection is performed, the onto-projection object being an object on which an image is displayed by image light that includes a plurality of pieces of pixel light being projected onto the object; and
(b) an image display apparatus that includes
a light source,
an image generator that modulates light emitted by the light source to generate the image light including the plurality of pieces of pixel light, and
a projection optical system that includes
a lens system that is formed along a reference axis at a position at which the generated image light enters the lens system, the lens system refracting the plurality of pieces of pixel light included in the generated image light, the lens system emitting the plurality of pieces of refracted pixel light, and
a reflection optical system that is formed along the reference axis, the reflection optical system being a reflection optical system off which the plurality of pieces of pixel light emitted from the lens system is reflected to be headed for the onto-projection object in a state in which traveling directions of the plurality of pieces of pixel light are aligned,
the onto-projection object displaying thereon the image in a state in which the traveling directions of the plurality of pieces of pixel light incident on the onto-projection object are controlled.

19. The image display system according to claim 18, wherein
the onto-projection object is a hologram screen or a Fresnel lens screen.

20. A projection optical system that projects image light including a plurality of pieces of pixel light onto an onto-projection object onto which projection is performed, the image light being generated by light emitted by a light source being modulated, the projection optical system comprising:
a lens system that is formed along a reference axis at a position at which the generated image light enters the lens system, the lens system refracting the plurality of pieces of pixel light included in the generated image light, the lens system emitting the plurality of pieces of refracted pixel light; and
a reflection optical system that is formed along the reference axis, the reflection optical system being a reflection optical system off which the plurality of pieces of pixel light emitted from the lens system is reflected to be headed for the onto-projection object in a state in which traveling directions of the plurality of pieces of pixel light are aligned.
